(19) United States
(12) Patent Application Publication
(10) Pub. No.: US 2014/0310025 A1
(43) Pub. Date: Oct. 16, 2014

(54) SYSTEMS, METHODS, AND COMPUTER PROGRAM PRODUCTS FOR GUIDING THE SELECTION OF THERAPEUTIC TREATMENT REGIMENTS

(71) Applicant: Advanced Biological Laboratories SA, Luxembourg ville (LU)

(72) Inventors: Chalom Sayada, Luxembourg ville (LU); Dimitri Gonzalez, Luxembourg ville (LU); Ronan Boulme, Luxembourg ville (LU)

(21) Appl. No.: 14/359,342

(22) PCT Filed: Nov. 21, 2012
(86) PCT No.: PCT/IB2012/002939

§ 371 Date: May 20, 2014

Related U.S. Application Data
(60) Provisional application No. 61/562,379, filed on Nov. 21, 2011.

(51) Int. Cl. G06F 19/00

(52) U.S. Cl. CPC G06F 19/3487; G06F 19/322
USPC 705/3; 705/2

(57) ABSTRACT

Systems, methods and computer program products for guiding selection of a therapeutic treatment regimen for a known disease such as HIV infection are disclosed. The method comprises (a) providing patient information to a computing device (the computer device comprising: a first knowledge base comprising a plurality of different therapeutic treatment regimens for the disease; a second knowledge base comprising a plurality of expert rules for selecting a therapeutic treatment regimen for the disease; and a third knowledge base comprising advisory information useful for the treatment of a patient with different constituents of the different therapeutic treatment regimens; and (b) generating in the computing device a listing (preferably a ranked listing) of therapeutic treatment regimens for the patient; and (c) generating in the computing device advisory information for one or more treatment regimens in the listing based on the patient information and the expert rules.

### FIELD OF THE INVENTION

The present invention concerns systems, and/or methods and/or computer program products for guiding the selection of therapeutic treatment regimens for complex disorders, including, but not limited to, cancer and viral infections, such as HIV-1, HCV, and HBV infections, wherein a ranking of available treatment regimens is generated and advisory information clinically useful for treating and monitoring patients is provided.

### BACKGROUND OF THE INVENTION

Therapeutic treatment regimens for disorders such as HIV-1 infection (acquired immune deficiency syndrome or AIDS) and cancer, diabetes, disorders of the central nervous system diseases, Cardiovascular diseases are increasingly complex. New data, new companion diagnostic's complex assays and new therapeutic treatment regimens continue to modify the treatments available, and it is difficult for all but the specialist to remain current on the latest treatment information. Further, even those who are current on the latest treatment information require time to assimilate that information and understand how it relates to other treatment information in order to provide the best available treatment for a patient at a given stage of the disease evolution. Combination therapeutic treatment regimens exacerbate this problem by making potential drug interactions even more complex. Finally, an increasingly sophisticated patient population, in the face of a vast volume of consumer information on the treatment of disease, budget and cost's constraints, makes the mere statement of a treatment regime, without explanation, difficult for the patient to accept.

Personalized approaches to HIV treatment are described in U.S. Pat. No. 6,081,786, the contents of which are hereby incorporated by reference in their entirety. Using the techniques outlined in the '786 patent, a patient's HIV can be screened for the presence of known mutations, and appropriate therapy can be identified which is successful against HIV with these mutations. However, preexisting drug-resistant HIV-1 minority variants that are not identified with routine mutation screening, such as a Sanger analysis, result in the risk of first-line non-nucleoside reverse transcriptase inhibitor (NNRTI)-based antiretroviral virologic failure. See, for example, Li et al., “Low-frequency HIV-1 drug resistance mutations and risk of NNRTI-based antiretroviral treatment failure: a systematic review and pooled analysis,” JAMA. 2011 Apr. 6; 305(13):1327-35.

According to Li, among participants from the cohort studies, 35% of those with detectable minority variants experienced virologic failure compared with 15% of those without minority variants. Thus, the presence of minority variants is associated with 2.5 to 3 times the risk of virologic failure. Similar risks exist for other types of viral infections, as well as cancer treatments, bacterial infections, and other disorders.

Viral Hepatitis is another type of disorder in which the presence of mutations results in virologic failure. New anti-retroviral agents are currently being developed for hepatitis C virus (HCV) and Hepatitis B virus (HBV), and administration of these agents will likely result in the development of drug resistance, and, potentially, co-infection with one or more different HCV/HBV variants with different drug resistance profiles.

Currently, there are no methods for reliably and automatically determining a patient's unique profile of major and minor variants, generating a suitable treatment regimen to treat these variants, and, optionally, providing advisory information to the patient and/or treating physician.

Next-generation sequencing (NGS) is a methodology that increases sequencing throughput by laying millions of DNA fragments on a single chip, and sequencing all fragments in parallel. DNA fragments are used to build libraries that are then used as sequencing templates. These are prepared for sequencing by ligating specific adaptor oligonucleotides to both ends of each fragment. Following sequencing, informatics allows each sequencing read to be mapped to a reference genome. These techniques can be used to sequence major and minor variants, and identify mutations in these variants. There are a number of NGS platforms (454 FLX/Junior, Qiagen, IIlumina, and Applied Biosystems' SOLiD™ (Sequencing by Oligo Ligation and Detection) System, and the like) which produce a large volume of genomic data on the viruses, but to date these have not been combined with focused data management software to help manage the genotyping, drug resistance testing, and other data).

It would be advantageous to have methods of screening patients to identify both majority and minority variants associated with their viral, bacterial, or other disorders, and to identify appropriate therapeutic treatments for both the majority and minority variants. The present invention provides such methods, as well as the hardware and software necessary to implement the methods.

### SUMMARY OF THE INVENTION

The present invention provides a personalized healthcare approach and diagnostic solution to treating disorders, particularly chronic disorders, which are potentially associated with more than one variant of the pathogen, even if a patient is only infected with a single variant. Specific pathogens include viruses such as HIV, HBV, and HCV, as well as various flu viruses. The susceptibility of a patient to other infectious diseases, such as bacterial and fungal diseases, can also be diagnosed, and personalized medicine approaches developed. Further, the existence of disorders associated with genetic mutations, in cancer cells, diabetes, CNS, CVD, HLAs, ITPA, and the like, can also be determined, and personalized healthcare approaches developed.

The methods described herein, as well as the system and software used to implement the methods, enable one to guide the decision, or to optimize the decisions, whether or not to perform sequencing (Sanger or UDS) on a given sample, based on the patient's information, administrative and economic information, and evaluation of the user decisions or proposition of interpretations by the system itself.

Where a patient is infected with a major variant and one or more minor variants of a given pathogen, appropriate therapeutic regimens for treating the major variant and the one or more minor variants can be identified. The selection of appropriate therapeutic regimens can be based, at least in part, on an analysis of the variants, and a correlation of the variants with therapeutic regimens which are known to be effective against such variants.

The presence of various alleles in patients, particularly in their interleukin 28A (IL-28A), IL-28B and IL-29, human leukocyte antigen (HLA), in vitro platelet toxicity assays (iPTA, which can be used to assess drug hypersensitivity syndrome), ITPA, oncology-related targets, and the like. The system can provide generic IT-based computerized tools to allow end-users to create their own respective expert systems in various diseases, and use appropriate decision support based rules to reach Personalized Healthcare determinations and assessments, using a database format.

The methods described herein can be useful in determining personalized medicine approaches. That is, by determining the presence or absence of various alleles/haplotypes, and determining appropriate therapeutic treatments based on these alleles, it is possible to provide personalized medicine approaches for patients suffering from disorders mediated by the presence or absence of certain alleles/haplotypes.

To implement these approaches, the present invention provides systems, methods and computer program products for guiding the selection of therapeutic treatment regimens for patients for patients in which available treatments are listed, and optionally ranked, while unavailable or rejected treatment regimens (e.g., regimens that would not be effective, or would be dangerous) are ideally either not displayed, or are assigned a low rank and are indicated to a user as not likely to be efficacious, or not preferred due to patient-specific complicating factors such as drug interaction from concomitant medications.

In one embodiment, the approaches are population based, and in another embodiment, are based on a clonal/haplotype analysis.

In one embodiment, next generation sequencing is used to determine i) an HIV sequence for HIV drug resistance determination and/or host determination, and ii) a quantification of the HIV viral load.

In one embodiment, biological samples from a plurality of patients are pooled, and subjected to “population screening” in the same wells of tagged samples using next generation sequencing runs using limited sensitivity, which can accommodate more samples per run than if a higher sensitivity were used. This embodiment allows for lower pricing per patient. Samples can be selected for further screening based on pre-determined criteria, and can be subjected to ultra-deep sequencing using relatively higher sensitivity than used in the population screening.

In addition to providing an appropriate treatment modality based on the particular types of mutations in the major and/or minor variants, therapies that would be expected to be ineffective due to known resistance and/or possible resistance can also be identified.

Patient Information

Patient information is ideally inputted into a system, which can then use the information to determine an appropriate treatment regimen. The information includes, at least, ultra-deep sequencing (“UDS”) information, or other such sequencing information which identifies major and minor variants of the types of pathogens, such as viruses (including HIV, HBV, and HCV) with which the patient is infected, and the specific mutations on each of these variants. Such information is useful, particularly in the treatment of HIV, HBV, and HCV infection, because there is a significant difference between two or more mutations on a single virus, or different mutations on different viruses. This is particularly relevant with antiviral therapies, where the presence of a single mutation can be associated with failure of a first treatment modality, but the presence of an additional mutation can be associated with the renewed effectiveness of this treatment modality. That is, drugs which are inactive against virus with a first mutation may be active against virus with a first and a second mutation. Without knowing whether a particular combination of mutations occurs on a single variant, or on multiple variants, it can be difficult to design appropriate therapy. Because the present invention provides information on which mutations are present in which variants, appropriate therapeutic modalities can be prescribed.

In one embodiment, after entering the patient's genetic information (i.e., types of variants, and mutations present on each variant), a user-defined therapeutic treatment regimen for the disease (or medical condition) can be entered. Advisory information for the user-defined combination therapeutic treatment regimen can then be generated, and/or an evaluation of the end-user treatment and/or monitoring decision(s) can be evaluated by the Method/System, leading the end-user to revise its initial decision(s). Where a rejected therapeutic treatment regimen for the disease (or medical condition) is entered, for example, a regimen that is included in the knowledge base of therapeutic regimens, but not recommended (i.e., given a very low ranking), advisory information can be generated, providing one or more reasons for not recommending (or providing a low ranking) for the particular therapeutic treatment regimen.

Identification of Variants

An essential component of the approach is to identify variants, and mutations present in the variants, associated with the disorder. For example, a biological sample taken from a patient infected with HIV, HCV, or HBV is screened to identify the prevalence of one or more different types or subtypes of the virus, or a patient with cancer can be screened to identify subtypes of the cancer cells, for example, low frequency somatic mutations in cancer samples. Each type or subtype can be screened for the presence of mutations that render particular therapeutic regimens more or less effective.

One example of a method to identify variants in a patient's viral infection is known as ultra-deep-sequencing screening (“UDS”). The UDS can be, for example, DeepChek™ (ABL) can be used to screen for HIV, HBV, and HCV. Ultra Deep Sequencing (Roche® 454 Life Sciences) (UDS-454®) is a technique used to detect low-level drug resistant HIV variants, which is not possible with other commercially-available sequencing assays. By using an integrated genotyping solution incorporating a UDS platform, such as UDS-454®, and a powerful software system capable of processing the sequencing information, one can generate assess the quality of the UDS generated data, generate also clinically meaningful genotyping reports, an example of which is shown in FIG. 1.

With respect to UDS methods, the present invention can also include software to perform HIV, HBV, or HCV genotyping from UDS platforms. The system can be used and/or integrated with several types of UDS platforms, such as 454 FLX, 454 Junior, and the like, and can also be fully integrated with a clinical data management software, such as that provided by Therapy Edge.

Patients with Low-Viremia Levels, and Clonal Screening

In one embodiment, the methods are used to identify appropriate treatment regimens for patients with low-viremia levels, and/or to identify and/or to identify clonal/population-based major/minor populations. This is a significant advance over the existing personalized medicine approaches that only focus on the major variants, in that the method can assess drug resistance based on mutations borne by a given virus.

An amplicon is a piece of DNA formed as the product of natural or artificial amplification events. For example, it can be formed via polymerase chain reactions (PCR) or ligase chain reactions (LCR), as well as by natural gene duplication. Amplicon-based screening can be used. Sequence alignment of these amplicons is then analyzed, for example, by DeepChek™, to generate information on mutations for the selected population (depending on the sensitivity).

In one embodiment, the system can produce a population-based sequence (consensus) related to each selected threshold, for all the proteins/regions that have been introduced. For example, where a patient is screened for the presence of mutations in HIV, the proteins are proteins that are commonly mutated as a result of the administration of anti-retroviral therapy, for example, reverse transcriptase, protease, integrase, GP120, and GP41. A threshold, as used herein, is a cutoff number (from 1 to 100%, or 0.1 to 100%) which defines, position by position on the aligned nucleotide sequences, which nucleotides should be kept, based on their individual prevalence at the specified position of the alignment. As an example, a 20% threshold will only keep nucleotides (A, C, T or G) represented, position by position, above 20% of the sequences of the alignment. Gaps are not taken into account. Typically, the number of different thresholds ranges from one to five. Once generated, all the thresholds can be summarized, for example, in a grid.

Optional Sanger Analysis

In addition to a UDS analysis, a Sanger-based comparative analysis can be performed, if desired. If a Sanger-based comparative analysis is performed, one has the ability to display on each individual report a report of each sequence, and comments related to the determined mutations.

If this option is selected, the information can be analyzed, and a specific report can be created for the Sanger data (mutations, subtype, interpretations, and the like) and optionally embedded in the patient report, for example, in the form of extra columns being provided for the Sanger analysis data.

Data Management

In use, patient information is provided to a computing device that includes various knowledge bases.

There is a large amount of genomic data on viruses such as HIV, HBV, and HCV, as well as various other pathogens, and various other hosts. There is also a large amount of clinical data, biological data, and molecular data. Further, because a number of therapeutics are available for treating these diseases, which are applicable to some variants, but not to all variants, a number of expert knowledge bases and databases can be used to determine an appropriate therapy based on the existence of mutations. The knowledge bases can also include, for example, advisory information, such as information on why a particular treatment will be effective or ineffective.

For example, a first knowledge base may include a plurality of different therapeutic treatment regimens, including single drug based treatment, for a disease or medical condition. A second knowledge base may include a plurality of expert rules for selecting a therapeutic treatment regimen for the disease or medical condition. A third knowledge base may include advisory information useful for the treatment of a patient with different constituents of different therapeutic treatment regimens. A fourth knowledge base may include information about past therapies, such as how a patient has fared under previous therapies.

In some embodiments, a treatment modality will be subject to several guidelines, including local, regional, and national guidelines, and these guidelines can be subject to change over time. These guidelines can be stored in a knowledge base, and updated automatically and/or on a regular basis.

Expert Systems

In one embodiment, an “expert system,” with a set of rules developed by experts in the field of the particular disorder being treated, can be used to automatically verify and/or finalize the personalized report. In this embodiment, a series of decision support-based rules are used to predict, on a personalized basis, appropriate treatment regimens. An expert system can be created, based on guidelines, on QA/QC, and the like, to ensure that the results provided in the personalized report are accurate and not issued automatically with potential major errors. The expert system can consider factors such as viral load, drug therapies already being used by the particular patient, and the like, and used to filter available information to provide relevant clinical and molecular data for appropriate clinical decision and treatment adaptation. The analysis of the Expert System can be done amplicon by amplicon, and/or also nucleotide position by nucleotide position, to ensure the optimal reliability and consistency. A series of decision support-based rules can be used in predicting, on a personalized basis, a series of “reflex testing” and treatment regimens.

The methods can also include the use of an “Expert System” which includes one or more rules to check the quality of the input to be interpreted used various Knowledge Bases. This Expert system typically will allow to automatically using computerized algorithms, analyze, align sequences, compare, check for the consistency of the input data and output reports, prevent inconsistencies in the reporting (by ex: allow a report of presence of given mutation at low viremia while not enough sequences were performed and as such cannot be analyzed).

As used herein, “Reflex testing” and “REFLEX DECISION” treatment regimens are based on the result and/or the interpretation of a given test. Several treatments can be prescribed or stopped even if these treatment are not necessarily directed to the pathogen analyzed, for example, because the assays determined that a newly-prescribed drug would cause interactions with the previous prescribed drug currently still in use. Monitoring assays can be used to assess the adverse events caused by the existing or newly prescribed treatments, and/or hospitalization stays, and/or other healthcare related decisions.

On the same clinical sample or a new requested clinical sample, another “reflex test” can be prescribed and/or performed based on the result and/or the interpretation of the previous test performed.

A series of expert system-based guidelines can also be created, related to quality assurance/quality control (QA/QC), to ensure that the results/report are accurate and not issued automatically with potential major errors. For example, the expert system can include specific Rules, particularly with respect to the sequencing analysis software, to allow for the detection of “Homopolymer” sequences where the Ultra Deep Sequencing system might not optimally and accurately detect the presence of local mutations in such homopolymer sequences. In this manner, one can prevent the generation generate of a report with incorrect and/or irrelevant data.

Expert systems (including information such as viral load, drug in use, and the like) can be used to filter available information to provide relevant clinical and molecular data for appropriate clinical decision and treatment adaptation.

Algorithms associated with determining effective therapy for each of the variants, based on the identity of the types of mutations in the variants, and the knowledge of therapeutic modalities known to be effective against variants with such mutations, are then used to identify appropriate therapy. One or more algorithms can be used to identify appropriate therapeutic regimens. Ideally, versions for each guideline are regularly and automatically updated once a new version is available (and, optionally, validated). Commercially-available algorithms that can be used include, but are not limited to, Stanford HIVdb, Rega Institute, ANRS, RIS (National Spanish algorithm), RenaGeno (National Brazilian algorithm), Detroit Medical Center, Centre Hospitalier de Luxembourg.

Software/Hardware

Once information regarding the patient's variants is obtained, the data can be collected, stored, analyzed, interpreted, and/or validated, and used to generate a personalized healthcare report. The approaches can be implemented using specific software, and a computer system and other hardware capable of working with the software to generate data.

Representative software useful for performing one or more of the steps includes AVA-CLI v2.5.1, Perl script to automate AVA execution, and DeepChek™-HIV. The hardware includes a sequencer capable of performing UDS, such as a 454-FLX or 454-Junior sequencer, optionally including a 454-Bioinformatics station, and a computer capable of storing one or more knowledge bases, and running software capable of handling the amount of sequencing data, tabulating the data, and accessing knowledge bases capable of taking the UDS data and using it to generate lists of appropriate therapeutic regimens capable of treating the patient's unique pathogen or combinations of major and minor pathogen variants.

The software also handles a suitable data workflow, and provides genotyping & reporting of same. The data can also be subjected to a quality assurance/quality control analysis (QA/QC). Using a series of knowledge bases, the data can be analyzed, and a personalized healthcare report can be generated. In one embodiment, the knowledge bases described herein are accessed remotely, such as over the internet, accessed locally, such as being resident on a computer hard drive, or combinations thereof.

Personalized Reports

The methods described herein provide the ability to create a personalized report to select treatment, and, optionally, diagnostic monitoring, consistent with the personalized treatment. The report can optionally rank various treatment regimens, including monotherapy and combination therapy.

Advisory information as to why a particular therapy is being prescribed, and/or why a particular therapy is contraindicated, can also be provided. In this manner, the reasons for rejecting a particular regimen can be readily understood.

In one embodiment, the method allows one to provide diagnostic monitoring guidance. That is, a patient can be re-screened over time, and the effectiveness or ineffectiveness of a previously-prescribed therapeutic regimen can be evaluated. The report can also optionally include information on a reference strain to be used, the subtyping method, and, if desired, resistance data.

The report typically focuses on Genotyping & Drug resistance testing. Accordingly, this information (except viral loads) may or may not be displayed here, but can be combined with the Therapy Edge Data Exploratory Framework, as described herein in Example 4.

The reports can be used to perform genotyping & reporting assessments, and can include tools and interfaces to customize and/or adapt each genotyping analysis to the desired organisms/pathogens. In some embodiments, viruses are sequenced using Sanger sequencing, and in other embodiments, are sequenced using UDS. Both types of sequencing can be used, if desired.

The reports can be prepared to offer guidelines for effective treatment modalities, and references to the particular viral strains. The report can be fully integrated with a clinical data management platform by Therapy Edge (“TE”), and used with a variety of gene sequencers.

The report can optionally include a listing of silent mutations, all mutations, or just mutations of interest based on a specific category. User parameters can be used to define which mutations are “of interest”. Exemplary classifications include IAS mutations, IAS primary mutations, IAS secondary mutations, Stanford mutations with score>5, Stanford mutations with score>10, and Stanford mutations with score< >0.

Reports can list the general information related to the sample (including, but not limited to, sample ID, date of sample, and the like) as well as the subtype information (subtype+similarity with reference strain). The report can also list mutations for each protein, with drug resistance interpretations optionally displayed in a specific table, optionally based on the R (resistant), I (intermediate), S (sensible) classification, which can optionally be displayed using corresponding background colors. The GSS (if determined) is displayed at the bottom of the interpretation table.

In one embodiment, there is just one reference strain. In one embodiment, resistance data is displayed in the report, and in another embodiment, this data is not displayed.

Individual reports can be stored, and made available upon request from an appropriate interface.

Depending on the analyzed proteins, the reports can include individual table for each protein (for example, Viral Protease, Reverse transcriptase, Integrase, GP120, GP41, and the like). In each table, individual positions where mutations are observed on the analyzed population can optionally be displayed in rows according to the way which has been selected in the previous step. The list of displayed mutations can optionally also take into account mutations found in the Sanger sequences (if a Sanger-comparative analysis has been included), meaning that if some mutations are only available in the Sanger sequence, they will be displayed too.

The report can also present information related to a drug resistance susceptibility analysis. The analysis can list, for example, resistance interpretations for each ARV drug (related to the analyzed proteins), optionally further classified by class of drug: NRTI, NNRTI, PI, II, EI, and the like, depending on which guidelines have been chosen.

The interpretations can be displayed for each selected threshold as well as for the Sanger sequences (if enabled). The interpretations can be given though the R/I/S nomenclature (R: Resistant; I: Intermediate; S: Sensible; N/A: Not Available), optionally together with a specific background color.

Thus, using the methods, systems, and/or software described herein, an integrated analysis can be performed, using, for example, clinical data, biological data, molecular data, and ultra-deep sequencing information, stored on one or more knowledge bases, in an integrated analysis, to determine an appropriate treatment regimen. The regimen can optionally include a clonal/haplotype-based analysis and interpretation.

Additional types of information that can be included in the report include, but are not limited to, risk factors, clinical data, labs samples, labs results, embedded FibroMeter determination, HIV infection, HBV viral load, HCV viral load, HCV genotype, treatment outcome (RVR, eRVR, EVR, cEVR, pEVR, ETR, SVR, PV, NR), exams (Biopsy, Ishak, FibroScan, and the like), treatments and adverse effects, and recommended follow-up.

Use of the Methods to Monitor a Patient's Progress

By following a patient's progress over time, one can also obtain information about the efficacy of previous treatment regimens imposed on patients, including one or more of the viral load, the development of mutations, the development of side effects, and the like.

Use of the Methods in Research

In addition to being used for routine genotyping, the process can also be used for research, for example, to identify types of mutations in a virus following the administration of particular anti-viral or anti-cancer agents. The system can be interfaced with a dedicated Data Exploratory Framework that can be used for research, either on UDS-related molecular data only, or in correlation with clinical data.

Further objects and aspects of the present invention are explained in detail in the drawings herein and the specification set forth below.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 illustrates a process of the instant invention, including routines for entering a user-defined therapeutic treatment regimen and for entering a “non-recommended” therapeutic treatment regimen.

FIG. 2 schematically illustrates a system or apparatus of the present invention.

FIG. 3 illustrates a client-server environment within which the system of FIG. 2 may operate, according to an embodiment of the present invention, and wherein a central server is accessible by at least one local server via a computer network, such as the Internet, and wherein each local server is accessible by at least one client.

FIG. 4 illustrates a medical history user interface for entering data about a patient's medical history according to the present invention.

FIG. 5 illustrates a user interface chart for monitoring a patient's condition during a particular therapeutic treatment regimen over a period of time according to the present invention.

FIGS. 6A and 6B illustrate a therapy evaluation user interface that facilitates evaluation of various therapeutic treatment regimen options with respect to relative efficacy, individualized adjusted relative efficacy, dosage, frequency, cost, medical complications and drug interactions according to the present invention.

FIG. 7 illustrates various symbols for providing information about a therapeutic treatment regimen option within the therapy list box of the therapy evaluation user interface of FIGS. 6A and 6B according to the present invention.

FIG. 8 illustrates the therapy details box of FIGS. 6A and 6B in “full screen” mode.

FIG. 9 illustrates a pop-up menu including an indexed electronic link to a PDR® that can be activated from within the therapy list box of the therapy evaluation user interface of FIGS. 6A and 6B according to the present invention.

FIGS. 10A-10D illustrate various functions of the present invention as described in Example 1.

FIGS. 11A-11E illustrate various functions of the present invention as described in Example 2.

FIGS. 12A-12C illustrate various functions of the present invention as described in Example 3.

FIGS. 13A-13U illustrate various functions of the present invention as described in Example 4.

FIG. 14 is a chart which shows common mutations in HBV.

FIG. 15 is a chart showing the result of ultra-deep sequencing as applied to a sample containing HCV, wherein four different variants are shown, in their relative prevalence, and in terms of what mutations are present.

FIG. 16 is a chart showing types of analysis that can be included in a personal report, for HCV and HBV, including genotyping, subtyping, and the presence of mutations in both the virus (and in which enzyme or other target) and the host. Particularly with respect to HCV, the mutations in the host can determine the potential effectiveness of an anti-HCV treatment.

FIG. 17 is a chart showing, for a particular patient, the expected efficacy of various therapies.

FIG. 18 is a chart showing the effect of the presence of minority variant copies and adherence to antiviral therapy on virologic failure.

FIGS. 19-23 are charts showing various mutations associated with different classes of anti-HIV agents.

FIGS. 24 A-C are graphical representations of low-coverage information displayed on a DeepChek report, with no results displayed for the corresponding protein about mutations & interpretations.

FIG. 25 is a graphical representation of a coverage check & validation, position by position, for every protein in a screening assay.

FIGS. 26 A-C are graphical representations of how information from a screening assay, for mutations in various types of proteins relevant to an HIV screen, namely, reverse transcriptase, protease, integrase, GP120, and GP41, a series of at least two default profiles/patterns of criteria are provided in a patient report.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, or computer program product. Accordingly, the present invention may take the form of an entirely hardware embodiment, an entirely software embodiment, or an embodiment combining software and hardware aspects. Furthermore, the present invention may take the form of a computer program product on a computer-usable storage medium having computer readable program code means embodied in the medium. Any suitable computer readable medium may be utilized including, but not limited to, hard disks, CD-ROMs, optical storage devices, and magnetic storage devices.

The present invention provides a personalized medicine approach and diagnostic solution to treating disorders, particularly chronic disorders, which are potentially associated with more than one variant of the pathogen, even if a patient is only infected with a single variant. Specific pathogens include viruses such as HIV, HBV, and HCV, as well as various flu viruses. The susceptibility of a patient to other infectious diseases, such as bacterial and fungal diseases, can also be diagnosed, and personalized medicine approaches developed. Further, the existence of disorders associated with genetic mutations, in cancer cells, HLAs, and the like, can also be determined, and personalized medicine approaches developed.

(e) Determination of Single or Multiple Variant Strains

In some cases, a patient is only infected with a single strain of a pathogen, for example, only one variant of HIV-1. However, in other cases, a patient is infected with multiple strains/variants. Where a patient is infected with a major variant and one or more minor variants of a given pathogen, appropriate therapeutic regimens for treating the major variant and the one or more minor variants can be identified. The selection of appropriate therapeutic regimens can be based, at least in part, on an analysis of the variants, and a correlation of the variants with therapeutic regimens which are known to be effective against such variants.

The following information summarizes examples of available ways to screen samples for the presence of mutations. Although described below with respect to viral infections, such as HIV, HBV, and HCV, the same or similar analyses can also be used for bacteria, HLA, cancer cells, and the like.

NGS

There are a number of commercially-available next generation sequencing (NGS) platforms, including the Roche (454) FLX Genome Sequencer, Illumina Genome Analyzer II, and Applied Biosystems' SOLiD™ (Sequencing by Oligo Ligation and Detection) System. In addition, single molecule sequencers, “third-generation sequencers”, have been developed. Helicos' HeliScope employs True Single Molecule Sequencing (tSMS) technology to sequence samples without amplification, and can produce over 10 Gb of sequence data per 8 day run. Pacific Biosciences has developed Single Molecule Real Time (SMRT™) sequencing technology, which involves proprietary surface and nucleotide chemistries.

NGS Sequencing Chemistry

Roche-Pyrosequencing involves using a pyrophosphate molecule, released following nucleotide incorporation by DNA polymerase, to propagate reactions that ultimately produce light.

Illumina-sequencing-by-synthesis involves using four differently labeled fluorescent nucleotides with their 3′-OH groups chemically inactivated to ensure only a single base is incorporated per cycle. Each base incorporation cycle is followed by an imaging step to identify the base that is incorporated, and a chemical step that removes the fluorescent group and deblocks the 3′ end for the next base incorporation cycle.

Applied Biosystems/Life Technologies

The SOLiD system uses a ligation-based sequencing process that starts by annealing a universal sequencing primer that is complementary to the SOLiD-specific adaptors on the library fragments. Then, a limited set of semi-degenerate 8-mer oligonucleotides (and DNA ligase) is added. When matching 8-mers hybridize to DNA fragment sequences adjacent to the universal primer, DNA ligase seals the phosphate backbone and a fluorescent readout identifies the fixed base of the 8-mer. A subsequent cleavage step removes bases 6-8 of the ligated 8-mer, removing the fluorescent group and enabling another round of 8-mer ligation, and so on. The advantage of ligation-based sequencing chemistry is the “built-in” quality check of read accuracy.

Amplification Approach

Emulsion PCR is the amplification approach used by both Roche and Applied Biosystems. For the Roche platform, emulsion PCR is carried out on the DNA fragments attached to the surfaces of agarose beads. On the Applied Biosystems sequencer, the DNA fragements are attached to the surfaces of magnetic beads. Bridge amplification (Illumina) is a PCR reaction that occurs within a discrete area of the flow cell surface.

Read Length/Mb Per Run/Time Per Run

NGS produces shorter reads (25-400 bp) with varying “read length” among different NGS platforms. Roche provides the longest read (400 bp with the Titanium system) while Illumina and Applied Biosystems are much shorter (32-75 bp and 35 bp, respectively).

Sanger Sequencing

Dideoxynucleotide (Sanger) sequencing of non-clonal PCR products (direct PCR sequencing) of plasma viral cDNA is widely used to detect genetic mutations. For example, more than 50 drug-resistance mutations in the molecular targets of HIV-1 therapy, including reverse transcriptase (RT) and protease, have been identified using this technique in clinical settings (US Department of Health and Human Services Panel on Clinical Practices for Treatment of HIV Infection 2006).

A major limitation of direct PCR sequencing, however, is its inability to detect low proportions of drug-resistant variants in the heterogeneous virus population existing in a patient's plasma sample. Minor drug-resistant variants that are not detected by population-based sequencing are clinically relevant, in that they are often responsible for the virological failure of a new antiretroviral treatment regimen.

NGS

There are a number of commercially-available NGS platforms, including the Roche (454) FLX Genome Sequencer, Illumina Genome Analyzer II, and Applied Biosystems' SOLiD™ (Sequencing by Oligo Ligation and Detection) System. In addition, single molecule sequencers, “third-generation sequencers”, have been developed. Helicos' HeliScope employs True Single Molecule Sequencing (tSMS) technology to sequence samples without amplification, and can produce over 10 Gb of sequence data per 8 day run. Pacific Biosciences has developed Single Molecule Real Time (SMRT™) sequencing technology, which involves proprietary surface and nucleotide chemistries.

In one embodiment, next generation sequencing is used to determine i) an HIV sequence for HIV drug resistance determination and/or host determination, and ii) a quantification of the HIV viral load.

Applied Biosystems/Life Technologies

The SOLiD system uses a ligation-based sequencing process that starts by annealing a universal sequencing primer that is complementary to the SOLiD-specific adaptors on the library fragments. Then, a limited set of semi-degenerate 8-mer oligonucleotides (and DNA ligase) is added. When matching 8-mers hybridize to DNA fragment sequences adjacent to the universal primer, DNA ligase seals the phosphate backbone and a fluorescent readout identifies the fixed base of the 8-mer. A subsequent cleavage step removes bases 6-8 of the ligated 8-mer, removing the fluorescent group and enabling another round of 8-mer ligation, and so on. The advantage of ligation-based sequencing chemistry is the “built-in” quality check of read accuracy.

NGS Sequencing Chemistry

Roche-Pyrosequencing involves using a pyrophosphate molecule, released following nucleotide incorporation by DNA polymerase, to propagate reactions that ultimately produce light.

Illumina-sequencing-by-synthesis involves using four differently labeled fluorescent nucleotides with their 3′-OH groups chemically inactivated to ensure only a single base is incorporated per cycle. Each base incorporation cycle is followed by an imaging step to identify the base that is incorporated, and a chemical step that removes the fluorescent group and deblocks the 3′ end for the next base incorporation cycle.

Amplification Approach

Emulsion PCR is the amplification approach used by both Roche and Applied Biosystems. For the Roche platform, emulsion PCR is carried out on the DNA fragments attached to the surfaces of agarose beads. On the Applied Biosystems sequencer, the DNA fragements are attached to the surfaces of magnetic beads. Bridge amplification (Illumina) is a PCR reaction that occurs within a discrete area of the flow cell surface.

Read Length/Mb Per Run/Time Per Run

NGS produces shorter reads (25-400 bp) with varying “read length” among different NGS platforms. Roche provides the longest read (400 bp with the Titanium system) while Illumina and Applied Biosystems are much shorter (32-75 bp and 35 bp, respectively).

Amplicon-Based Sequencing

Amplicon-based screening can be used to provide more sensitive screening than Sanger screening. One example of amplicon-based screening is 454 Sequencing. 454 Sequencing uses a large-scale parallel pyrosequencing system capable of sequencing roughly 400-600 megabases of DNA per 10-hour run, using a Genome Sequencer FLX with GS FLX Titanium series reagents.

The system relies on fixing nebulized and adapter-ligated DNA fragments to small DNA-capture beads in a water-in-oil emulsion. The DNA fixed to these beads is then amplified by PCR. Each DNA-bound bead is placed into a ˜29 μm well on a PicoTiterPlate, a fiber optic chip. A mix of enzymes such as DNA polymerase, ATP sulfurylase, and luciferase are also packed into the well. The PicoTiterPlate is then placed into the GS FLX System for sequencing.

454 Sequencing (454 Life Sciences), using GS FLX Titanium series reagents on a Genome Sequencer FLX instrument has the ability to sequence 400-600 million base pairs per run with 400-500 base pair read lengths. It is possible that newer approaches will enable sequencing read lengths of up to 1,000 bp in 2010. The GS Junior System (454 Life Sciences) is a bench top version of the Genome Sequencer FLX System, and can also be used.

DNA Library Preparation and emPCR

Genomic DNA is fractionated into smaller fragments (300-800 base pairs) and polished (made blunt at each end). Short adaptors are then ligated onto the ends of the fragments. These adaptors provide priming sequences for both amplification and sequencing of the sample-library fragments. One adaptor (Adaptor B) contains a 5′-biotin tag for immobilization of the DNA library onto streptavidin-coated beads. After nick repair, the non-biotinylated strand is released and used as a single-stranded template DNA (sstDNA) library. The sstDNA library is assessed for its quality and the optimal amount (DNA copies per bead) needed for emPCR is determined by titration.

The sstDNA library is immobilized onto beads. The beads containing a library fragment carry a single sstDNA molecule. The bead-bound library is emulsified with the amplification reagents in a water-in-oil mixture. Each bead is captured within its own microreactor where PCR amplification occurs. This results in bead-immobilized, clonally amplified DNA fragments.

Sequencing

Single-stranded template DNA library beads are added to the DNA Bead Incubation Mix (containing DNA polymerase) and are layered with Enzyme Beads (containing sulfurylase and luciferase) onto a PicoTiterPlate device. The device is centrifuged to deposit the beads into the wells. The layer of Enzyme Beads ensures that the DNA beads remain positioned in the wells during the sequencing reaction. The bead-deposition process is designed to maximize the number of wells that contain a single amplified library bead.

The loaded PicoTiterPlate device is placed into the Genome Sequencer FLX Instrument. The fluidics sub-system delivers sequencing reagents (containing buffers and nucleotides) across the wells of the plate. The four DNA nucleotides are added sequentially in a fixed order across the PicoTiterPlate device during a sequencing run. During the nucleotide flow, millions of copies of DNA bound to each of the beads are sequenced in parallel. When a nucleotide complementary to the template strand is added into a well, the polymerase extends the existing DNA strand by adding nucleotide(s). Addition of one (or more) nucleotide(s) generates a light signal that is recorded by the CCD camera in the instrument. This technique is based on sequencing-by-synthesis and is called pyrosequencing, and can be used in addition to, or in place of, other techniques such as molecular and limiting dilution clonal sequencing.

The signal strength is proportional to the number of nucleotides; for example, homopolymer stretches, incorporated in a single nucleotide flow generate a greater signal than single nucleotides. However, the signal strength for homopolymer stretches is linear only up to eight consecutive nucleotides after which the signal falls-off rapidly. Data can be stored, for example, in standard flowgram format (SFF) files for downstream analysis.

Applications

454 Sequencing can sequence any double-stranded DNA and enables a variety of applications, including de novo whole genome sequencing, re-sequencing of whole genomes and target DNA regions, metagenomics and RNA analysis.

Full genome sequencing (de novo sequencing and resequencing)

Full genome sequencing (FGS), also referred to as whole genome sequencing (WGS), allows one to sequence the entire genome of an organism. Examples of organisms that can be sequenced include humans, dogs, mice, viruses and bacteria.

Amplicon Sequencing

Amplicon (ultra deep) sequencing is enabled through 454 Sequencing technology. This method is designed to allow mutations to be detected at extremely low levels, and PCR amplify specific, targeted regions of DNA. This method can be used to identify low frequency somatic mutations in cancer samples, or discovery of rare variants in HIV infected individuals.

Transcriptome Sequencing

Transcriptome sequencing encompasses experiments including small RNA profiling and discovery, mRNA transcript expression analysis (full-length mRNA, expressed sequence tags (ESTs) and ditags, and allele-specific expression) and the sequencing and analysis of full-length mRNA transcripts. The transcriptome data derived from the Genome Sequencer FLX is ideally suited to detailed transcriptome investigation into single nucleotide polymorphisms (SNPs), insertion-deletion and splice-variant discovery.

Sequence Data and Alignment

In a typical analysis of an HIV sample, the amplicon-based sequencing platform, such as a GS20 sequencing platform, generates an average of over 6,000 reads per sample (mean length of 105 nucleotides [nt]) on four HIV-1 plasmid DNA clones and eight RT-PCR products derived from HIV-1-infected plasma samples.

Should there be an interest in comparing DeepChek® data with Sanger-sequencing data, algorithms, such as the Asymmetric Smith-Waterman (ASW) algorithm, can be used. Such algorithms incorporate the phred-equivalent quality scores into the pairwise alignment between GS20 reads and the sequence generated using direct PCR Sanger sequencing.

Because the individual GS20 reads are usually similar to the reference sequence, the ASW algorithm may not outperform BLAST or Smith-Waterman algorithms, so these algorithms can also be used. However, when these three alignment algorithms used in connection with more distantly related sequences (e.g., sequences belonging to different subtypes) as might occur in the case of a virus super-infection with a divergent strain, the ASW algorithm is believed to map a slightly higher percentage of nucleotides, and to have a slightly lower error rate, than both BLAST and Smith-Waterman algorithms.

Determination of HIV Genotypes in Patients with Extremely Low Viral Loads

Ultra-deep pyrosequencing can be used to detect minority variant drug-resistance mutations in previously-treated patients in whom mutations are no longer detectable by standard direct PCR sequencing. Ultra-deep pyrosequencing can also be used to detect minor variants in the HIV-1 RT and protease genes from clinical plasma samples.

The same determination can be carried out with respect to other viral diseases, such as HCV and HBV. The use of pyrosequencing techniques in connection with HBV (Homs et al., “Ultra-deep pyrosequencing analysis of the hepatitis B virus preCore region and main catalytic motif of the viral polymerase in the same viral genome,” Nucleic Acids Res Oct. 1, 2011 39: 8457-8471, and also in connection with HCV (Verbinnen et al., “Tracking the Evolution of Multiple In Vitro Hepatitis C Virus Replicon Variants under Protease Inhibitor Selection Pressure by 454 Deep Sequencing,” J. Virol. Nov. 1, 2010 84: 11124-11133) has been described in the literature.

HIV-1

When screening a patient's HIV, mutations are commonly identified in the pol gene, and the proteins of interest are typically the HIV reverse transcriptase, protease, and integrase enzymes.

There are three main types of mutations. There are mutations that result in drug resistance. There are mutations that do not result in drug resistance, but do result in an amino acid change in the protein. There are also mutations that do not result in drug resistance, and also do not result in an amino acid change in the protein.

Tables of mutations present in the one or more HIV-1 variants present in the patient sample can be prepared. For purposes of determining an appropriate treatment regimen, it is only necessary to consider mutations that result in drug resistance. However, there are often reasons to consider the other two types of mutations. Also, when considering whether more than one type of HIV-1 virus is present, the identification of mutations not associated with drug resistance can be used to identify the various HIV-1 variants.

Minority Variant Copies of HIV

Although success rates are high with anti-HIV treatment, further improvements in tailoring regimens to resistance genotypes would avoid the costs associated with treatment failure and the accumulation of additional drug resistance mutations. A number of studies have been undertaken to evaluate the effects of baseline low-frequency NNRTI and nucleoside reverse transcriptase inhibitor (NRTI) resistance mutations on the rates of treatment failure associated with the initial ART regimen.

Patients with minority variant copies (MVC) of HIV (defined herein as the percentage (%) of variant present in the UDS sequences and multiplied by the Viral Load) have significantly higher virologic failure than patients without MVC of HIV. They typically also have lower CD4 cell counts than those in whom these variants are not detected. (see, for example. Li et al, “Low-Frequency HIV-1 Drug Resistance Mutations and Risk of NNRTI-Based Antiretroviral Treatment Failure, A Systematic Review and Pooled Analysis” JAM A. 2011; 305 (13):1327-1335).

Li found that, compared with all patients without minority variants, patients with minority variants and less than 95% medication adherence had 5.1 times the risk of virologic failure, and those with minority variants and 95% or greater adherence had 1.5 times the risk of virologic failure. Thus, the presence of these minority variants may adversely affect the response to antiretroviral treatment (ART).

Given the virologic failure rates for patients with and without NNRTI resistant minority variants (37% and 15%, respectively, over a median 31-month follow-up period), it would be advantageous to screen for the presence of MVC before initiating therapy. One can look for the types of mutations shown in Figures _. Indication of the presence of one or more of these primary mutations can be used to design appropriate therapeutic regimens that treat the main virus and the minority variant(s) of the virus as well.

The presence of MVCs can be determined using a number of ultrasensitive assays, including allele-specific PCR (including the HIV SNaPshot assay) and ultradeep pyrosequencing (Roche/454 Life Sciences, Branford, Conn.), which can detect mutations present at a far lower frequency than standard population sequencing. If one sets a threshold, it is important that the screening performed to identify such minority variants is sensitive enough to meet this threshold. For example, if a 1% threshold is set for analyzing minority variants, a screen cannot be used if it has a limit of detection of 2%. Ultra deep sequencing can detect additional NNRTI-resistant minority variants (for example, G190A K101E, and P225H). The lower limit of detection of minority variants differs between assays, with a typical upper range of 2% for the HIV-SNaPshot assay and a lower range of 0.003% for allele-specific PCR assays.

HBV

Serological markers are key elements in diagnosing acute hepatitis B virus (HBV) infection. Once treatment of chronic HBV is initiated with approved anti-hepadnaviral agents, such as lamivudine, interferon-alpha, or adefovir dipivoxil, the measurement of HBV DNA in serum can not only help monitor treatment efficacy but also indicates breakthrough infection should drug resistance emerge.

The analyses described herein can further pinpoint the type of mutation responsible and, more importantly, detect upcoming viral resistance at an early stage when the variant represents only a minor fraction of the total viral population. This can be particularly relevant for patients at high risk for disease progression or acute exacerbation.

There are two main therapeutic approaches to control HBV infection and its sequelae—immunomodulatory agents and/or antiviral chemotherapy. The first therapeutic agent to be approved for hepatitis B was interferon-alpha (IFN-α), whose dual mode of action includes both antiviral and immunomodulatory effects. Unfortunately, extended IFN-α treatment is expensive, injection-dependent, effective in no more than 15-25% of patients, and associated with a wide spectrum of adverse reactions.

The nucleoside analogue lamivudine has become the gold standard worldwide for patients with chronic hepatitis B. It is relatively affordable, involves taking just one pill per day, and has a low incidence of side effects. Nevertheless, lamivudine-induced decreases in viral load are difficult to sustain over time due to the occurrence of viral drug resistance. Thus, the antiviral effects of the drug are gradually reversed in most cases. The ensuing rebound effect is termed “breakthrough infection.” Genotypic resistance to lamivudine emerges in approximately one quarter of patients after one year of treatment, rising to more than 40% after two years, and increasing further to over 50% and 70% after years three and four, respectively.

Additional anti-HBV agents include the nucleotide analog adefovir dipivoxil. Its antiviral efficacy was confirmed in large-scale clinical trials for the therapy of both HbeAg-positive and HbeAg-negative chronic hepatitis B, achieving more than a 3-log decrease in viral load, a significant drop in serum ALT levels. Resistance surveillance in adefovir-treated patients for potential resistance mutations showed mutations after 96 weeks. Resistance testing for adefovir mutations is advisable.

HBV is a small but elusive DNA virus that presents relatively few specific targets for antiviral interventions. At present, the target of choice is the HBV polymerase protein—an enzyme that plays an essential role in viral replication. Within its four functional regions, drug resistance to lamivudine is associated with mutations in the very conserved catalytic polymerase/reverse transcriptase domain of the gene, located specifically at a locus of four amino acids consisting of tyrosine-methionine-aspartate-aspartate, termed the YMDD motif. It is thought that lamivudine acts here by suppressing HBV replication.

When mutations occur, the configuration of the wild-type YMDD motif becomes altered in such a way that the drug no longer successfully exerts its inhibitory action at that site. Both wild-type and resistance virus strains then populate the infected liver. HBV DNA and ALT levels usually begin to rebound, but are generally lower compared to baseline levels when only wild-type virus is present.

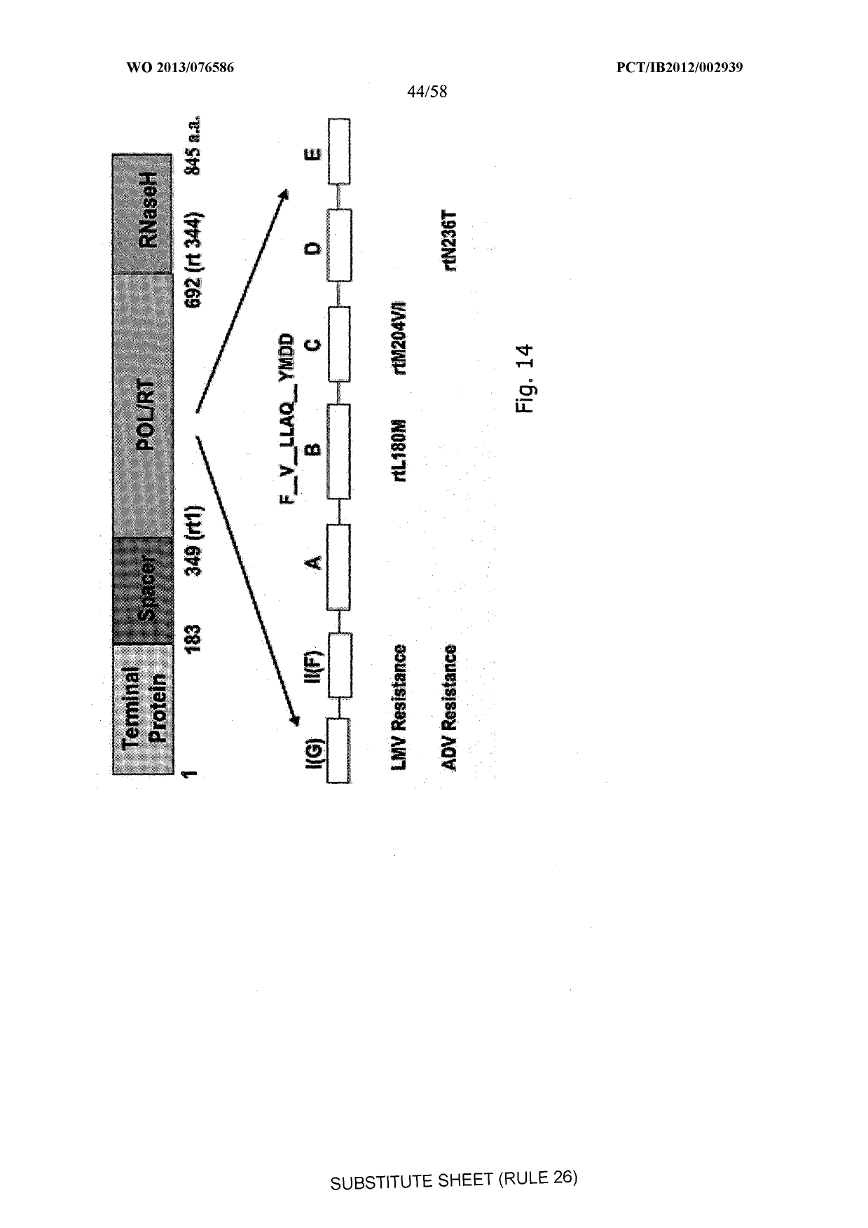

Three key mutations in the polymerase gene have been shown to confer resistance to lamivudine and adefovir dipivoxil, although many other mutations have also been described. The main mutations are shown in FIG. 14.

The first two include the substitution of methionine (M) by the amino acids isoleucine (I) or valine (V) in the YMDD motif (C domain) at position rtM204V/I. In the majority of cases, these mutations in the YMDD motif occur together with an additional compensatory mutation in the B subdomain, namely the substitution of a leucine by methionine some 20 amino acids upstream from the YMDD domain at position rtL180M. Finally, the mutant to adefovir (rtN236T) is located downstream from the YMDD motif in the D domain of the viral polymerase.

Resistance to antiviral therapy (assuming the patient was on such therapy) is presently defined as (i) an increase in serum HBV DNA titers during therapy after a sustained viral response and (ii) the selection of a mutation in the viral polymerase gene (YMDD motif of the polymerase C domain) that could not be detected in the major viral species prior to therapy, and that is not included in the HBV consensus sequences from data banks (i.e., genotypic resistance).

Standard DNA sequencing technology provides highly accurate and complete DNA sequence information, and is applicable to any part of the 3.2-kilobase HBV genome. However, this approach is not able to detect viral resistance even when the mutated virus still makes up a relatively large fraction (up to 30%) of the entire HBV population (i.e., mixtures of wild-type and mutant species). This limits its use for detecting upcoming resistance at an early stage. Furthermore, it tends to be time-consuming and labor intensive, not readily adaptable to high-throughput screening, and is amenable to analysis only by well-trained personnel.

An additional difficulty when using direct DNA sequencing of a PCR product is to know whether a given set of mutations occurs on the same molecule or in a different clonal subpopulation. This obstacle can overcome using the ultra-deep sequencing described herein.

HCV

HCV is typically treated with pegylated alpha-interferon and ribavirin. However, antiviral nucleosides are also being used, including boceprevir (Victrelis, Merck & Co) and telaprevir (Incivek, Vertex Pharmaceuticals). These agents can be used in combination with pegylated alpha-interferon and ribavirin for the treatment of HCV genotype 1 infection.

HCV variants containing mutations that confer reduced susceptibility to boceprevir and telaprevir emerged in patients who experienced sub-optimal treatment response.

Assays such as the HCV GenoSure NS3/4A analyze the genetic sequence for the non-structural proteins NS3 and NS4A of HCV genotypes 1a and 1b that encode for an enzyme essential to viral replication. The assay detects mutations in NS3 and NS4A, and specifically identifies those associated with boceprevir and telaprevir resistance.

The use of resistance testing to guide antiviral drug treatment can provide value to the clinical management of HCV infection. However, as with HIV and HBV, when using direct DNA sequencing of a PCR product, it is not possible is to know whether a given set of mutations occurs on the same molecule or in a different clonal subpopulation. This obstacle can overcome using the ultra-deep sequencing described herein.

Another issue with HCV patients is that there are many types of HCV. (see, for example, Lee et al., “Evaluation and comparison of different hepatitis C virus genotyping and serotyping assays,” Journal of Hepatology, Volume 26, Issue 5, Pages 1001-1009, May 1997). The geno/subtype of hepatitis C virus (HCV) is predictive of the response to initerferon-α or other therapies. Accordingly, typing methods are clinical useful. Common typing methods include a reverse hybridization assay, and a DNA immunoassay based on immobilized type-specific probes for the 5′-noncoding and the core region, respectively. A third genotyping assay utilized type-specific primers for amplification of the core region. Serotyping assays detect type-specific antibodies of the nonstructural-4 region (enzyme immunoassay) or of the core and nonstructural-4 region (recombinant immunoblot assay). Geno/subtyping of HCV isolates can be performed by sequency and phylogenetic analysis of the nonstructural-5B region.

Lee showed that all of these genotyping systems amplify the respective target region of the HCV genome with high sensitivity. The reverse hybridization assay and the DNA immunoassay can be used to identify HCV-1, -2, and -3. However, the DNA immunoassay can misinterpret HCV-4 isolates as HCV-4 and -5 coinfection. In the type-specific amplification assay, coinfections of subtypes HCV-1a and HCV-3a with HCV-1b could not be excluded. The reverse hybridization assay misinterpreted 1/14 HCV-1a isolates as HCV-1b, and vice versa 3/36 HCV-1b isolates as HCV-1a. Furthermore, differentiation between HCV-2a and -2c was not possible using this assay. The DNA immunoassay correctly identified all HCV subtypes. The serotyping assays, recombinant immunoblot assay and enzyme immunoassay identified HCV-1, -2, and -3 in 93% and 89% of cases, respectively. HCV-4, however, could only be recognized by the enzyme immunoassay. Lee concluded that the reverse hybridization assay and the DNA immunoassay specifically identified HCV genotypes 1, 2, and 3, while crossreactivity occurred in the primer-specific amplification assay. The DNA immunoassay achieved the best performance in HCV subtyping. Both serotyping systems correctly identified HCV-1, -2, and -3 in about 90% of cases, but lacked the possibility of subtyping.

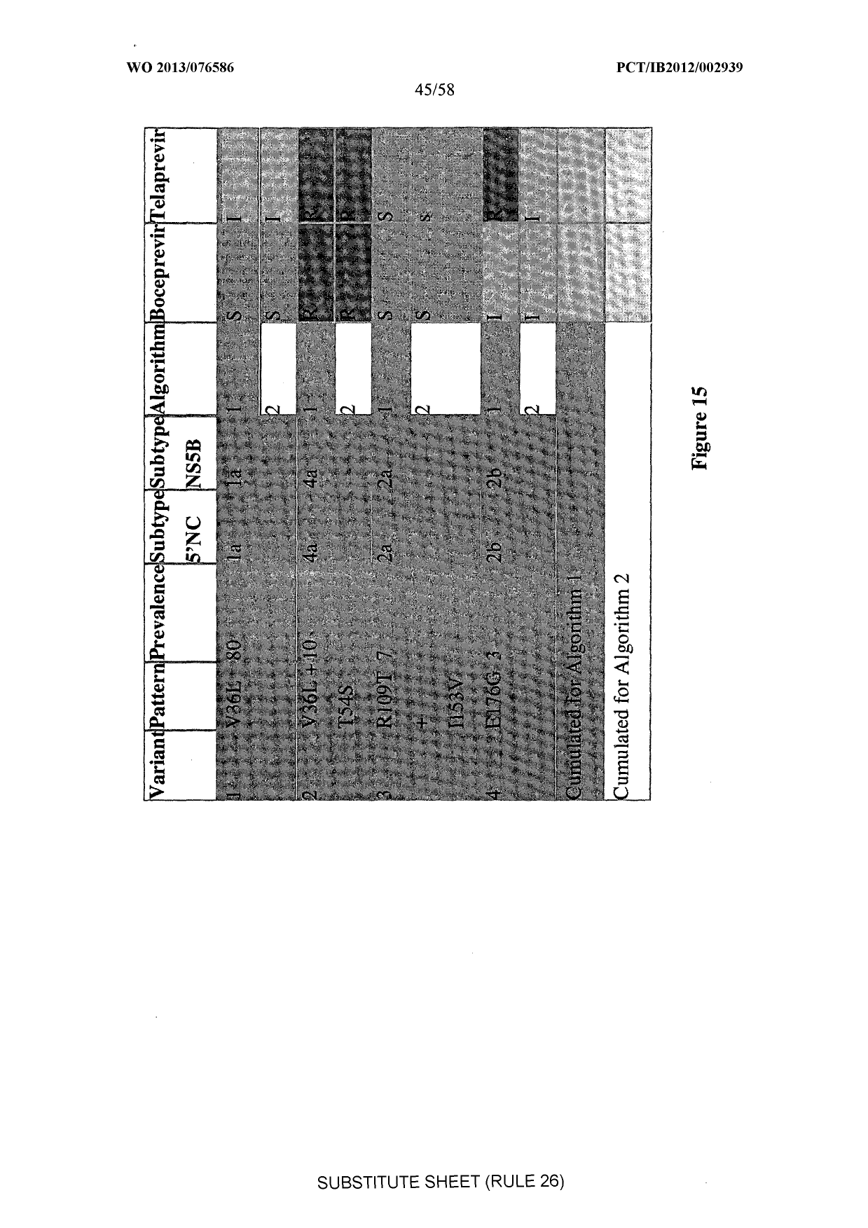

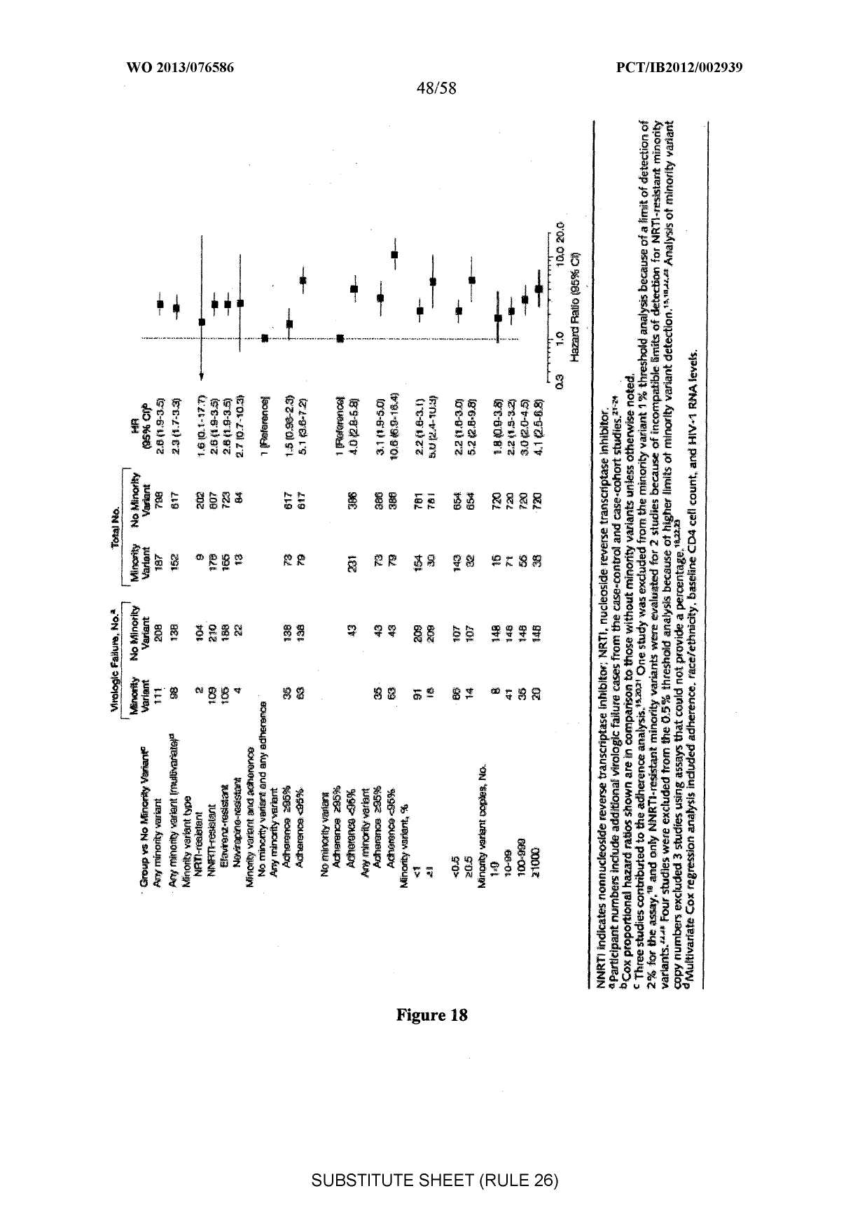

In order to provide the best possible care, it is important to know which type or types of HCV are present. The use of ultra-deep sequencing can provide the subtyping needed to provide such care. As shown in FIGS. 15 and 18, patient samples were screened to determine the prevalence of the different subtypes, and, using ultra-deep sequencing, it was possible to do so. FIG. 15 also shows the expected virological response to boceprevir and telaprevir, based on the presence or absence of certain mutations.

Flu Viruses

Antiviral resistance in flu viruses, such as influenza, means that a virus has changed in such a way that the antiviral drug is less effective in treating or preventing illnesses. In the United States, four antiviral drugs are FDA-approved for use against influenza: amantadine, rimantadine, zanamivir (Relenza®) and oseltamivir (Tamiflu®). The rifabutin drugs (amantadine and rimantadine) are approved for influenza A, while the neuraminidase inhibitor drugs (zanamivir and oseltamivir) are approved for both influenza A and influenza B. The CDC issues guidance for health care providers on which antiviral drugs to use each flu season.

Flu viruses often change from one season to the next, and can even change within the course of one flu season. As an influenza virus replicates, the genetic makeup may change in a way that results in the virus becoming resistant to one or more of the antiviral drugs used to treat or prevent influenza.

Antiviral resistance can be detected by collecting a sample of the virus and determining if it is resistant to any of the four FDA-approved influenza antiviral drugs. In patients identified as having mutations associated with resistance to these drugs, appropriate therapy can be provided.

Where the patient has a minor variant that includes these resistance genes, such may not be detected using direct DNA sequencing of a PCR product (i.e., it is not possible is to know whether a given set of mutations occurs on the same molecule or in a different clonal subpopulation). This obstacle can overcome using the ultra-deep sequencing described herein.

Determination of Mutations in Cancer Cells

The systematic characterization of somatic mutations in cancer genomes is essential for understanding the disease and for developing targeted therapeutics (Zhengyan Kan et al., “Diverse somatic mutation patterns and pathway alterations in human cancers,” Nature, Vol. 466, Pages 869-873 (12 Aug. 2010). Zhengyan identified 2,576 somatic mutations across ˜1,800 megabases of DNA representing 1,507 coding genes from 441 tumors comprising breast, lung, ovarian and prostate cancer types and subtypes. Mutation rates and the sets of mutated genes varied substantially across tumor types and subtypes. Statistical analysis identified 77 significantly mutated genes including protein kinases, G-protein-coupled receptors such as GRM8, BAI3, AGTRL1 (also called APLNR) and LPHN3, and other druggable targets. Integrated analysis of somatic mutations and copy number alterations identified another 35 significantly altered genes including GNAS, indicating an expanded role for gα subunits in multiple cancer types. Furthermore, there are functional roles of mutant GNAO1 (a Gα subunit) and mutant MAP2K4 (a member of the JNK signaling pathway) in oncogenesis.

A number of these mutations occur in relatively low frequency, so a routine PCR screen might not identify the existence of these mutations. Thus, chemotherapy prescribed for cancer cells that do not include these somatic mutations may be ineffective against the low prevalence of cancer cells with these mutations. As a result, the chemotherapy may be effective against some of the cancer cells, but the other cancer cells may thrive, resulting in a poor outcome for the patient.

The use of ultra-deep sequencing can provide the ability to determine the major types of cancer cells, while also identifying the presence of these low prevalence cells with somatic mutations. Thus, appropriate therapeutic regimens can be identified for such patients.

Determination of HLA Types

The human leukocyte antigen (HLA) system is the name of the major histocompatibility complex (MHC) in humans. The super locus contains a large number of genes related to immune system function in humans. This group of genes resides on chromosome 6, and encodes cell-surface antigen-presenting proteins and many other genes. The HLA genes are the human versions of the MHC genes that are found in most vertebrates (and thus are the most studied of the MHC genes). The proteins encoded by certain genes are also known as antigens, as a result of their historic discovery as factors in organ transplants. The major HLA antigens are essential elements for immune function. Different classes have different functions:

HLAs corresponding to MHC class I (A, B, and C) present peptides from inside the cell (including viral peptides if present). These peptides are produced from digested proteins that are broken down in the proteasomes. In general, the peptides are small polymers, about 9 amino acids in length. Foreign antigens attract killer T-cells (also called CD8 positive- or cytotoxic T-cells) that destroy cells.

HLAs corresponding to MHC class II (DP,DM, DOA,DOB,DQ, and DR) present antigens from outside of the cell to T-lymphocytes. These particular antigens stimulate the multiplication of T-helper cells, which in turn stimulate antibody-producing B-cells to produce antibodies to that specific antigen. Self-antigens are suppressed by suppressor T-cells.

HLAs corresponding to MHC class III encode components of the complement system.

HLAs have other roles. They are important in disease defense. They may be the cause of organ transplant rejections. They may protect against or fail to protect (if down regulated by an infection) against cancers. They may mediate autoimmune disease (examples include type I diabetes disease).

Aside from the genes encoding the 6 major antigens, there are a large number of other genes, many involved in immune function, located on the HLA complex. Diversity of HLAs in the human population is one aspect of disease defense, and, as a result, the chance of two unrelated individuals with identical HLA molecules on all loci is very low. HLA genes have historically been identified as a result of the ability to successfully transplant organs between HLA-similar individuals.

Infectious Disease

When a foreign pathogen enters the body, specific cells called antigen-presenting cells (APCs) engulf the pathogen through a process called phagocytosis. Proteins from the pathogen are digested into small pieces (peptides) and loaded onto HLA antigens (to be specific, MHC class II). They are then displayed by the antigen-presenting cells to T cells, which then produce a variety of effects to eliminate the pathogen.

Through a similar process, proteins (both native and foreign, such as the proteins of virus) produced inside most cells are displayed on HLAs (to be specific, MHC class I) on the cell surface. Infected cells can be recognized and destroyed by CD8+ T cells.

Graft Rejection

Any cell displaying some other HLA type is “non-self” and is seen as an invader by the body's immune system, resulting in the rejection of the tissue bearing those cells. This is particularly important in the case of transplanted tissue, because it could lead to transplant rejection. Because of the importance of HLA in transplantation, the HLA loci are some of the most frequently typed by serology and PCR.

In one embodiment, the methods described herein are used to determine whether or not a patient will likely reject a particular graft. In this embodiment, biological samples from the patient and from the putative graft are screened, for example, by PCR, and a comparison is made as to whether the graft is suitable.

Autoimmunity

Certain inherited HLA types are associated with autoimmune disorders and other diseases. People with certain HLA antigens are more likely to develop certain autoimmune diseases, such as type I diabetes, ankylosing spondylitis, celiac disease, SLE (systemic lupus erythematosus), myasthenia gravis, inclusion body myositis, and Sjögren syndrome. A list of HLA types associated with these disorders is provided below:

| HLA allele | Diseases with increased risk |
|---|---|
| HLA-B27 | Ankylosing spondylitis |
| | Postgonococcal arthritis |
| | Acute anterior uveitis |
| HLA-B47 | 21-hydroxylase deficiency |
| HLA-DR2 | Systemic lupus erythematosus |
| HLA-DR3 | Autoimmune hepatitis |
| | Primary Sjögren syndrome |
| | Diabetes mellitus type 1 |
| | Systemic lupus erythematosus |
| HLA-DR4 | Rheumatoid arthritis |
| | Diabetes mellitus type 1 |
| HLA-DR3 | and Diabetes mellitus type 1 |

DR4 Combined

HLA typing has led to some improvement and acceleration in the diagnosis of celiac disease and type 1 diabetes. For DQ2 typing to be useful, it typically requires either high-resolution B l*typing (resolving *02:01 from *02:02), DQA1*typing, or DR serotyping. Current serotyping can resolve, in one step, DQ8. HLA typing in autoimmunity is being increasingly used as a tool in diagnosis. In celiac disease, it is the only effective means of discriminating between first-degree relatives that are at risk from those that are not at risk, prior to the appearance of sometimes-irreversible symptoms such as allergies and secondary autoimmune disease.

In one embodiment, a patient suffering from an autoimmune disorder is screened for the presence of certain HLA antigens. Expert information stored on a knowledge base, relating to which therapies are appropriate for patients with certain HLA antigens, can be used to help determine an appropriate therapy for these patients.

Cancer

Some HLA-mediated diseases are directly involved in the promotion of cancer. Gluten-sensitive enteropathy is associated with increased prevalence of enteropathy-associated T-cell lymphoma, and DR3-DQ2 homozygotes are within the highest risk group, with close to 80% of gluten-sensitive enteropathy-associated T-cell lymphoma cases.

In one embodiment, a patient suffering from, or suspected of suffering from a cancer resulting from the presence of certain HLA antigens is diagnosed using an appropriate methodology, such as PCR. Expert information stored on a knowledge base, relating to which anti-cancer therapies are appropriate for patients with certain HLA antigens, can be used to help determine an appropriate therapy for these patients to treat and/or prevent these cancers.

Variability

Five loci have over 100 alleles that have been detected in the human population. Of these, the most variable are HLA B and HLA DRB1. As of 2004, the number of alleles that have been determined are listed in the table below. To interpret this table, it is necessary to consider that an allele is a variant of the nucleotide (DNA) sequence at a locus, such that each allele differs from all other alleles in at least one (single nucleotide polymorphism, SNP) position. Most of these changes result in a change in the amino acid sequences that result in slight to major functional differences in the protein.

There are issues that limit this variation. Certain alleles like DQA1*05:01 and DQA1*05:05 encode proteins with identically processed products. Other alleles like DQB1*0201 and DQB1*0202 produce proteins that are functionally similar. For class II (DR, DP and DQ), amino acid variants within the receptor's peptide-binding cleft tend to produce molecules with different binding capability.

MHC class I

| locus | #^{[7][8]} |
|---|---|
| Major Antigens | |
| HLA A | 767 |
| HLA B | 1,178 |
| HLA C | 439 |
| Minor Antigens | |
| HLA E | 9 |
| HLA F | 21 |
| HLA G | 43 |

MHC class II

| HLA | -A1 | -B1 | -B3 to -B5¹ | Potential |
|---|---|---|---|---|
| locus | #^{[8]} | #^{[8]} | #^{[8]} | Combinations |
| DM- | 4 | 7 | | 28 |
| DO- | 12 | 9 | | 72 |
| DP- | 27 | 133 | | 3,591 |
| DQ- | 34 | 96 | | 3,264 |
| DR- | 3 | 618 | 82 | 2,121 |

¹DRB3, DRB4, DRB5 have variable presence in humans

Sequence Feature Variant Type (SFVT)

The large extent of variability in HLA genes poses significant challenges in investigating the role of HLA genetic variations in diseases. Disease association studies typically treat each HLA allele as a single complete unit, which does not illuminate the parts of the molecule associated with disease. The Sequence Feature Variant Type (SFVT) approach for HLA genetic analysis categorizes HLA proteins into biologically relevant smaller sequence features (SFs), and their variant types (VTs). Sequence features are combinations of amino acid sites defined based on structural information (e.g., beta-sheet 1), functional information (e.g., peptide antigen-binding), and polymorphism. These sequence features can be overlapping and continuous or discontinuous in the linear sequence. Variant types for each sequence feature are defined based upon all known polymorphisms in the HLA locus being described. SFVT categorization of HLA is applied in genetic association analysis so that the effects and roles of the epitopes shared by several HLA alleles can be identified. Sequence features and their variant types have been described for all classical HLA proteins, and can be stored in a knowledge base, which can be updated as appropriate. A tool to convert HLA alleles into their component SFVTs can be found on the Immunology Database and Analysis Portal (ImmPort) website.

Gene Sequencing

Minor reactions to subregions that show similarity to other types can be observed to the gene products of alleles of a serotype group. The sequence of the antigens determines the antibody reactivities, and so having a good sequencing capability (or sequence-based typing) obviates the need for serological reactions. Therefore, different serotype reactions may indicate the need to sequence a person's HLA to determine a new gene sequence. Allelic diversity makes it necessary to use broad antigen typing followed by gene sequencing because there is an increased risk of misidentifying by serotyping techniques.

Phenotyping

Gene typing is different from gene sequencing and serotyping. With this strategy, PCR primers specific to a variant region of DNA are used (called SSP-PCR), if a product of the right size is found. The assumption is that the HLA allele has been identified. New gene sequences often result in an increasing appearance of ambiguity. Because gene typing is based on SSP-PCR, it is possible that new variants, in particular in the class I and DRB1 loci, may be missed.

For many populations, such as the Japanese or European populations, so many patients have been typed that new alleles are relatively rare, and thus SSP-PCR is more than adequate for allele resolution. Haplotypes can be obtained by typing family members in areas of the world where SSP-PCR is unable to recognize alleles and typing requires the sequencing of new alleles.

Haplotypes

An HLA haplotype is a series of HLA “genes” (loci-alleles) by chromosome, one passed from the mother and one from the father. Haplotypes can be used to trace migrations in the human population because they are often much like a fingerprint of an event that has occurred in evolution. The Super-B8 haplotype is enriched in the Western Irish, declines along gradients away from that region, and is found only in areas of the world where Western Europeans have migrated. The “A3-B7-DR2-DQ1” is more widely spread, from Eastern Asia to Iberia. The Super-B8 haplotype is associated with a number of diet-associated autoimmune diseases. There are 100,000s of extended haplotypes, but only a few show a visible and nodal character in the human population.

Role of Allelic Variation

Studies of humans and other animals imply a heterozygous selection mechanism operating on these loci as an explanation for this exceptional variability. One credible mechanism is sexual selection in which females are able to detect males with different HLA relative to their own type. While the DQ and DP encoding loci have fewer alleles, combinations of A1:B1 can produce a theoretical potential of 1586 DQ and 2552 DP αβ heterodimers, respectively. While nowhere near this number of isoforms exists in the human population, each individual can carry 4 variable DQ and DP isoforms, increasing the potential number of antigens that these receptors can present to the immune system in individual immune system. Studies of the variable positions of DP, DR, and DQ reveal that peptide antigen contact residues on class II molecules are most frequently the site of variation in the protein primary structure. Therefore, through a combination of intense allelic variation and/or subunit pairing, the class II ‘peptide’ receptors are capable of binding an almost endless variation of peptides of 9 amino acids or longer in length, protecting interbreeding subpopulations from nascent or epidemic diseases. Individuals in a population frequently have different haplotypes, and this results in many combinations, even in small groups. This diversity enhances the survival of such groups, and thwarts evolution of epitopes in pathogens, which would otherwise be able to be shielded from the immune system.

Antibodies

HLA antibodies are typically not naturally occurring, with few exceptions are formed as a result of an immunologic challenge of a foreign material containing non-self HLAs via blood transfusion, pregnancy (paternally-inherited antigens), or organ or tissue transplant.

Antibodies against disease-associated HLA haplotypes have been proposed as a treatment for severe autoimmune diseases.

Donor-specific HLA antibodies have been found to be associated with graft failure in kidney, heart, lung, and liver transplantation.

HLA Matching for Sick Siblings

In some diseases requiring hematopoietic stem cell transplantation, pre-implantation genetic diagnosis may be used to give rise to a sibling with matching HLA.

ITPA

Inosine triphosphatase (ITPA; EC 3.6.1.19) catalyzes the hydrolysis of ITP to inosine monophosphate, thereby recycling purines that might otherwise be trapped in the form of ITP. Two single-nucleotide polymorphisms associated with ITPA deficiency have been identified in the ITPA gene. Individuals who are homozygous for a 94C>A (P32T) mutation have a total deficiency of enzyme activity and accumulate ITP intracellularly, whereas 94C>A heterozygotes have decreased ITPA activity that is 22.5% of the control mean value. A second mutation, IVS2+21A>C, is detected in ITPA-deficient families. This intronic mutation has a more subtle effect on ITPA activity, and heterozygotes have activities that are, on average, 60% of the control mean. The IVS2+21A>C mutation is believed to alter the relatively conserved adenine of a putative splicing branch site, leading to abnormal mRNA splicing.

ITPA deficiency, of and by itself, is not related to any defined pathology in humans. However, polymorphisms in the ITPA gene associated with ITPA deficiency have pharmacogenomic implications for patients treated with thiopurines and other drugs. The 94C>A deficient allele is significantly related to the adverse drug reactions (ADRs) flu-like symptoms, rash, and pancreatitis, associated with administration of thiopurines.

The purine analog 6-mercaptopurine and its prodrug azathioprine (AZA) are widely used in the treatment of leukemia and autoimmune disease, and in transplantation. ADRs to these drugs have been related to a genetic deficiency of thiopurine S-methyltransferase (TPMT; EC 2.1.1.67), which is a key enzyme of thiopurine drug catabolism. TPMT deficiency leads to life-threatening myelosuppression by accumulation of active thiopurine metabolites. Most ADRs to thiopurines, however, cannot be explained by TPMT deficiency. Thiopurines are more frequently discontinued because of non-dose-dependent ADRs (fever, pancreatitis, nausea) than because of dose-dependent side effects (recurrent infections, thrombocytopenia, leukopenia).

Reliable methods are required for screening for the functional polymorphisms in the ITPA gene where patients are to be treated with thiopurines. The Sanger or UDS screening approaches can both be used. In one embodiment, a patient sample is screened for polymorphisms associated with a cancer, and with the patient's ITPA, so that information relevant to which drugs are effective against the cancer, and which can be tolerated by the patient, are obtained at the same time.

Primers for amplification of the region of interest in the ITPA gene were located in intron 1 (forward primer; 5′-CTT TAG GAG ATG GGC AGC AG-3′) and intron 2 (reverse primer; 5′-CAC AGA AAG TCA GGT CAC AGG-3′). The 3′ end of one probe can be labeled with fluorescein (FLU), and the 5′ end of an adjacent anchor probe can be labeled with either Cy5.5 (94C>A) or Bodipy630/650 (IVS2+21A>C). Anchor probes can be 3′-phosphorylated to prevent probe elongation by the Taq polymerase.

The ITPA 94C wild type (wt) can be covered by the 3′-FLU-labeled 94Cwt probe (5′-AGT TTC CAT GCA CTT TGG-3′) and the adjacent 5′-Cy5.5-labeled 94 anchor probe (5′-GGC ACA GAA AAT TGA CCG TAT GTC TC-3′). The IVS2+21C mutation site was detected by the 3′-FLU-labeled IVS2C mut probe (5′-ATG TCT CTG TTT TGT TTT CTT T-3′) and a 5′-Bodipy630/650-labeled anchor probe (5′-TAA AAG ATG GTT GGA TTT CTC TGT CTT CCT-3′).

Screening using NGS represents a fast and reliable method to determine the pharmacogenetic status of a patient with respect to thiopurine treatment. Pre-therapeutic ITPA genotyping has the potential to identify patients at increased risk for non-dose-dependent ADRs to thiopurines. Therefore, it is advantageous to use the methods described herein to both screen patients for TPMT activity, and additionally for ITPA polymorphisms, and to include information on the presence of mutations in the personalized patient report, specially when associated with other Sanger and/or UDS data from the Host and the Pathogens (such as HCV), and with current and/or past patient information.

Patient Pooling

In one embodiment, while screening for any of the disorders discussed above, biological samples from a plurality of patients are pooled, and subjected to “population screening” in the same wells of tagged samples using next generation sequencing runs using limited sensitivity, which can accommodate more samples per run than if a higher sensitivity were used. This embodiment allows for lower pricing per patient. Samples can be selected for further screening based on pre-determined criteria, and can be subjected to ultra-deep sequencing using relatively higher sensitivity than used in the population screening.

(e) Preparation of Personalized Patient Reports

The types of disorders for which personalized patient reports can be generated, after ultra-deep sequencing information is obtained, are described above. Obtaining this information is just one part of how to prepare a complete personalized patient report.

In addition to obtaining the ultra-deep sequencing (“UDS”) information, one can input information from the patient, which can be stored in a first knowledge base, and which can include the UDS information as well as additional patient information. Information on treatments for the particular disorder can be stored in a second knowledge base. Expert rules for interpreting the data, and identifying effective therapies for patients with various mutations identified in the UDS, can be stored in a third knowledge base. Advisory data can be stored in a fourth knowledge base.

The presence of a single variant, or of multiple variants, can be correlated to effective therapy to treat the one variant or multiple variants. Each variant, and its corresponding mutations, can be analyzed against the knowledge base of therapeutic agents and the knowledge base of expert rules for determining which of the therapies is effective against the particular mutations in the variants, and appropriate therapy to treat all of the variants can be determined.

The report may include a listing of the types of variants, as well as the therapies that will work against these variants, and, optionally, therapies that will not work against these variants. Optionally, the report can also include advisory information.

The type of patient information that may be obtained, and how the various knowledge bases are set up and managed, is described below. Also described below are the types of systems and software used to manage the data, as well as the types of reports that can be generated.

The present invention is described below with reference to flowchart illustrations of methods, apparatus (systems), and computer program products according to an embodiment of the invention. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

The methods described herein, as well as the system and software used to implement the methods, enable one to guide the decision, or to optimize the decisions, whether or not to perform sequencing (Sanger or UDS) on a given sample, based on the patient's information and interpretation by the system.

Patient Information

Patient information is ideally inputted into a system, which can then use the information to determine an appropriate treatment regimen. The information includes, at least, ultra-deep sequencing (“UDS”) information, or other such sequencing information which identifies major and minor variants of the types of pathogens, such as viruses (including HIV, HBV, and HCV) with which the patient is infected, and the specific mutations on each of these variants. Such information is useful, particularly in the treatment of HIV, HBV, and HCV infection, because there is a significant difference between two or more mutations on a single virus, or different mutations on different viruses. This is particularly relevant with antiviral therapies, where the presence of a single mutation can be associated with failure of a first treatment modality, but the presence of an additional mutation can be associated with the renewed effectiveness of this treatment modality. That is, drugs which are inactive against virus with a first mutation may be active against virus with a first and a second mutation. Without knowing whether a particular combination of mutations occurs on a single variant, or on multiple variants, it can be difficult to design appropriate therapy. Because the present invention provides information on which mutations are present in which variants, appropriate therapeutic modalities can be prescribed.

In one embodiment, after entering the patient's genetic information (i.e., types of variants, and mutations present on each variant), a user-defined therapeutic treatment regimen for the disease (or medical condition) can be entered. Advisory information for the user-defined combination therapeutic treatment regimen can then be generated. Where a rejected therapeutic treatment regimen for the disease (or medical condition) is entered, for example, a regimen that is included in the knowledge base of therapeutic regimens, but not recommended (i.e., given a very low ranking), advisory information can be generated, providing one or more reasons for not recommending (or providing a low ranking) for the particular therapeutic treatment regimen.

Additional examples of patient information that may be gathered include one or more of gender, age, weight, CD4⁺ cell information, viral load information, HIV genotype and phenotype information, hemoglobin information, neuropathy information, neutrophil information, pancreatitis, hepatic function, renal function, drug allergy and intolerance information, and information for drug treatments for other conditions. The information may include historical information on prior therapeutic treatment regimens for the disease or medical condition.

While the patient is typically examined on a first visit to determine the patient information, it will be appreciated that patient information may also be stored in the computing device, or transferred to the computing device from another computing device, storage device, or hard copy, when the information has been previously determined.

Expert Rules/Algorithms, Knowledge Base Management, and Computer Hardware/Software

The present invention is described below with reference to flowchart illustrations of methods, apparatus (systems), and computer program products according to an embodiment of the invention. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

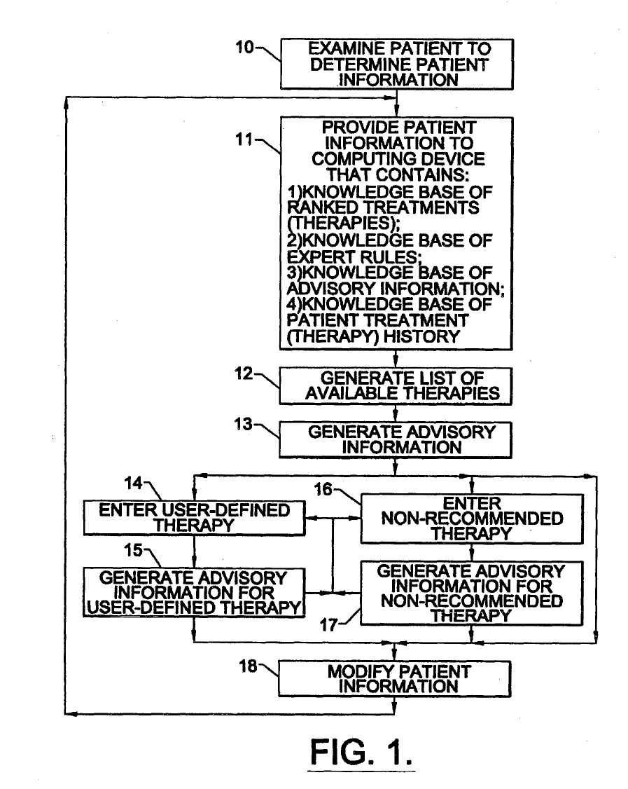

A method of the instant invention is illustrated in FIG. 1. In the first step 10, the patient is examined to determine patient information. Examples of patient information that may be gathered include one or more of gender, age, weight, CD4⁺ cell information, viral load information, HIV genotype and phenotype information, hemoglobin information, neuropathy information, neutrophil information, pancreatitis, hepatic function, renal function, drug allergy and intolerance information, and information for drug treatments for other conditions. The information may include historical information on prior therapeutic treatment regimens for the disease or medical condition. While the patient is typically examined on a first visit to determine the patient information, it will be appreciated that patient information may also be stored in the computing device, or transferred to the computing device from another computing device, storage device, or hard copy, when the information has been previously determined.

The patient information is then provided 11 to a computing device that contains a knowledge base of treatments, contains a knowledge base of expert rules for determining available treatment options for the patient in light of the patient information, and also contains a knowledge base of advisory information. A list of available treatments for the patient is then generated 12 from the patient information and the available treatments by the expert rules, and advisory information for the available treatments is generated 13. The advisory information may include warnings to take the patient off a contraindicated drug or select a suitable non contraindicated drug to treat the condition before initiating a corresponding treatment regimen and/or information clinically useful to implement a corresponding therapeutic treatment regimen.

Computer Program Instructions

The computer program instructions described herein can be stored in a computer-readable memory that can direct a computer or other programmable data processing apparatus to function in a particular manner, such that the instructions stored in the computer-readable memory produce an article of manufacture including instruction means which implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

A method of the instant invention is illustrated in FIG. 1. In the first step 10, the patient is examined to determine patient information. The patient information is then provided 11 to a computing device that contains a knowledge base of treatments, contains a knowledge base of expert rules for determining available treatment options for the patient in light of the patient information, and also contains a knowledge base of advisory information. A list of available treatments for the patient is then generated 12 from the patient information and the available treatments by the expert rules, and advisory information for the available treatments is generated 13. The advisory information may include warnings to take the patient off a contraindicated drug or select a suitable non contraindicated drug to treat the condition before initiating a corresponding treatment regimen and/or information clinically useful to implement a corresponding therapeutic treatment regimen.

For example, when the known disease is HIV-1 infection, the treatment regimen includes antiretroviral drugs, and the treatment regimen or advisory information may also include contraindicated or potentially adversely interacting non-antiretroviral drugs. Particularly, when the treatment regimen includes a protease inhibitor, a contraindicated drug may be terfenadine. When the treatment regimen includes indinavir, a contraindicated drug is cisapride.

Exemplary antiretroviral drugs are listed below in Table 1.

TABLE 1

| Abbreviation | Formal Name | Generic Name |
|---|---|---|
| ABC | ZIAGEN ® | Abacavir |
| ADV | PREVEON ® | Adefovir |
| APV | AGENERASE ® | Amprenavir |
| AZT | RETROVIR ® | Zidovudine |
| ddI | VIDEX ® | Didanosine |
| ddC | HIVID ® | Zalcitabine |
| d4T | ZERIT ® | Stavudine |
| EFV | SUSTIVA ® | Efavirenz |
| 3TC | EPIVIR ® | Lamivudine |
| SQV | INVIRASE ® | Saquinavir |
| | FORTOVASE ® | |
| IDV | CRIXIVAN ® | Indinavir |
| RTV | NORVIR ® | Ritonavir |
| DLV | RESCRIPTOR ® | Delavirdine |
| NFV | VIRACEPT ® | Nelfinavir |
| NVP | VIRAMUNE ® | Nevirapine |

| | | |
|---|---|---|
| Brand Name | Generic Name | Manufacturer Name |

Additional antiretroviral drugs used in the treatment of HIV
infection Multi-class Combination Products

| | | |
|---|---|---|
| Atripla¹ | efavirenz, emtricitabine | Bristol-Myers Squibb |
| | and tenofovir disoproxil | and Gilead Sciences |
| | fumarate | |
| Complera² | emtricitabine, rilpivirine, | Gilead Sciences |
| | and tenofovir disoproxil | |
| | fumarate | |

Nucleoside Reverse Transcriptase Inhibitors (NRTIs)

| | | |
|---|---|---|
| Combivir³ | lamivudine and zidovudine | GlaxoSmithKline |
| Emtriva⁴ | emtricitabine, FTC | Gilead Sciences |
| Epivir⁵ | lamivudine, 3TC | GlaxoSmithKline |
| Epzicom⁶ | abacavir and lamivudine | GlaxoSmithKline |
| Hivid⁷ | zalcitabine, dideoxycytidine, | Hoffmann-La Roche |
| | ddC (no longer marketed) | |
| Retrovir⁸ | zidovudine, azidothymidine, | GlaxoSmithKline |
| | AZT, ZDV | |
| Trizivir⁹ | abacavir, zidovudine, and | GlaxoSmithKline |
| | lamivudine | |
| Truvada¹⁰ | tenofovir disoproxil | Gilead Sciences, Inc. |
| | fumarate and emtricitabine | |
| Videx EC¹¹ | enteric coated didanosine, | Bristol Myers-Squibb |
| | ddI EC | |
| Videx¹² | didanosine, dideoxyinosine, | Bristol Myers-Squibb |
| | ddI | |
| Viread¹³ | tenofovir disoproxil | Gilead |
| | fumarate, TDF | |
| Zerit¹⁴ | stavudine, d4T | Bristol Myers-Squibb |
| Ziagen¹⁵ | abacavir sulfate, ABC | GlaxoSmithKline |

Nonnucleoside Reverse Transcriptase Inhibitors (NNRTIs)

| | | |
|---|---|---|
| Edurant¹⁶ | rilpivirine | Tibotec Therapeutics |
| Intelence¹⁷ | etravirine | Tibotec Therapeutics |
| Rescriptor¹⁸ | delavirdine, DLV | Pfizer |
| Sustiva¹⁹ | efavirenz, EFV | Bristol Myers-Squibb |
| Viramune²⁰ | nevirapine, NVP | Boehringer Ingelheim |
| (Immediate | | |
| Release | | |
| Viramune XR²¹ | nevirapine, NVP | Boehringer Ingelheim |
| (Extended | | |
| Release) | | |

Protease Inhibitors (PIs)

| | | |
|---|---|---|
| Agenerase²² | amprenavir, APV | GlaxoSmithKline |
| Aptivus²³ | tipranavir, TPV | Boehringer Ingelheim |
| Crixivan²⁴ | indinavir, IDV, | Merck |
| Fortovase²⁵ | saquinavir (no longer | Hoffmann-La Roche |
| | marketed) | |
| Invirase²⁶ | saquinavir mesylate, SQV | Hoffmann-La Roche |
| Kaletra²⁷ | lopinavir and ritonavir, | Abbott Laboratories |
| | LPV/RTV | |
| Lexiva²⁸ | Fosamprenavir Calcium, | GlaxoSmithKline |
| | FOS-APV | |
| Norvir²⁹ | ritonavir, RTV | Abbott Laboratories |
| Prezista³⁰ | darunavir | Tibotec, Inc. |
| Reyataz³¹ | atazanavir sulfate, ATV | Bristol-Myers Squibb |
| Viracept³² | nelfinavir mesylate, NFV | Agouron |
| | | Pharmaceuticals |

Fusion Inhibitors

| | | |
|---|---|---|
| Fuzeon³³ | enfuvirtide, T-20 | Hoffmann-La Roche & |
| | | Trimeris |

Entry Inhibitors - CCR5 co-receptor antagonist

| | | |
|---|---|---|
| Selzentry³⁴ | maraviroc | Pfizer |

HIV integrase strand transfer inhibitors

| | | |
|---|---|---|
| Isentress³⁵ | raltegravir | Merck & Co., Inc. |

NRTIs

NRTIs (nucleoside/nucleotide reverse transcriptase inhibitors) were the first medicines to be approved for the treatment of HIV. NRTIs stop HIV from replicating within cells by inhibiting the reverse transcriptase protein. Eight of these drugs are currently available. Typically an antiretroviral treatment combination consists of two NRTIs and one drug from another class. Representative NRTIs include KP-1461, Racivir and Elvucitabine.

NNRTIs

NNRTIs (non-nucleoside reverse transcriptase inhibitors) are an older class of antiretroviral drug—the first was approved in 1996. NNRTIs stop HIV replicating within cells by interfering with HIV's reverse transcriptase protein which it needs to make new copies of itself. Until recently just three members of this group were available: efavirenz and nevirapine (both widely used in first-line treatment) and delavirdine (only rarely used).

Representative NNRTIs include Apricitabine, Elvucitabine and Racivir, Festinavir (previously OBP-601), Etravirine (sold as Intelence), Rilpivirine (also known as Edurant), Lersivirine (which is effective against HIV with a certain mutation (position Y181), KP-1461, a combination of tenofovir, emtricitabine and rilpivirine (marketed as Complera), and Apricitabine, as well as and Atripla (which combines tenofovir, emtricitabine and efavirenz), and Complera (a combination of Rilpivirine+FTC+TDF).

Fusion or Entry Inhibitors

In order to enter a human cell, HIV must first attach itself to proteins on the cell's surface. The virus always begins by latching on to a protein called CD4. The next stage involves proteins called co-receptors, of which there are two main types: CCR5 and CXCR4. Some strains of HIV use CCR5, others use CXCR4, and some can use either.

CCR5 antagonists are a type of entry inhibitor that bind to the CCR5 co-receptor so that HIV cannot exploit it to gain entry to a cell. The main drawback of these drugs is that they don't work against all strains of HIV.

Representative entry inhibitors include Maraviroc, Vicriviroc, PRO 140, TNX-355 (ibalizumab), BMS-663068, and Cenicriviroc (a CCR5 antagonist).

Integrase Inhibitors

Integrase is an enzyme produced by HIV. This chemical performs a crucial role in an early stage of HIV's replication process, which takes place inside human cells. Integrase inhibitors block the action of this enzyme, thus preventing the virus from making new copies of itself. These drugs are effective against HIV that has become resistant to other antiretroviral classes. Representative integrase inhibitors include Isentress (raltegravir), Dolutegravir, Elvitegravir, alone or in combination with ritonavir to boost their effectiveness.

Maturation Inhibitors

Maturation inhibitors are a potential new drug class which seeks to halt the development of immature HIV particles after they have emerged from human cells. Representative maturation inhibitors include Bevirimat and Vivecon (MP-9055).

Exemplary advisory information that can be displayed to a user is summarized below in Table 2.

TABLE 2

| | Description |
|---|---|
| Drug | The inference engine will process every therapy from a |
| Therapies | resource file which contains all valid therapy |
| (All the | combinations. The system will support multiple drug |
| output data | combinations. Those therapies which are recommended by |
| types below | the knowledge base will be displayed along with all the |
| are | data types below. |
| associated | |
| with a | |
| therapy) | |
| Commen- | Commentaries consist of warnings and advisories |
| taries | concerning drugs as well as various patient conditions. |
| | Each commentary will appear in specific locations of the |
| | User Interface. Commentaries will have various Flags, |
| | Triggers, and Output Locations. |
| Rejection | Rejection Notices are the explanation why a given therapy |
| Notices | is not recommended. Rejection notices always appear in |
| | predefined places in the User Interface. |
| Cost | The cost per day is calculated for each therapy by the |
| | inference engine as well as each drug cost within a |
| | therapy. |
| Dosage | The base dosage and any adjustments to the base dosage |
| | due to various patient conditions are calculated by the |
| | inference engine. |
| Pill | The number of pills in the therapy. |
| Burden | |
| Frequency | Number of times the patient will be taking medications for |
| | a given therapy. For a multi-drug therapy, the Frequency of |
| | the therapy is the drug in the therapy that has the highest |
| | number of Frequencies. If a three-drug regimen has 2 drugs |
| | with q12h dosages and one that is a q8h, the therapy is |
| | considered to be a q8h Frequency. |
| Admin | Special drug administration instructions. |
| Efficacy | The relative Efficacy is a whole number that represents the |
| | relative efficacy of the various therapies. One is the most |
| | effective therapy. |
| Adjusted | The “Adjusted Score” is the Efficacy adjusted up or down |
| Score | based on patient specific characteristics to roughly |
| | indicate the likelihood of that therapy being an effective |
| | treatment for that patient. An example would be: the |
| | system evaluates a therapy containing a drug that is known |
| | to be associated with a medical condition in that patient's |
| | medical history, therefore the therapy is ranked low. The |
| | Ranking Ordinal is an integer, beginning with 0 and |
| | having no upper limit. A therapy with a 1 Ranking Ordinal |
| | (RO = 1) would be ranked at the top of the list whereas a |
| | therapy with a 10 Ranking Ordinal (RO = 10) would be less |
| | likely to be successful given the patient's specific history |
| | and characteristics. Each therapy will have a starting RO |
| | number which will be the therapy's relative efficacy score. |
| | The relative efficacy score can then be adjusted up or |
| | down by the rules. Both base “Efficacy” number and the |
| | “Adjusted Score” number can be displayed. |

The inference engine will process every therapy from a Therapies resource file which contains all valid therapies. Commentaries consist of warnings and advisories concerning drugs as well as various patient conditions. Each commentary will appear in specific locations of the User Interface. Commentaries can have various Flags, Triggers, and Output Locations.

Rejection Notices are the explanation why a given therapy is not recommended. Rejection notices can appear in predefined places in the User Interface.

The cost per day can be calculated for each therapy by the inference engine as well as each drug cost within a therapy. The base dosage and any adjustments to the base dosage due to various patient conditions can also be calculated by the inference engine. The number of pills in the therapy can be listed, as well as the number of times the patient will be taking medications for a given therapy.

Efficacy

The relative Efficacy is a whole number that represents the relative efficacy of the various therapies. One is the most effective therapy.

The “Adjusted Score”

The adjusted up or down score can be based on patient specific characteristics to roughly indicate the likelihood of that therapy being an effective treatment for that patient. An example would be: the system evaluates a therapy containing a drug that is known to be associated with a medical condition in that patient's medical history, therefore the therapy is ranked low. The Ranking Ordinal is an integer, beginning with 0 and having no upper limit. A therapy with a 1 Ranking Ordinal (RO=1) would be ranked at the top of the list whereas a therapy with a 10 Ranking Ordinal (RO=10) would be less likely to be successful given the patient's specific history and characteristics. Each therapy will have a starting RO number which will be the therapy's relative efficacy score. The relative efficacy score can then be adjusted up or down by the rules. Both base “Efficacy” number and the “Adjusted Score” number can be displayed.

Diseases (or medical conditions), the treatment of which may be facilitated or improved by the present invention, are those for which multiple different therapy options are available for selection and treatment. Such diseases and medical conditions include, but are not limited to, cardiovascular disease (including but not limited to congestive heart failure, hypertension, hyperlipidemia and angina), pulmonary disease (including but not limited to chronic obstructive pulmonary disease, asthma, pneumonia, cystic fibrosis, and tuberculosis), neurologic disease (including but not limited to Alzheimer's disease, Parkinson's disease, epilepsy, multiple sclerosis, amyotrophic lateral sclerosis or ALS, psychoses such as schizophrenia and organic brain syndrome, neuroses, including anxiety, depression and bipolar disorder), hepatitis infections (including hepatitis B and hepatitis C infection), urinary tract infections, venereal disease, cancer (including but not limited to breast, lung, prostate, and colon cancer), etc. It should be appreciated that prevention of development or onset of the above-mentioned diseases and medical conditions may be facilitated or improved by the present invention.

The present invention is useful for known diseases such as HIV-1 infection (acquired immune deficiency syndrome or “AIDS”), or where the known disease is any medical condition for which a combination therapeutic treatment regimen can be used. The invention is particularly useful when the list of available treatments includes a plurality (e.g., 2, 10 or 15 or more) of treatment, combination therapeutic treatment regimens (e.g., therapeutic treatment regimens incorporating two or more active therapeutic agents), where the potential for drug interactions is increased and/or the complexity involved in selecting the best available treatment is multifactorial.

Advantageously, the list of available treatments and advisory information may be regenerated in a number of ways. The patient information may be simply modified 18. In addition, if a particular therapy in which the user might be interested is not presented, a user-defined therapy may be entered 14 and advisory information generated 15 based on the user-defined therapy. Still further, if a therapeutic treatment regimen that is in the knowledge base is rejected by the system (not recommended upon display), the non-recommended therapeutic treatment regimen may be entered 16 and advisory information generated 17 for the non-recommended therapeutic treatment regimen. This may indicate to the user that they should discontinue use of a non-critical drug for another condition or select a suitable substitute that does not create a conflict/non-recommended situation so that they can then proceed with the therapy of choice. Alternatively, the advisory information can be generated automatically for non-recommended therapeutic treatment regimens. These various steps can be repeated in any sequence in an interactive manner to provide the user with assurance that all treatment options have been given adequate and appropriate consideration.

The terms “therapy” and “therapeutic treatment regimen” are interchangeable herein and, as used herein, mean any pharmaceutical or drug therapy, regardless of the route of delivery (e.g., oral, intraveneous, intramuscular, subcutaneous, intraarterial, intraperitoneal, intrathecal, etc.), for any disease (including both chronic and acute medical conditions, disorders, and the like). In addition, it is understood that the present invention is not limited to facilitating or improving the treatment of diseases. The present invention may be utilized to facilitate or improve the treatment of patients having various medical conditions, without limitation.

System Description

The present invention may be embodied as an expert system that provides decision support to physicians (or other health care providers) treating patients with a known disease, such as HIV infection. A system according to the present invention calculates combination antiretroviral therapy options and attaches all relevant information to those options.

As known to those of skill in the art, an expert system, also known as artificial intelligence (AI), is a computer program that can simulate the judgment and behavior of a human or an organization that has expert knowledge and experience in a particular field. An expert system typically contains a knowledge base containing accumulated experience and a set of rules for applying the knowledge base to each particular situation that is described to the program. Expert systems are well known to those of skill in the art and need not be described further herein.

The antiretroviral therapy options (combinations of antiretroviral drugs), are derived using a knowledge base consisting of a number of expert system rules and functions which in turn take into account a given patient's treatment history, current condition and laboratory values. A system according to the present invention supports the entry, storage, and analysis of patient data in a large central database. A system according to the present invention has a flexible data driven architecture and custom reporting capabilities designed to support patient therapy management and clinical drug trial activities such as screening, patient tracking and support. It is anticipated that a system according to the present invention may be used by health care providers (including physicians), clinical research scientists, and possibly healthcare organizations seeking to find the most cost-effective treatment options for patients while providing the highest standard of care.

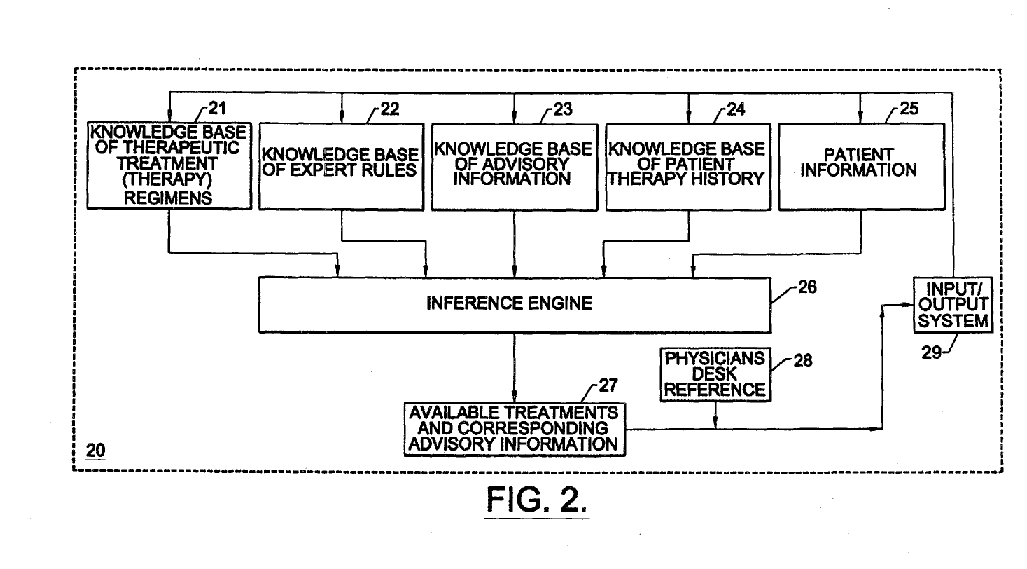

A system 20 for carrying out the present invention is schematically illustrated in FIG. 2. The system 20 comprises a knowledge base of treatment regimens 21, which may be ranked for efficacy (e.g., by a panel of experts) or ranked according to system rules, a knowledge base of expert rules 22, a knowledge base of advisory information 23, a knowledge base of patient therapy history 24 and patient information 25. Patient information is preferably stored within a database and is configured to be updated. The knowledge bases and patient information 21-25 may be updated by an input/output system 29, which can comprise a keyboard (and/or mouse) and video monitor. Note also that, while the knowledge bases and patient data 21-25 are shown as separate blocks, the knowledge bases and patient data 21-25 can be combined together (e.g., the expert rules and the advisory information can be combined in a single database).

To carry out the method described above, the information from blocks 21-25 is provided to an inference engine 26, which generates the listing of available treatments and the corresponding advisory information from the information provided by blocks 21-25. The inference engine 26 may be implemented as hardware, software, or combinations thereof. Inference engines are known and any of a variety thereof may be used to carry out the present invention. Examples include, but are not limited to, those described in U.S. Pat. No. 5,263,127 to Barabash et al. (Method for fast rule execution of expert systems); U.S. Pat. No. 5,720,009 to Kirk et al. (Method of rule execution in an expert system using equivalence classes to group database objects); U.S. Pat. No. 5,642,471 to Paillet (Production rule filter mechanism and inference engine for expert system); U.S. Pat. No. 5,664,062 to Kim (High performance max-min circuit for a fuzzy inference engine).

High-speed inference engines are preferred so that the results of data entered are continually updated as new data is entered. As with the knowledge bases and patient information in blocks 21-25, the inference engine 26 may be a separate block from the knowledge bases and patient information blocks 21-25, or may be combined together in a common program or routine.

Note that the advisory information that is generated for any available therapy may differ from instance to instance based on differences in the patient information provided.

System Architecture

The present invention can be implemented as a system running on a stand alone computing device. Preferably, the present invention is implemented as a system in a client-server environment. As is known to those of skill in the art, a client application is the requesting program in a client-server relationship. A server application is a program that awaits and fulfills requests from client programs in the same or other computers. Client-server environments may include public networks, such as the Internet, and private networks often referred to as “intranets”, local area networks (LANs) and wide area networks (WANs), virtual private networks (VPNs), frame relay or direct telephone connections. It is understood that a client application or server application, including computers hosting client and server applications, or other apparatus configured to execute program code embodied within computer usable media, operates as means for performing the various functions and carries out the methods of the various operations of the present invention.

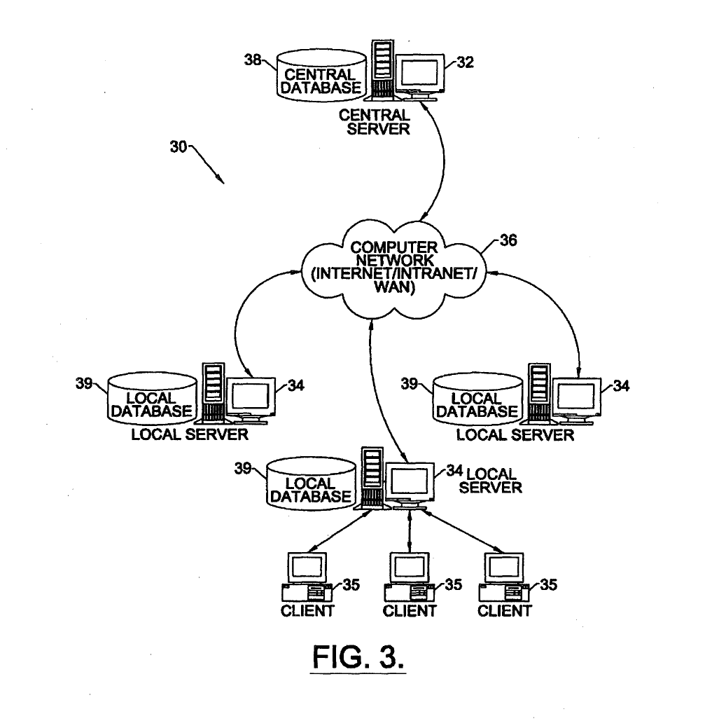

Referring now to FIG. 3, a client-server environment 30 according to a preferred embodiment of the present invention is illustrated. The illustrated client-server environment 30 includes a central server 32 that is accessible by at least one local server 34 via a computer network 36, such as the Internet. A variety of computer network transport protocols including, but not limited to TCP/IP, can be utilized for communicating between the central server 32 and the local servers 34.

Central Server

The central server 32 includes a central database 38, such as the Microsoft® SQL Server application program, version 6.5 (available from Microsoft, Inc., Redmond, Wash.), executing thereon. The central server 32 ensures that the local servers 34 are running the most recent version of a knowledge base. The central server 32 also stores all patient data and performs various administrative functions including adding and deleting local servers and users to the system (20, FIG. 2). The central server 32 also provides authorization before a local server 34 can be utilized by a user. Patient data is preferably stored on the central server 32, thereby providing a central repository of patient data. However, it is understood that patient data can be stored on a local server 34 or on local storage media.

Local Server

Each local server 34 typically serves multiple users in a geographical location. Each local server 34 includes a server application, an inference engine, one or more knowledge bases, and a local database 39. Each local server 34 performs artificial intelligence processing for carrying out operations of the present invention. When a user logs on to a local server 34 via a client 35, the user is preferably authenticated via an identification and password, as would be understood by those skilled in the art. Once authenticated, a user is permitted access to the system (20, FIG. 2) and certain administrative privileges are assigned to the user.

Each local server 34 also communicates with the central server 32 to verify that the most up-to-date version of the knowledge base(s) and application are running on the requesting local server 34. If not, the requesting local server 34 downloads from the central server 32 the latest validated knowledge base(s) and/or application before a user session is established. Once a user has logged onto the system (20, FIG. 2) and has established a user session, all data and artificial intelligence processing is preferably performed on a local server 34. An advantage of the illustrated client-server configuration is that most of the computationally intensive work occurs on a local server 34, thereby allowing “thin” clients 35 (i.e., computing devices having minimal hardware) and optimizing system speed.

In a preferred embodiment, each local server database 39 is implemented via a Microsoft® SQL Server application program, Version 6.5. The primary purpose of each local database 39 is to store various patient identifiers and to ensure secure and authorized access to the system (20, FIG. 2) by a user. It is to be understood, however, that both central and local databases 38, 39 may be hosted on the central server 32.

Local Client

Each local client 35 also includes a client application program that consists of a graphical user interface (GUI) and a middle layer program that communicates with a local server 34. Program code for the client application program may execute entirely on a local client 35, or it may execute partly on a local client 35 and partly on a local server 34. As will be described below, a user interacts with the system (20, FIG. 2) by entering (or accessing) patient data within a GUI displayed within the client 35. The client 35 then communicates with a local server 34 for analysis of the displayed patient information.

Computer program code for carrying out operations of the present invention is preferably written in an object oriented programming language such as JAVA®, Smalltalk, or C++. However, the computer program code for carrying out operations of the present invention may also be written in conventional procedural programming languages, such as the “C” programming language, in an interpreted scripting language, such as Perl, or in a functional (or fourth generation) programming language such as Lisp, SML, or Forth.

The middle layer program of the client application includes an inference engine within a local server 34 that provides continuous on-line direction to users, and can instantly warn a user when a patient is assigned drugs or a medical condition that is contraindicated with, or antagonistic of, the patient's current antiretroviral therapy. Every time patient data is entered into the system (20, FIG. 2) or updated, or even as time passes, the inference engine evaluates the current status of the patient data, sorting, categorizing, ranking and customizing every possible antiretroviral therapy for a patient according to the specific needs of the patient.

Inference Engine

Inference engines are well known by those of skill in the art and need not be described further herein. Each knowledge base used by an inference engine according to the present invention is a collection of rules and methods authored by a clinical advisory panel of HIV-treating physicians and scientists. A knowledge base may have subjective rules, objective rules, and system-generated rules. Objective rules are based on industry established facts regarding the treatment of HIV using antiretroviral therapy and are drawn from the package insert information of antiretroviral drug manufacturers and from peer reviewed and published journal articles. An example of an objective rule would be an antiretroviral to antiretroviral contraindication such as:
Rule #1: If the eval therapy contains Zidovudine (AZT) and Stavudine (d4T), then reject the therapy.

In Rule #1, the term “eval therapy” refers to the therapy currently being analyzed by the system (20, FIG. 2). Rule #1 then states that if this therapy contains both AZT and d4T, then this therapy should not be displayed in a list of potential therapy options for the patient.

For objective rules, the present invention can be configured so as to prevent a user from receiving recommendations on new therapy options when certain crucial data on the patient has not been entered. However, it is understood that the present invention does not prevent a health care provider, such as a physician, from recording his/her therapy decisions, even if the system (20, FIG. 2) has shown reasons why that therapy may be harmful to the patient. The present invention allows a health care provider to be the final authority regarding patient therapy.

Subjective rules are based on expert opinions, observations and experience. Subjective rules are typically developed from “best practices” information based on consensus opinion of experts in the field. Such expert opinion may be based on knowledge of the literature published or presented in the field or their own experience from clinical practice, research or clinical trials of approved and unapproved medications. A number of experts are used so that personal bias is reduced.

System generated rules are those derived from the outcomes of patients tracked in the system who received known and defined therapies and either improved, stabilized or worsened during a defined period. Because of the large number of potential combinations usable in HIV infection, this system generated database and rules derived from them are likely to encompass data beyond that achievable from objective or subjective rules databases.

The rules which comprise the various knowledge bases (21-24, FIG. 2) of the present invention each have two main parts: a premise and a conclusion—also referred to as the left side and the right side, respectively. When a premise of a rule is found to be true, the action specified in the conclusion is taken. This is known to those of skill in the art as “firing” the rule. For example, consider the following rule:

| Rule ID | Premise | Conclusion |
|---|---|---|
| FiltDComA1 - - | If the eval therapy contains ddC - | Commentary 18 |

The premise of the above rule is for the inference engine to determine whether or not a therapy being evaluated (i.e., “eval therapy”) contains the antiretroviral drug “ddC”. If a therapy does contain the antiretroviral drug ddC, the action called for by the conclusion of the rule is to attach “Commentary 18” to the therapy. Commentary 18 may be a piece of text that provides a user with the necessary information about therapies containing ddC. Exemplary rules which may comprise one or more knowledge bases according to the present invention are listed below in Table 3.

TABLE 3
Therapy initiation/change: Rules that provide information on
therapy change or initiation
Boundary condition rules: Limits for values, intervals for values to
be updated
Comment Data Aging rules: These rules warn the user that the data
in certain fields is getting old and that the most current values in the
system will be used.
Rules that filter therapies due to drug interactions in ARV drug
combinations
Rules that filter therapies due to medical conditions
Rules that filter therapies due to genotypic mutations in patient's
plasma HIV
Rules that filter therapies due to phenotypic sensitivity/resistance
Antiretroviral therapy ranking rules
General dosage rules
Solid dosage rule
Dosage modifications due to ARV-ARV drug combination
Dosage modification due to ARV-NonARV interaction
Dosage modification due to medical condition
Comment determined
General commentary rules
Commentaries added due to medical conditions
Commentaries added due to drug interactions
Commentaries added due to drug combination
Delivery size rules

Using the various knowledge bases and patient information of the present invention (21-25, FIG. 2), the inference engine (26, FIG. 2) can evaluate potential therapy options for a patient based on a patient's medical history (including therapy history) and current laboratory values. FIG. 3 shows a client-server environment within which the system of FIG. 2 can operate. A central server (32) with a central database (38) is connected via a computer network (36), such as an internet, intranet, or wide area network (WAN), which is connected to local servers (34), which include local databases (39), which can be accessed by clients (35). Multiple antiretroviral drug combinations can be quickly and accurately analyzed for a particular patient. Furthermore, the inference engine can quickly provide guidance in the areas listed below in Table 4.

TABLE 4

| | |
|---|---|
| Data | Is the patient lab and assessment data getting |
| Integrity | too old to be considered reliable? Are there |
| | conflicts between lab data such as phenotype |
| | data which indicates resistance to one or more |
| | antiretroviral drugs in the patient's current |
| | therapy and current viral load data which |
| | indicates significant viral suppression? |
| Therapy | Should antiretroviral therapy be initiated for |
| Performance | the patient? Is the patient's current therapy |
| | achieving good initial and long-term viral |
| | suppression or should the therapy be changed? |
| | Are there potential non-compliance issues as |
| | demonstrated by a lack of viral suppression |
| | with a regimen when current genotype or |
| | phenotype data does provide explanation for |
| | the failure by demonstrating resistance to any |
| | drugs in the patient current therapy? |
| Dosage | What are the base and adjusted dosages of |
| | antiretroviral drugs in a given therapy? Are |
| | there any special specific dosage |
| | administration instructions? What are options |
| | if patient can only take liquid dosage forms? |
| Contra- | Which antiretroviral drugs can be used with |
| indications | each other and what dosage adjustments are |
| | required? Are there any contraindications or |
| | interactions between antiretroviral drugs in |
| | patient's current therapy or potential therapies |
| | and the non-antiretroviral drugs patient is |
| | taking and if so what are they and what, if any, |
| | dosage adjustments are required? |
| Medical | Are there any medical conditions to be aware |
| Conditions | of in deciding an appropriate therapy for |
| | patient? What, if any, effect do current or |
| | historical medical conditions have on each |
| | therapy option? |
| Drug Cost | How much does each therapy option cost? |
| and | What is the dosing frequency of the drugs in |
| Delivery | the therapy? What is the pill count and |
| Data | optimum delivery size for the least number of |
| | pills? |
| Therapy | What are all the drug combination therapy |
| Options | options for patient? How can physician |
| | instantly assess which of the hundreds of |
| | potential combinations will be the most |
| | effective for patient? What information from |
| | the package inserts from each drug apply |
| | specifically to patient? What is the relative |
| | antiviral efficacy of each therapy? Are there |
| | special considerations that might make one |
| | therapy more or effective for patient? |
| Resistance | What drugs are patient's virus current |
| | genotypic or phenotypic profile known to be |
| | associated with resistance to? Which |
| | antiretroviral drugs are more effective against |
| | resistant strains when used together? Which |
| | drugs (if any) used in historical therapies are |
| | most likely to be effective if recycled into a |
| | new therapy? Can any of the drugs in patient's |
| | current therapy be recycled into the next |
| | therapy? |

User Interface

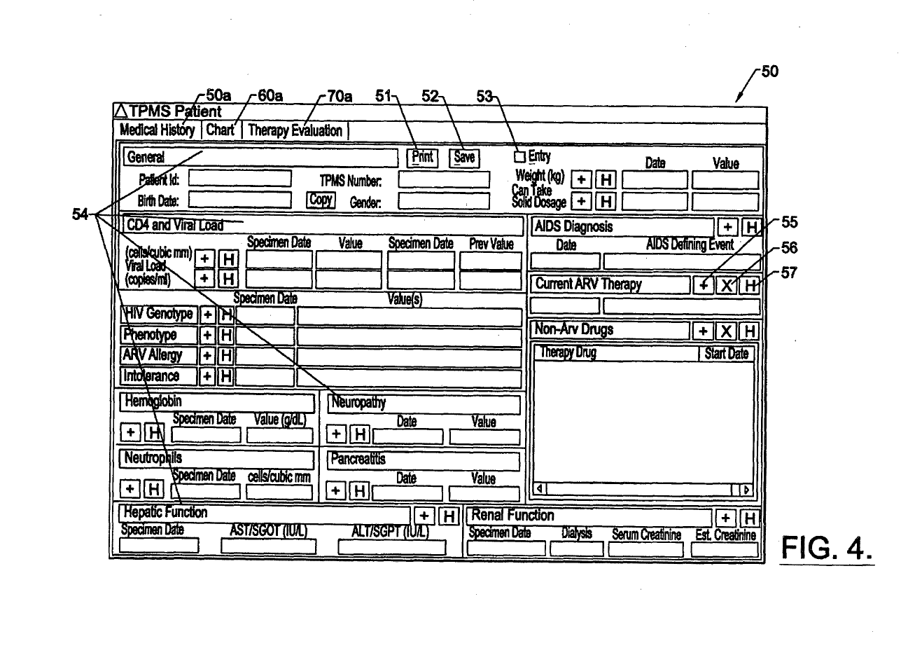

Referring now to FIGS. 4-5, 6A, 6B, and 7-9, exemplary user interfaces according to the present invention will be illustrated. In FIG. 4, a medical history user interface 50 for entering data about a patient's medical history according to the present invention is illustrated. The medical history user interface 50 can be displayed by activating the “Medical History” tab 50a. The illustrated medical history user interface 50 allows a user to create, save, update and print patient records. When a user adds a new patient, the medical history user interface 50 appears with empty data entry fields. Data entry fields for receiving information via a GUI are well known to those of skill in the art and need not be described further herein. When a user opens a patient record for editing, the medical history user interface 50 appears with patient data in the various fields. Preferably color is used to highlight critical or required information in a patient record.

Important elements in the illustrated medical history user interface 50 include a “print” button 51 for printing a patient record and therapeutic treatment regimen details; a “save” button 52 for saving a patient record; and a “speed entry” check box 53 for allowing a user to move quickly between entry fields. In addition, there are multiple group headings 54 that divide a patient's medical history into related categories. Each group contains entry fields in which a user can add patient information. An “add” button 55 allows a user to add new information to a patient record for a selected group. A “delete” button 56 allows a user to delete patient information for a selected group (although the original information is still recorded in the database). A “history” button 57 allows a user to review a patient's historical data for each selected group.

After completing a patient's medical history, an inference engine analyzes the data and suggests whether a therapeutic treatment regimen is indicated; if an existing therapeutic treatment regimen should be continued or changed; and the best drug therapies for the selected patient. Often, more than one drug therapy is presented to the user. These drug therapies are preferably ranked according to expected efficacy, frequency in dosage, pill count, and cost. All of these factors can help the user make a decision about what therapy to use for the selected patient. When a user clicks on a drug therapy in the presented list, information is provided about the dosage regimens. Also, various warnings, such as drug interaction warnings, and notes about each drug, are presented. An appropriate drug therapy can then be selected.

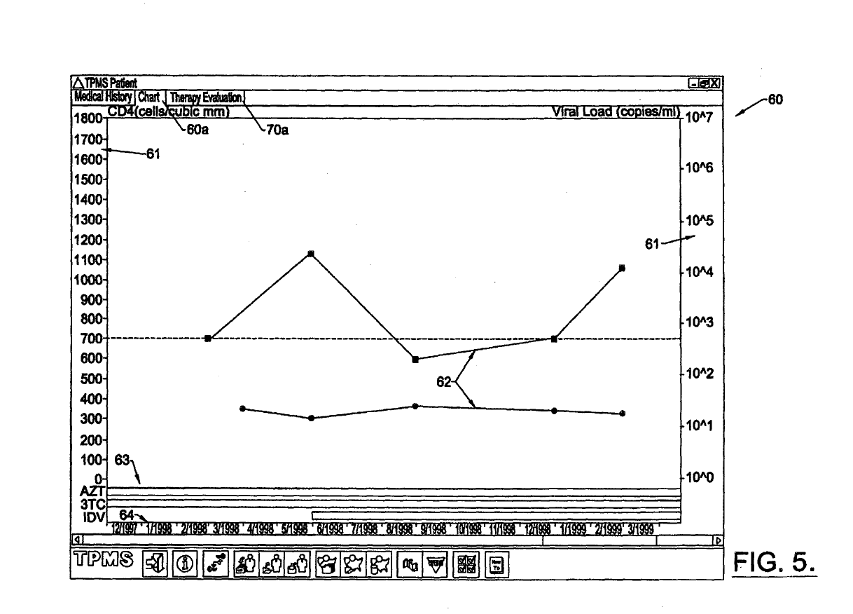

In FIG. 5, an exemplary user interface chart 60 for monitoring a patient's condition during a particular drug therapy over a period of time is illustrated. The user interface chart 60 can be displayed by activating the “Chart” tab 60a. The illustrated user interface chart 60 tracks the CD4 level against viral load. Along the left-hand side of the Y-axis 61 the CD4 count is plotted. Along the right-hand side of the Y-axis 61 the viral load count is plotted. The lines 62 represent the CD4 test and the viral load test as would be understood by those having skill in the art. Drug therapy for a time period is indicated within the area of the chart user interface 60 indicated as 63. Time is plotted along the X-axis 64, as illustrated.

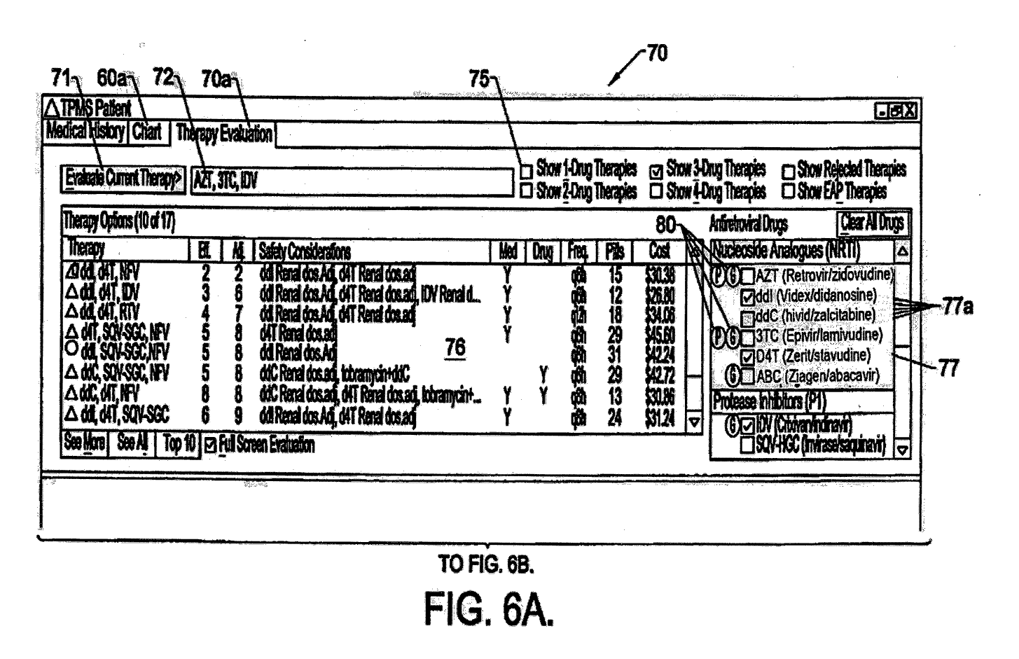

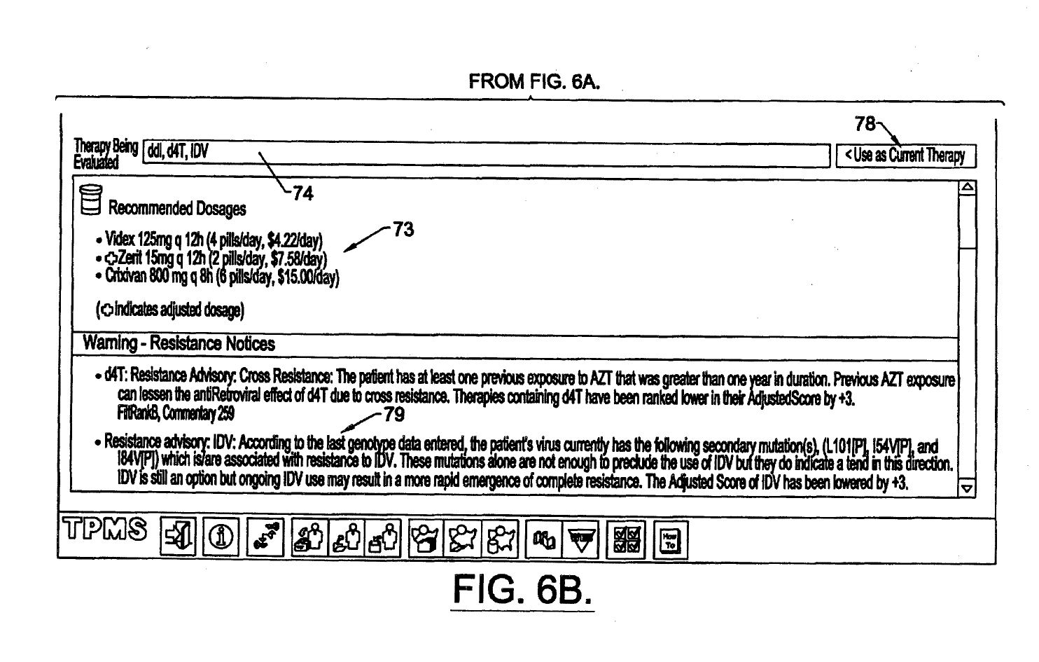

In FIGS. 6A and 6B, a therapy evaluation user interface 70 that facilitates evaluation of various therapy options with respect to relative efficacy, dosage, frequency, cost, medical complications and drug interactions is illustrated. The therapy evaluation user interface 70 can be displayed by activating the “Therapy Evaluation” tab 70a. Important elements in the illustrated therapy evaluation user interface 70 include an “Evaluate Current Therapy” button 71 for initiating an evaluation of a current therapy and a “Current Therapy” field 72 that lists a patient's current therapy. Detailed information about a patient's therapy is displayed in the therapy details box 73. A therapy displayed within box 73 is identified in box 74.

Multiple check boxes 75 are provided that allow a user to control how information is displayed within the therapy evaluation user interface 70. Within the therapy list box 76, a list of available therapies for a patient can be displayed. In the illustrated embodiment the drugs are listed in standard abbreviated form. Other information displayed with each drug may include that listed below in Table 5.

TABLE 5

| | |
|---|---|
| Efficacy | Lists the therapy according to expected |
| Rating | effectiveness only, regardless of patient |
| | specific considerations (1 is most effective). |
| Adjusted | This number uses the Efficacy Rating as a base |
| Score | and then the system adjusts it up or down based |
| | on patient specific conditions (1 is most |
| | effective). |
| Safety | A brief two or three word summary of the alerts |
| Considera- | associated with the therapy. |
| tions | |
| Frequency | Lists the dosage frequency (q12h, q24h, etc.). |
| Pills | Lists the total number of pills required per day |
| | for the complete regimen. |
| Cost | Lists the total cost of the regimen per day. |
| Medical | Displays a Y if there is one or more Yellow |
| Alert | Medical Alerts and an R if there is one or more |
| | Red Medical Alerts associated with the therapy. |
| Drug | Displays a Y if there is one or more Yellow Drug |
| Interaction | Interaction Alerts and an R if there is one or |
| | more Red Drug Interaction Alerts associated with |
| | the therapy. |

A list of available antiretroviral drugs is displayed within box 77. A user desiring to evaluate a particular combination of drugs can click the appropriate check boxes 77a to review information in the therapy details box 73. A “Use as Current Therapy” button 78 allows a user to apply a particular therapy to a patient. Various hyperlinks 79 within the therapy details box 73 allow a user to display specific information about a therapy evaluation. For example, a user can be allowed to view a rule which is associated with the displayed text.

Resistance evaluation alerts 80 can be provided adjacent each available antiretroviral drug displayed within box 77. For example, a blue “G” icon can be used to indicate that a patient's last genotype test contains mutations which are known to be associated with full or partial resistance to the antiretroviral drug. A red “P” icon can be used to indicate that a patient's last phenotype test demonstrates resistance to the antiretroviral drug.

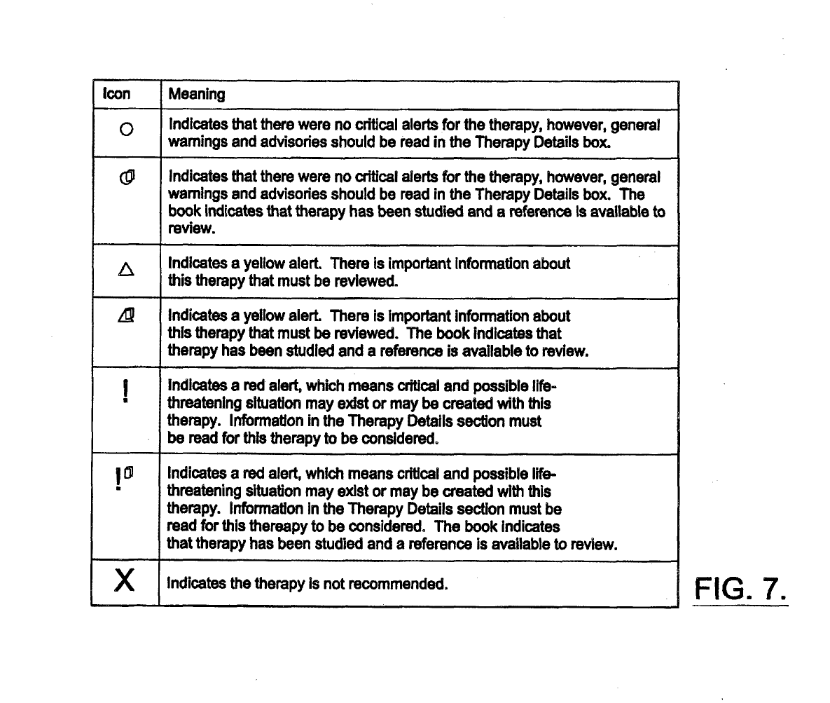

Within the therapy list box 76, various symbols (described in FIG. 7) can be utilized to provide information about a drug therapy option. These symbols provide an instant graphical warning level for each therapy option. Some symbols, such as a red exclamation point, indicate that there is critical, possibly life threatening information in the therapy details box 73 for that therapy which must be read in order for that therapy to be properly utilized.

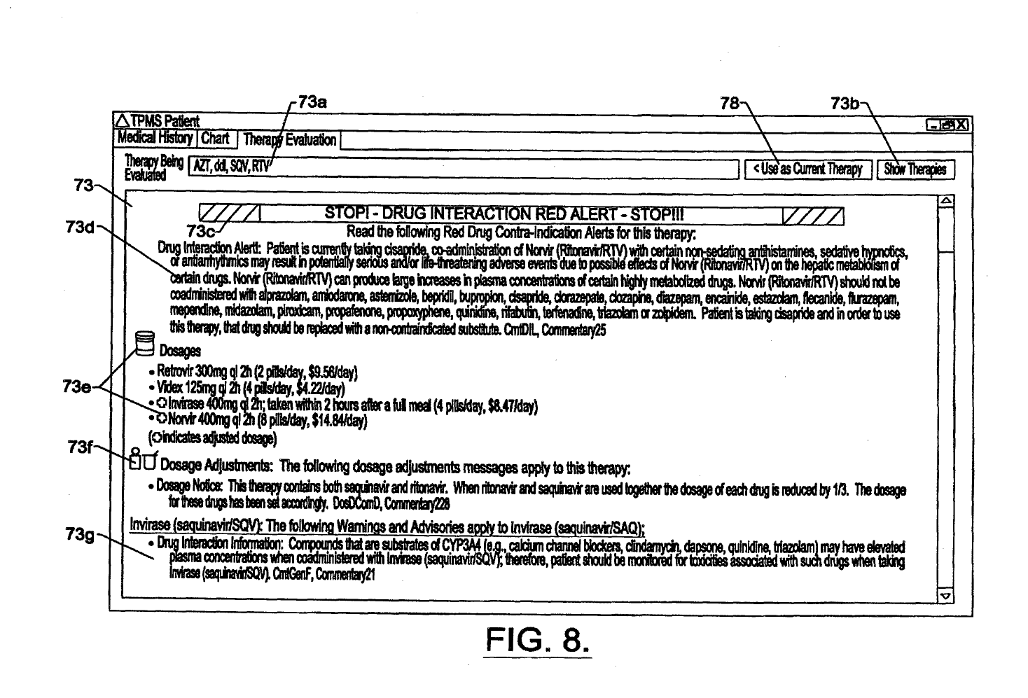

When a drug therapy from the therapy list box 76 is selected by a user for evaluation, the therapy details box 73 of FIGS. 6A and 6B can be displayed in “full screen” mode as illustrated in FIG. 8. Important elements in the illustrated therapy details box 73 include an identification box 73a for identifying the therapy being evaluated; a “Use as Current Therapy” button 78 that allows a user to apply a particular therapy to a patient; and a “Show Therapies” button 73b that returns the therapy details box 73 back to half-screen size as illustrated in FIGS. 6A and 6B. In addition, various hyperlinks may be embedded within text displayed within the therapy details box 73 that can be activated by a user to display various types of information. Eye catching alert banner(s) 73c and text 73d can be displayed at the top of the therapy details box 73 as illustrated. Dosages 73e of each drug, along with special administration instructions, can be displayed within the therapy details box 73 as illustrated. Dosage adjustment information 73f and various warnings and advisories 73g can also be displayed within the therapy details box 73 as illustrated.

According to a preferred embodiment of the present invention, therapeutic treatment regimens are not displayed to a user if an invalid drug is selected for treatment of a patient.

Physicians Desk Reference®

According to a preferred embodiment of the present invention, the Physicians Desk Reference®. (PDR®) 28, which is a known drug reference source, is fully integrated with the system 20 of FIG. 2. Users can access the PDR® drug abstracts for antiretroviral drugs listed in the therapy list box 76 of the therapy evaluation user interface 70 of FIGS. 6A and 6B. In addition, users can access the PDR® on-line Web database to obtain additional information about a specific drug or to research a substitute for a contraindicated drug. When a user selects a drug within the therapy list box 76 of the therapy evaluation user interface 70, a web browser preferably is launched and the PDR® on-line Web database is accessed. Information can also be extracted from the PDR® on-line Web database to provide drug selection lists for non-antiretroviral drugs that a patient may be taking and to define relationships between brand name and generic drugs.

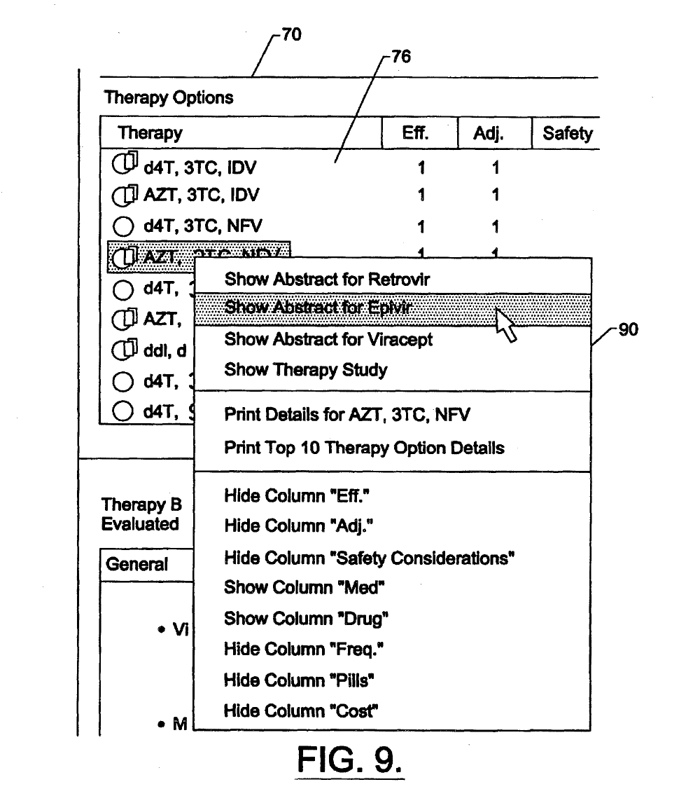

As illustrated in FIG. 9, a PDR® pop-up menu 90 may be provided that can be activated from within the therapy list box 76 of the therapy evaluation user interface 70 of FIGS. 6A and 6B. From the PDR® pop-up menu 90 a user can access various information from the PDR® including, but not limited to, drug abstracts, and generic components contained within a brand name drug.

It is important to validate the information that is obtained, to ensure that it is accurate. The following sections discuss validation of the information obtained during the screening of patient samples.

Coverage Validation

When conducting a next generation sequencing screen, such as a DeepChek screen, a global coverage check can be performed on each uploaded file to ensure the number of available reads is sufficient to produce meaningful information. The number of available reads per protein (file) can be determined, and correlated with a predetermined fixed cutoff point, which in one embodiment is defined by one or more of the experts making up the expert rules. In one aspect of this embodiment, the cutoff point is set to a minimum of 500 sequences, and the results are displayed at a minimum of 1%. However, this number can easily be changed, if desired. A representative table showing the threshold (%) and the minimal number of required sequences is shown below, but this table is not intended to be limiting.

| Threshold | Minimal number of |
|---|---|
| (%) | required sequences |
| 1 | 500 |
| 2 | 250 |
| 3 | 166 |
| 4 | 125 |
| 5 | 100 |
| 6 | 83 |
| 7 | 71 |
| 8 | 62 |
| 9 | 55 |
| 10 | 50 |
| 11 | 45 |
| 12 | 42 |
| 13 | 38 |
| 14 | 36 |
| 15 | 33 |
| 16 | 31 |
| 17 | 29 |
| 18 | 28 |
| 19 | 26 |
| 20 | 25 |

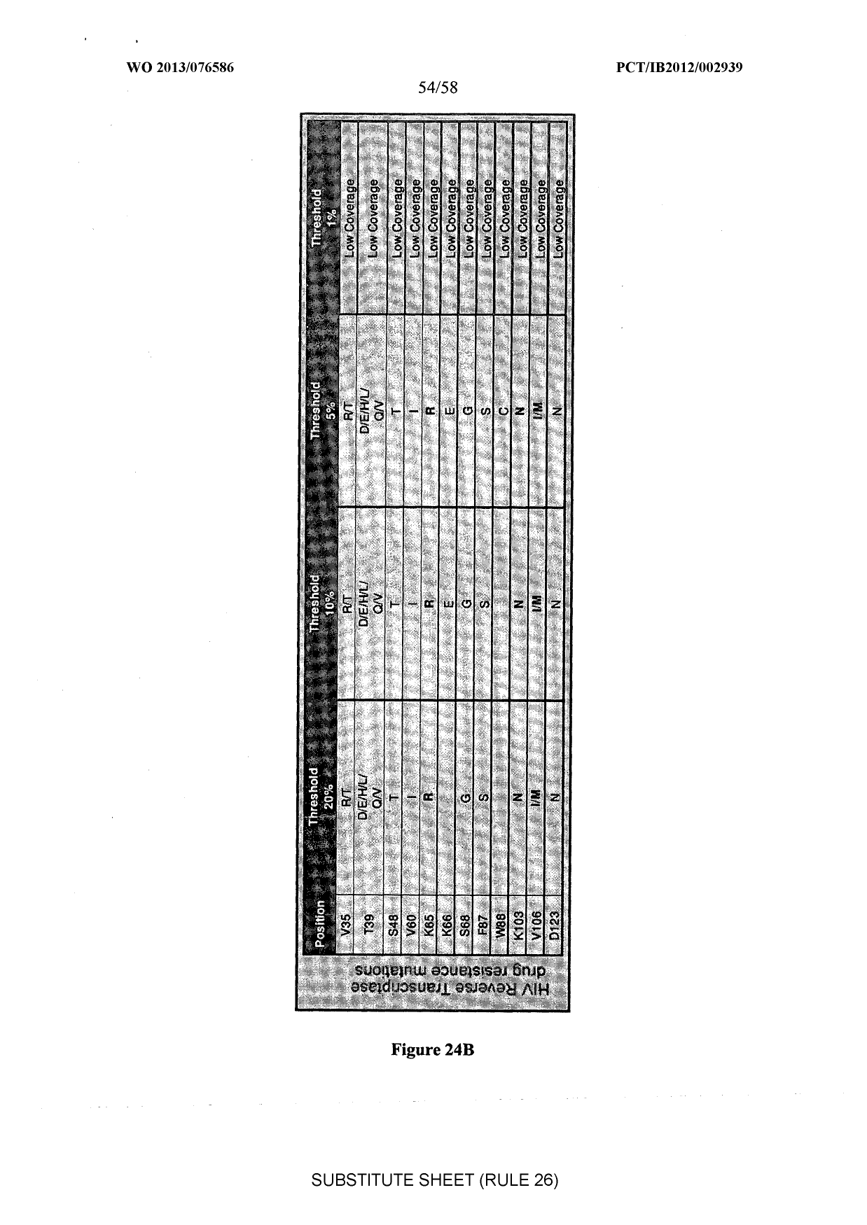

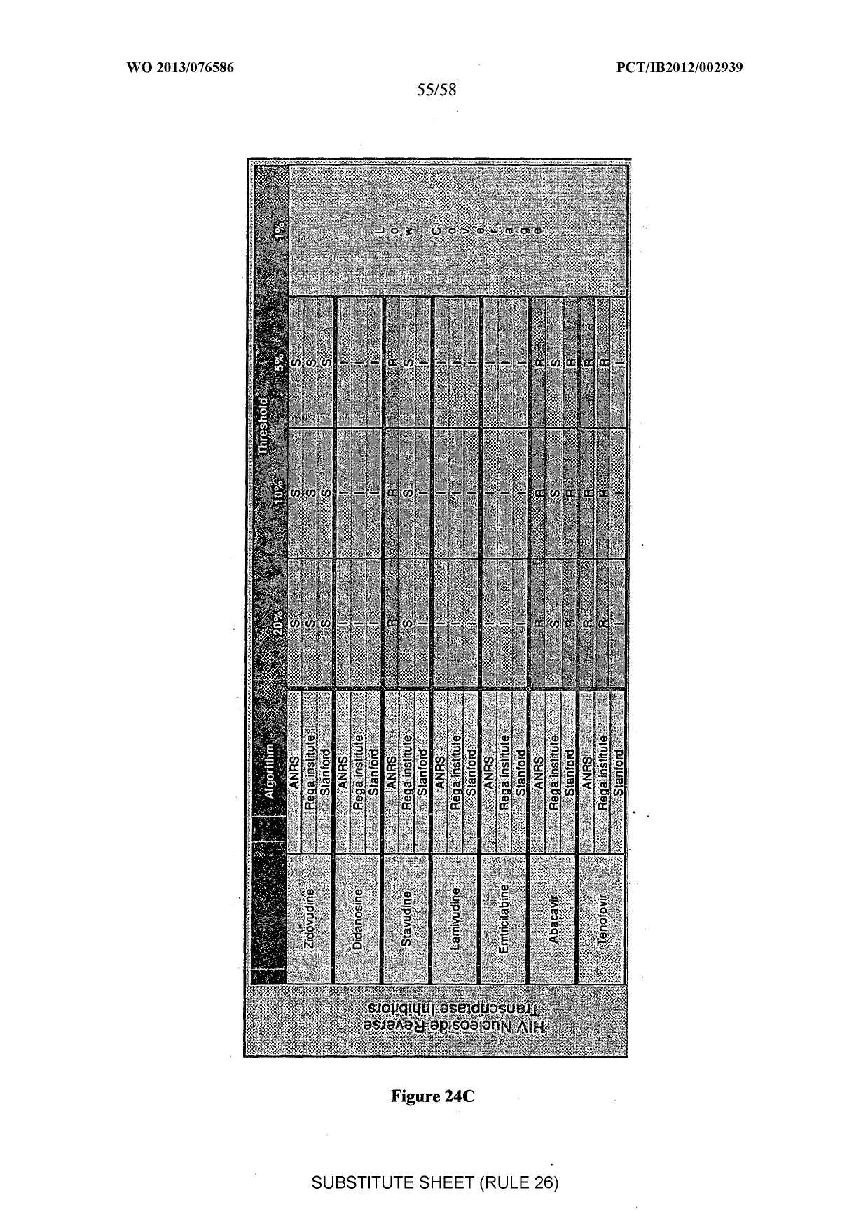

When a low-coverage is detected, an alert can warn the user, and if the selected threshold is confirmed, “Low coverage” information can be displayed on the DeepChek report, and no results may be displayed for the corresponding protein about mutations & interpretations. An example of such information is shown in FIGS. 24 A-C.

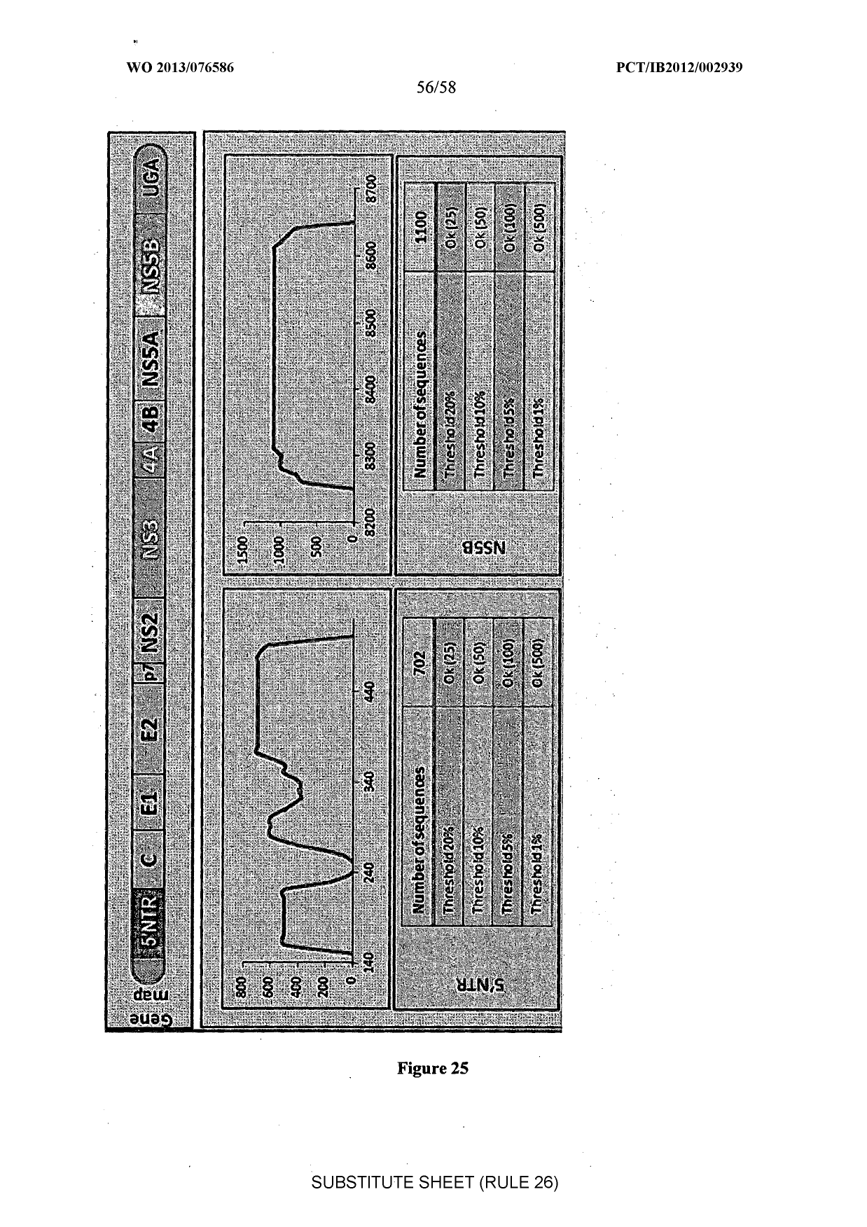

A more detailed/accurate coverage check & validation can be introduced, wherein the coverage can be given, position by position, for every protein, such as in a graphical display, and “low coverage” information can be displayed as soon as one position of interest (based on the selected classification of mutations of interest) is not sufficiently covered. A full correlation of coverage by position can then be performed, with one or more embedded knowledge databases. A graphical representation of such information in report form is provided in FIG. 25.

Data Entry Quality Assessment

A systematic control can be performed on the files introduced in DeepChek. In one embodiment, the system can check:

The Alignment format (FASTA; ACE; BAM; SAM . . . )

If the entered format corresponds to the expected selection (reads or consensus alignment)

If the global structure of the files is correct (no truncated sequences, correct headers . . . )

If an inconsistency is found, an alert message can be displayed, and the file can be prevented from being uploaded or otherwise handled.

Forward/Reverse Reads Reliability Assessment

In one embodiment, the DeepChek system can control and display the number of forward and/or reverse reads on the patient report.

Sequences Quality Control

The overall quality of the generated consensus sequences at each threshold can be checked based on a list of predetermined and defined parameters, including, for example, the number of ambiguous nucleotides, sequences length, and the like.

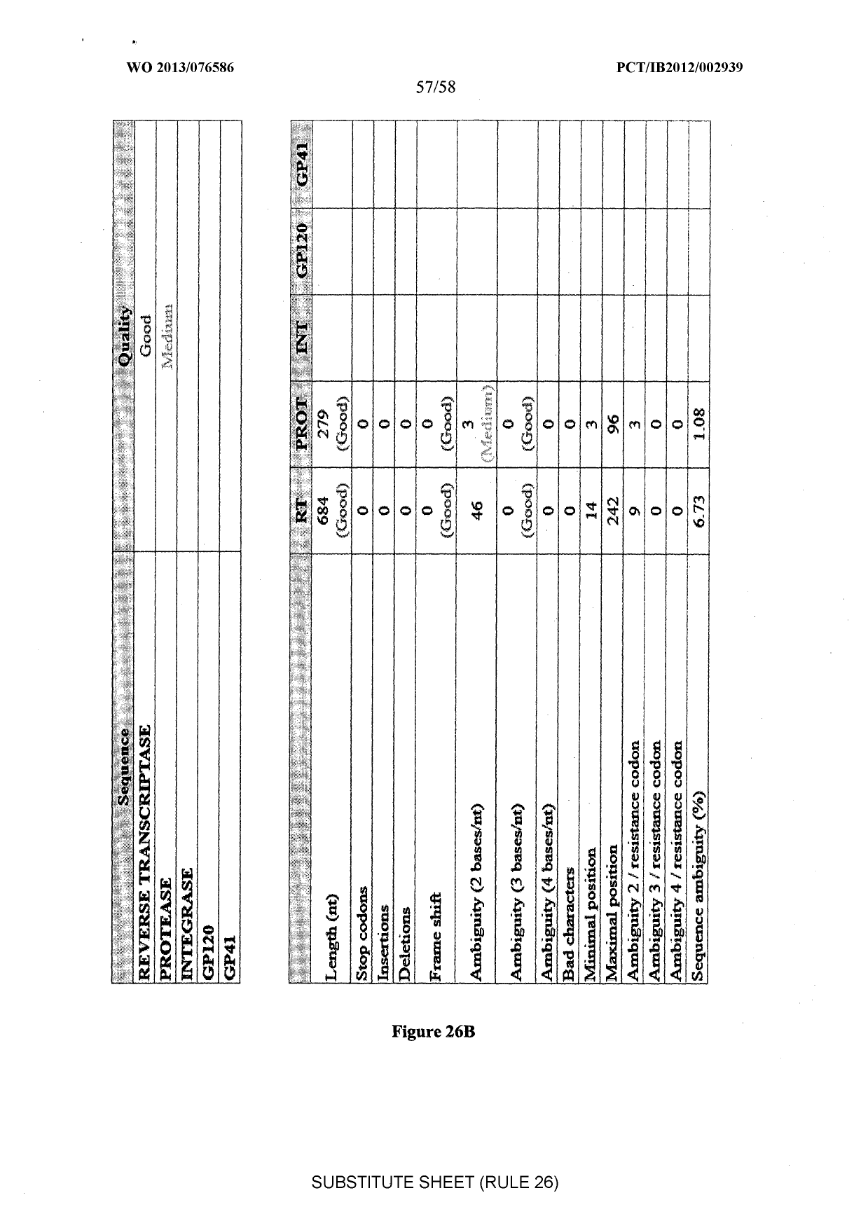

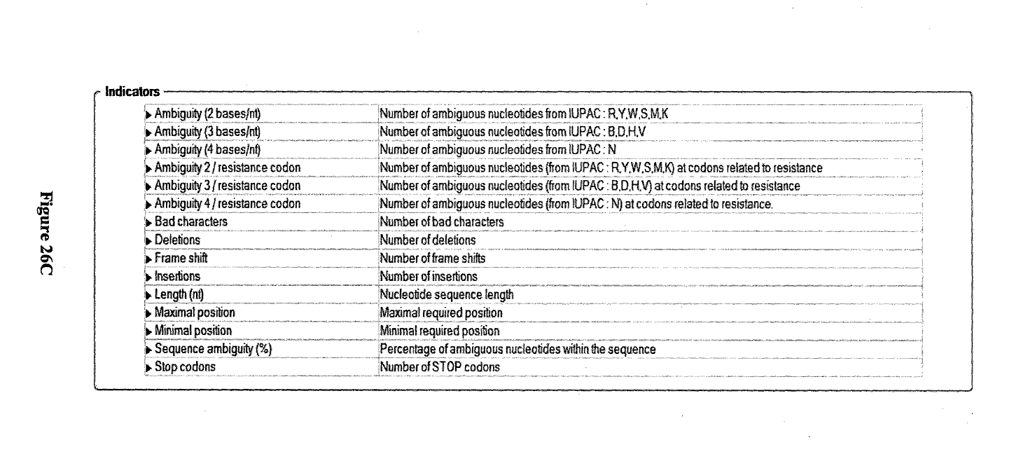

In one aspect of this embodiment, for each type of protein (for example, where a patient is screened for the presence of mutations in HIV, the proteins include reverse transcriptase, protease, integrase, GP120, and GP41), the list of parameters to be used can be fully customizable through a dedicated interface. Further, a series of at least two default profiles/patterns of criteria can be included and used by the DeepChek screen. A graphical representation of how this information can be provided in a patient report is shown in FIGS. 26 A-C.

Sequence quality assessment can be performed at the reads level. Specific visualization, editing, filtering interfaces can be applied, to work on the reads. One or more types of filters can be used, for example, a homopolymer check at positions of interest.

Mutations Patterns Coherence

In one embodiment, one or more types of mutation patterns coherence can be determined, such as the coherence of observed mutations between reverse reads & forward reads. Inter-threshold mutation checks can be performed during a population-based analysis. The expert system can check to see if mutations found at a specific level are also present at higher levels. If it is not the case, specific warnings will be displayed and mutations/interpretations information won't be given. For example, a mutation found at 5% also has to be found at 10%.

Contamination Check

In one embodiment, an embedded contamination check is used. In this embodiment, all, or at least a majority, of the individual variants/reads can be controlled by homology testing (local alignment) against a local sequences database to identify potential sequencing contaminations.

Use of the Methods to Monitor a Patient's Progress

By following a patient's progress over time, one can also obtain information about the efficacy of previous treatment regimens imposed on patients, including one or more of the viral load, the development of mutations, the development of side effects, and the like.

Use of the Methods in Research

In addition to being used for routine genotyping, the process can also be used for research, for example, to identify types of mutations in a pathogen and/or in the host following the administration of particular anti-viral or anti-cancer agents. The system can be interfaced with a dedicated Data Exploratory Framework that can be used for research, either on UDS-related molecular data only, or in correlation with clinical data.

The following non-limiting examples illustrate various aspects of the present invention. These examples are provided for illustrative purposes only, and are not intended to be limiting of the invention.

### Example 1

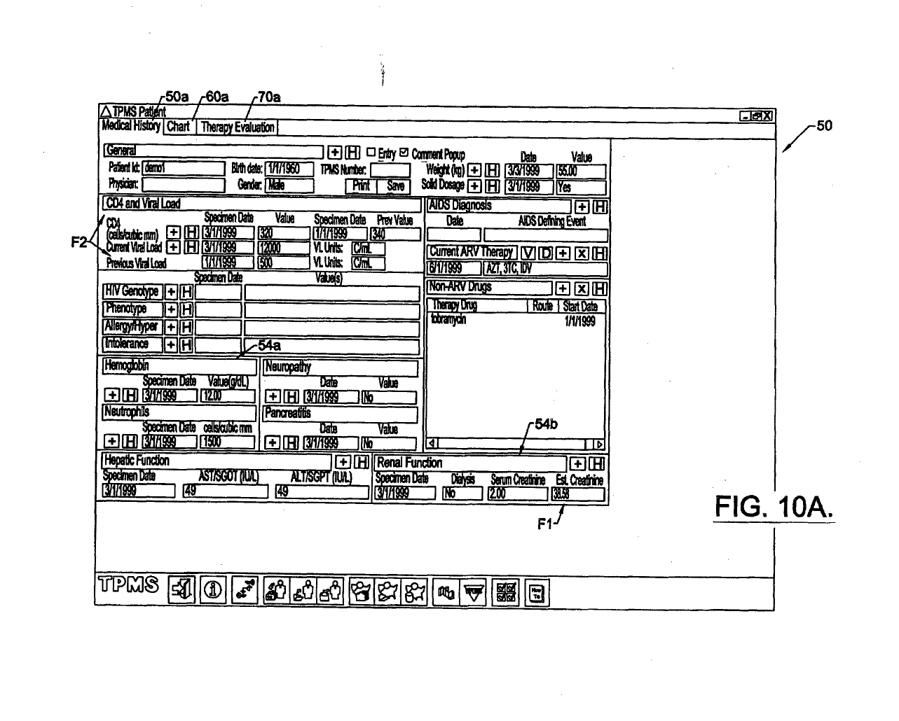

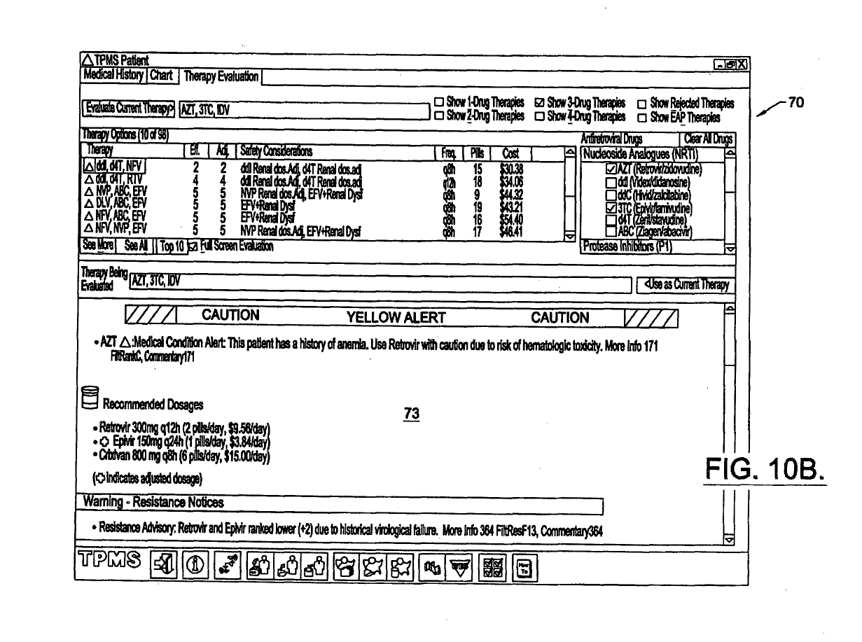

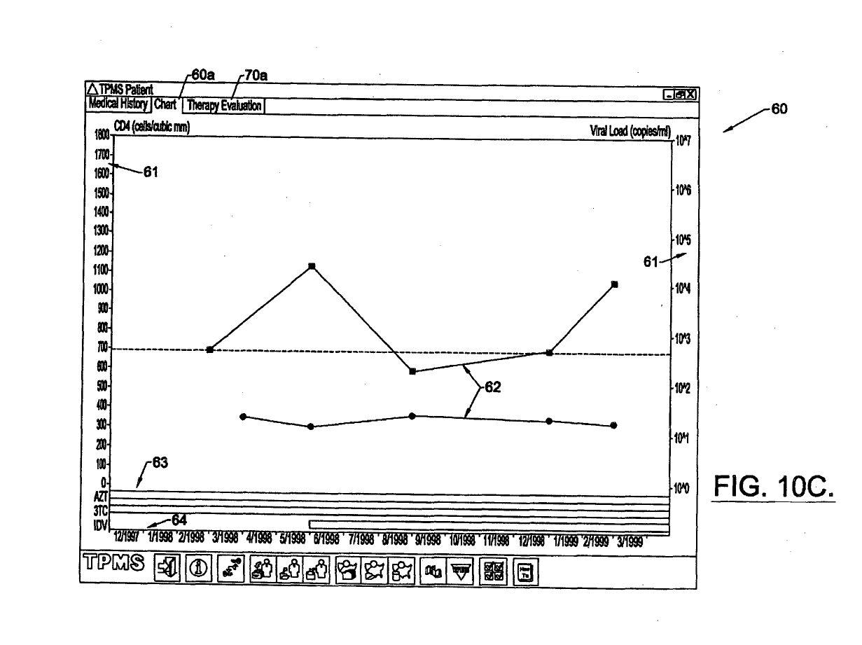

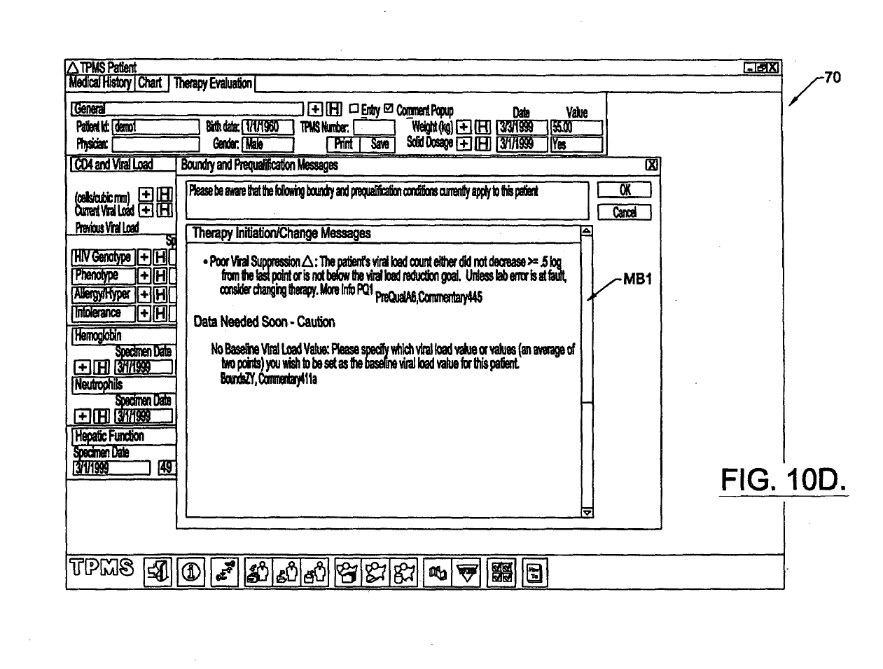

Example 1 will be explained with reference to FIGS. 10A-10D. Referring to FIG. 10A, a medical history user interface 50 containing evaluated data, including ultra-deep sequencing and/or Sanger data, for patient “demol” is illustrated. The group heading “Hemoglobin” 54a has changed colors to indicate to a user that the patient has an abnormally low hemoglobin value from a previous (historical) blood sampling. When the therapy evaluation tab 70a is activated to display the therapy evaluation user interface 70 (FIG. 10B) the associated medical condition warning of a history of anemia and the caution notification if using drugs known to be associated with hematopoetic toxicity is triggered as illustrated in the therapy details box 73 of FIG. 10B.

In addition, the group heading “Renal Function” 54b in FIG. 10a has changed colors to warn a user of potential renal dysfunction and is also indicated by the low estimated creatinine clearance rate in field F1 (which the system calculates using a mathematical formula taking patient age, sex, weight, and serum creatinine values—all of which are fields of the “Medical History” user interface 50). This information is pointed out to the user and is used if dosage adjustments are required for drugs that are known to be affected (cleared) by renal function.

Current and the next most recent CD4⁺ cell count and viral load are displayed (F2, medical history user interface 50). This information is also used to determine when to start or change therapy and to evaluate the initial antiviral efficacy of a newly administered antiviral regimen.

Current and historical values for all fields in the medical history user interface 50 (FIG. 10A) can be viewed by pressing the “H” button beside fields that have this button.

In FIG. 10C, the “Chart” user interface 60 has been activated. HIV RNA (viral load) is plotted on a log scale, the CD4 count is plotted on a linear scale, and the drug treatments are shown as Gantt bars on the horizontal date scale at the bottom of the chart user interface 60.

In FIG. 10D, the “Change Therapy Recommendation” message box MB1 pops up when the “Therapy Evaluation” tab 70a is selected. This box represents the processing of the data from the “Medical History” tab and the knowledge base output, including objective rules derived from published treatment guidelines, indicating that initiation of therapy, or a change of therapy in this case, may be called for if the other variable(s) indicated in the message have been addressed.

The list of available therapies and associated ranking order may be shown within the therapy details box 73 of FIG. 10B. This represents the output of the knowledge base for therapy selection. Included with the list of therapies can be any of the following: safety advisories (dosage adjustment, drug interaction, etc.) with a yellow triangle or red exclamation warning symbols; number of pills; daily cost of all three drugs; dosing regimen (q 8 h, q 12 h, etc.); and dosages for all drugs in a regimen (including dosage adjustments if necessary) and pertinent information specific to the patient is listed in the dialog box.

### Example 2

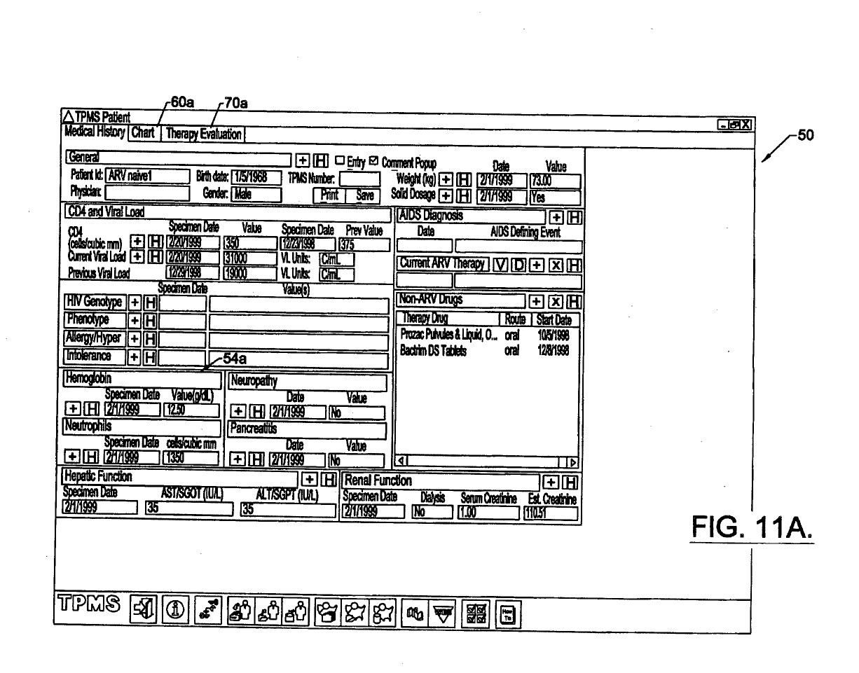

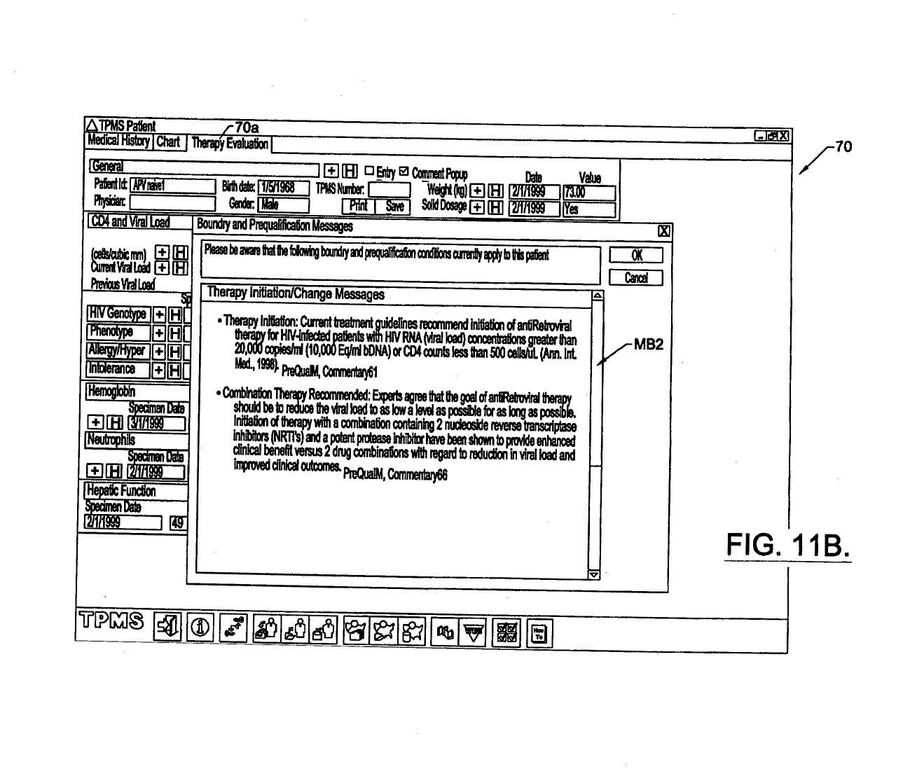

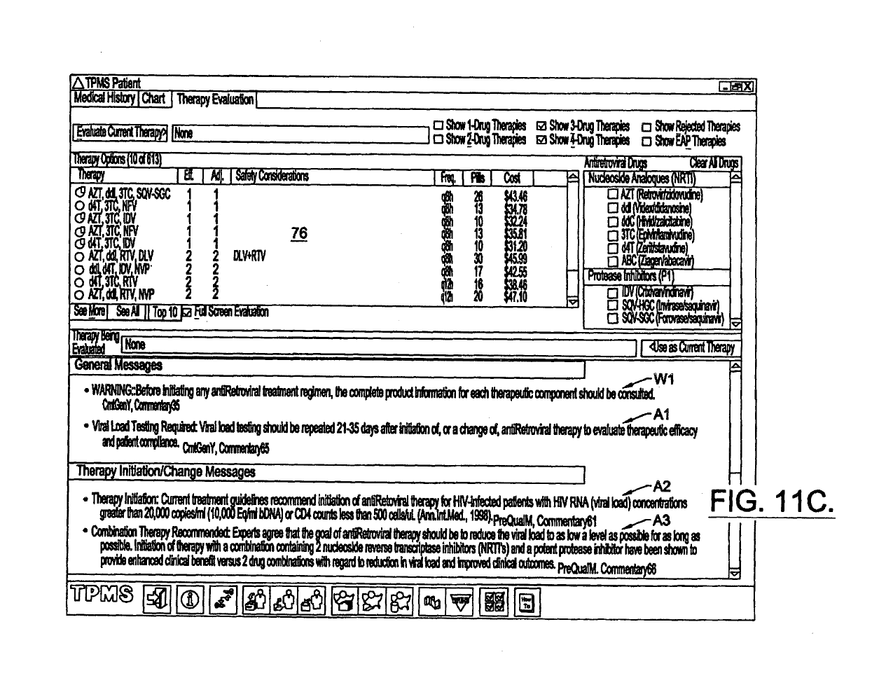

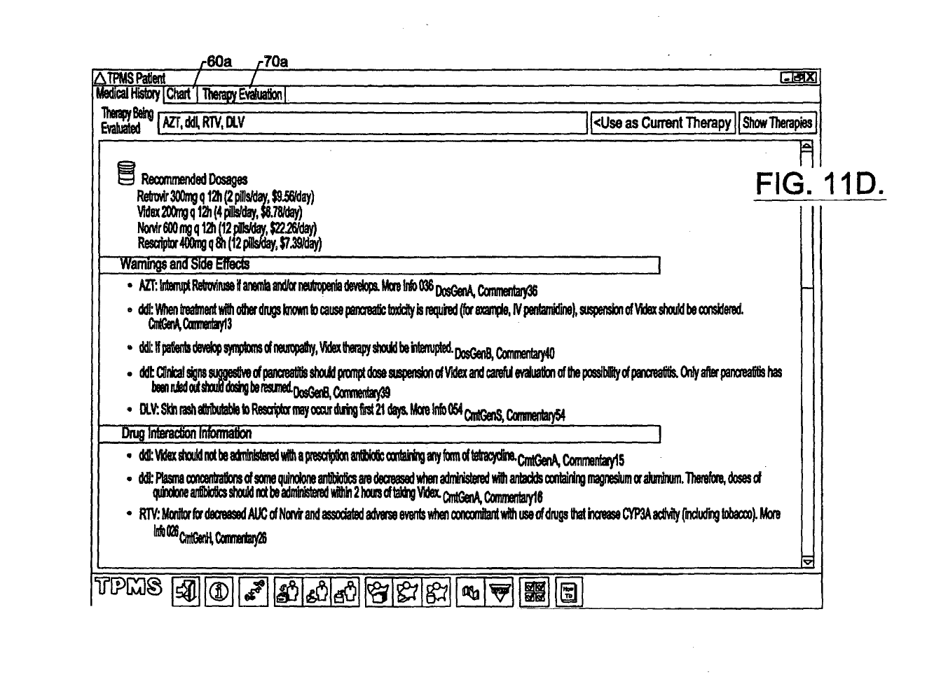

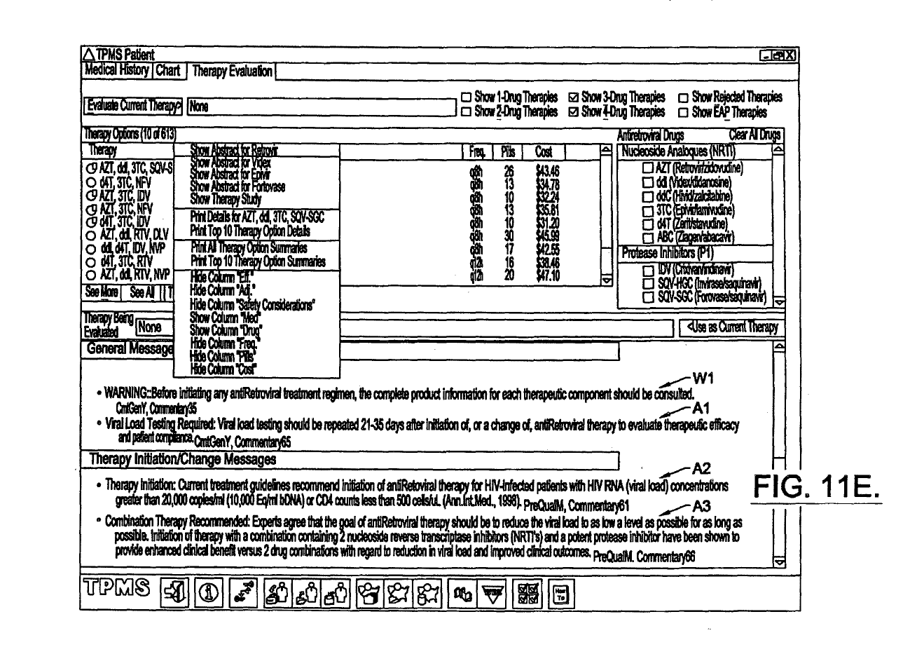

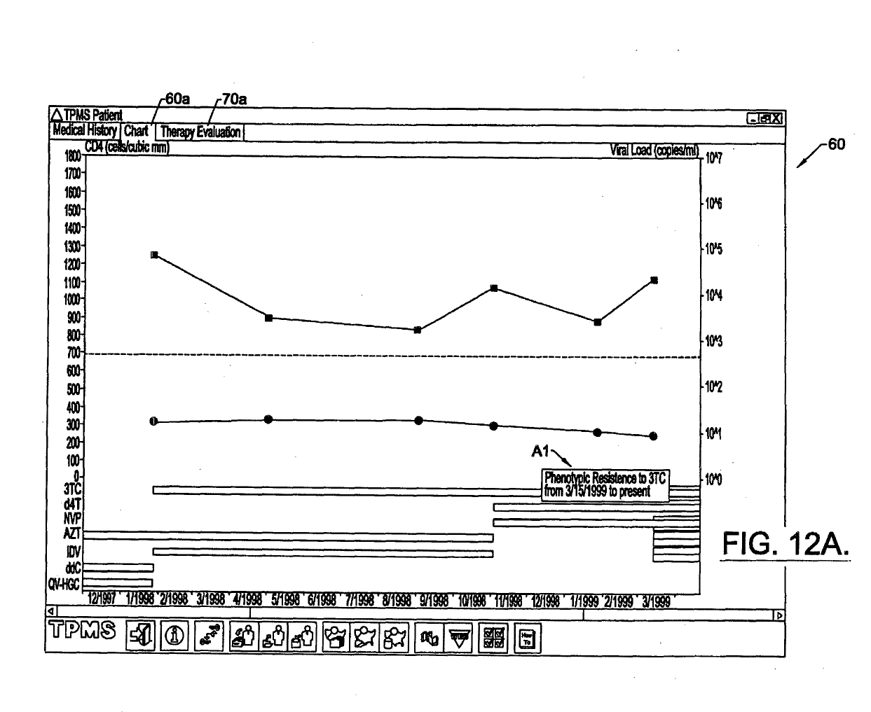

Example 2 will be explained with reference to FIGS. 11A-11E, and relates to patient file “ARV naive1” which is an example of an HIV-infected patient who has not been treated with anti-HIV drugs previously. In FIG. 11A, a medical history user interface 50 containing evaluated data for patient “ARV naive1” is illustrated. In FIG. 11B, when the “Therapy Evaluation” tab 70a is activated to display the therapy evaluation user interface 70, a “Boundary and Prequalification Messages” message box MB2 pops up indicating that according to the current, published, HIV treatment guidelines, the patient should be initiated on antiviral therapy and that the current guidelines recommend combinational therapy.

In FIG. 11C, the therapy evaluation user interface 70 has been activated and demonstrates features/functions associated with therapy evaluation including a general warning W1 and advisories A1, A2, and A3 for the patient related to treatment of the disease (e.g., whether therapy should be initiated or changed) or related to a specific therapy selected from the list box which is being evaluated by the user.

FIG. 11D illustrates various information that is displayable by clicking on an individual therapy in the therapy list box 76 of FIG. 11C. Information displayed includes dosages of all drugs with general and patient-specific warnings and advisories.

The features available by right clicking on any therapy listed in the therapy list box 76 of FIG. 11C are illustrated in FIG. 11E and include: linking to an electronic PDR® to show drug package insert information or perform drug search information; showing or hiding columns of information displayed within the therapy list box; linking to a publication or abstract associated with a therapy that has a “book” icon associated therewith; and various printing functions.

### Example 3

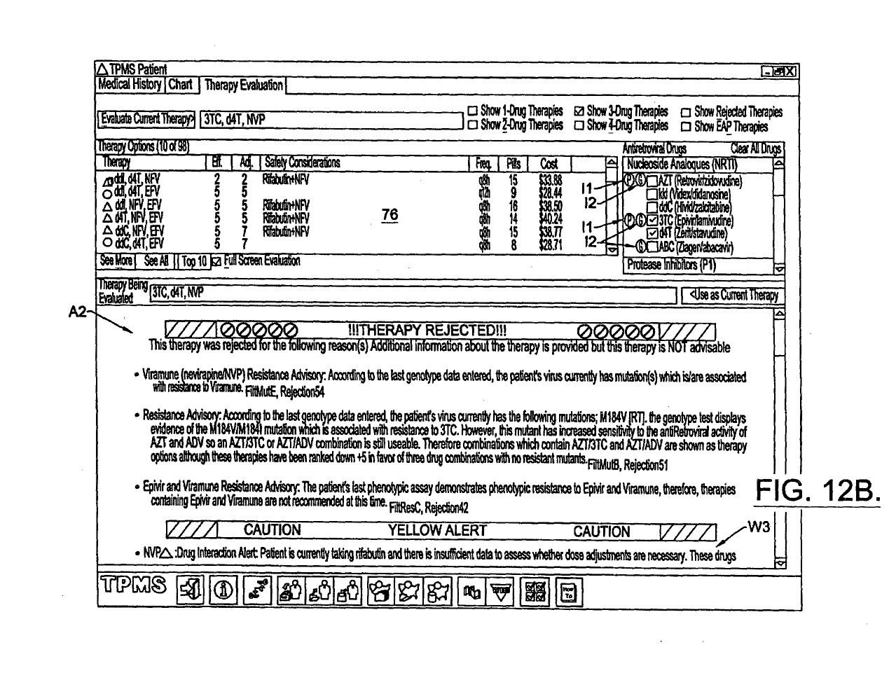

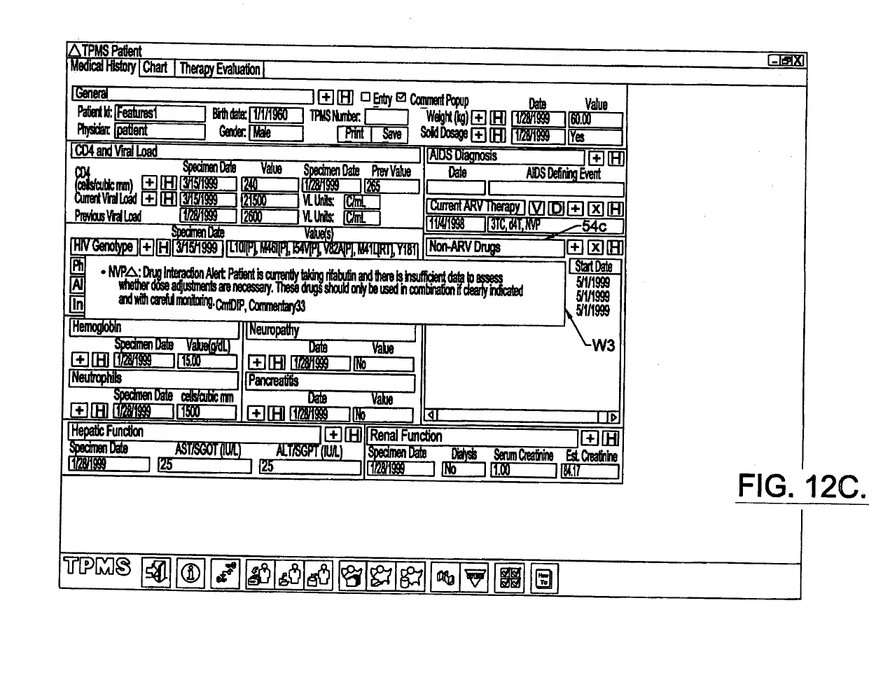

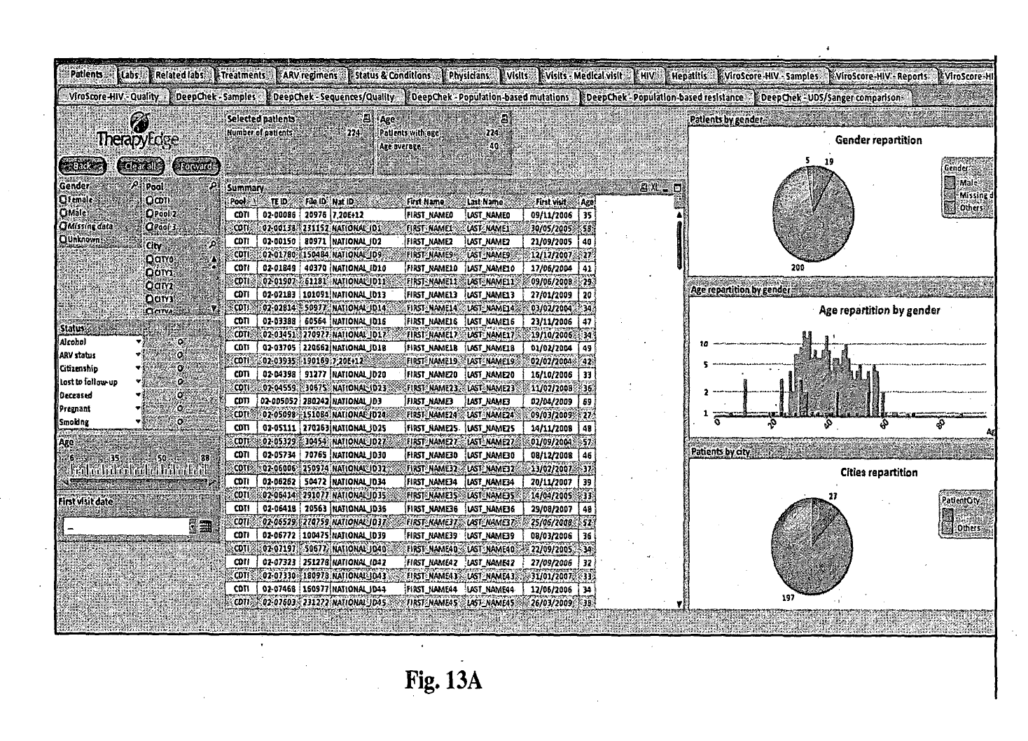

Example 3 will be explained with reference to FIGS. 12A-12C, and relates to patient file “Features1” which illustrates some important functions/features that a system according to the present invention can provide for highly drug experienced patients who may have developed resistance associated with the use of several antiviral drugs. Features, including functions attributed to the new resistance and historical therapy rules are illustrated and includes:

1) Potential drug resistance advisories (A1, FIG. 12A) when the chart tab 60a is activated, or (A2, FIG. 12B) when the therapy evaluation tab 70a is activated;

2) The heads up “P” and “G” indicators (I1 and I2, FIG. 12B) to remind of phenotypic or genotypic resistance associated with certain anti-HIV compounds as demonstrated for this patient (including indication of expected/anticipated genotypic resistance, as a result of cross-resistance, to a drug that a patient may not be taking currently or has not previously taken);

3) The drug interaction warning system (indicated by warning W3, FIG. 12C). Warning W3 is for the interaction between Nevirapine and rifabutin (which was selected from the list of non-antiretroviral drugs available as part of the medical history user interface 50). The drug interaction warning message may be viewed from the medical history user interface 50 by “right-clicking” the non-ARV title bar 54C, which has turned yellow indicating the presence of an ARV-nonARV drug interaction. This information is also prominently displayed for the user on the therapy evaluation user interface 70 as a text message (W3, FIG. 12B) as well as in the “Safety Considerations” section of the drug list box (76, FIG. 12B); and

4) The chart user interface 60 (FIG. 12A) illustrates the viral load, CD4, drug therapies, and associated drug resistance in graphic form for the user to evaluate.

### Example 4

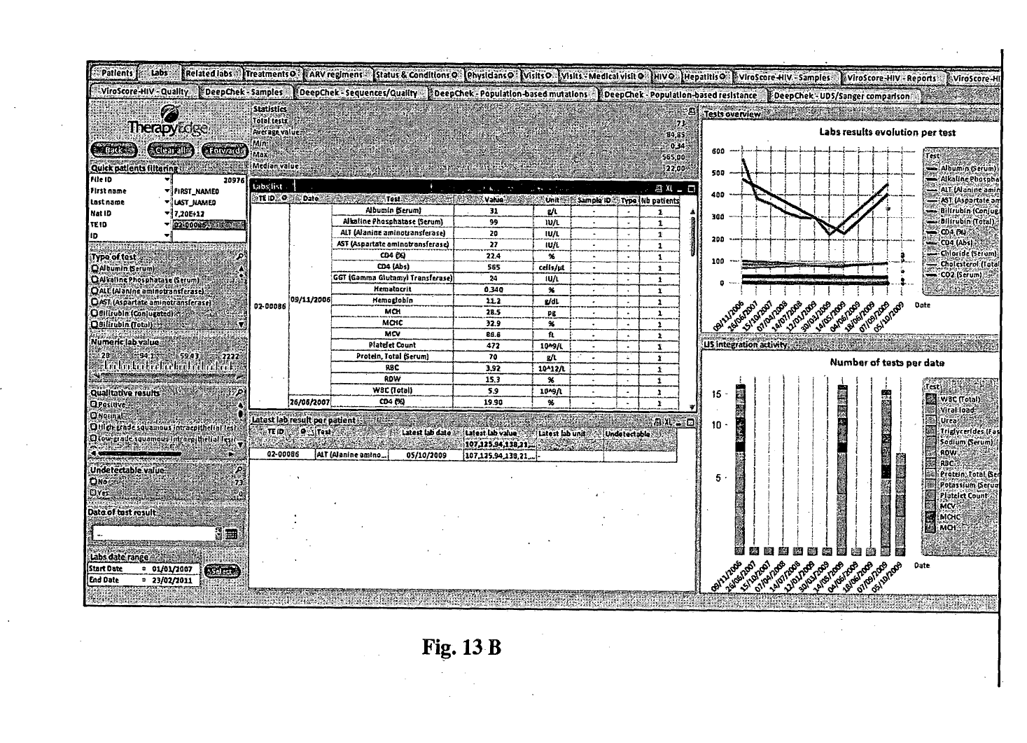

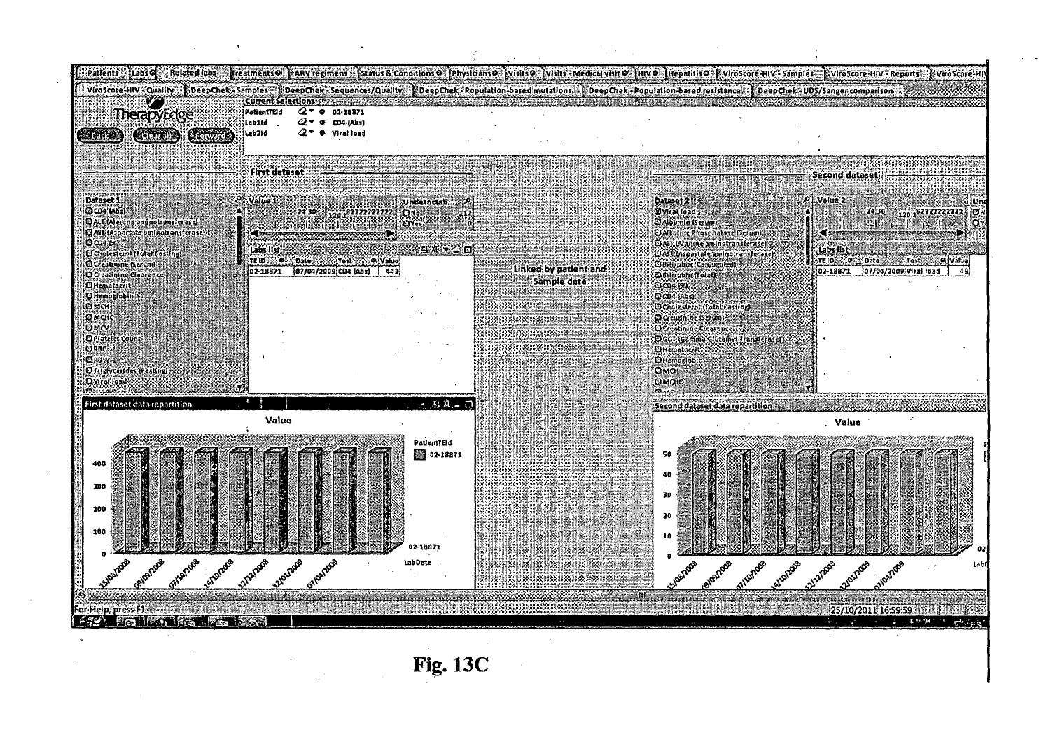

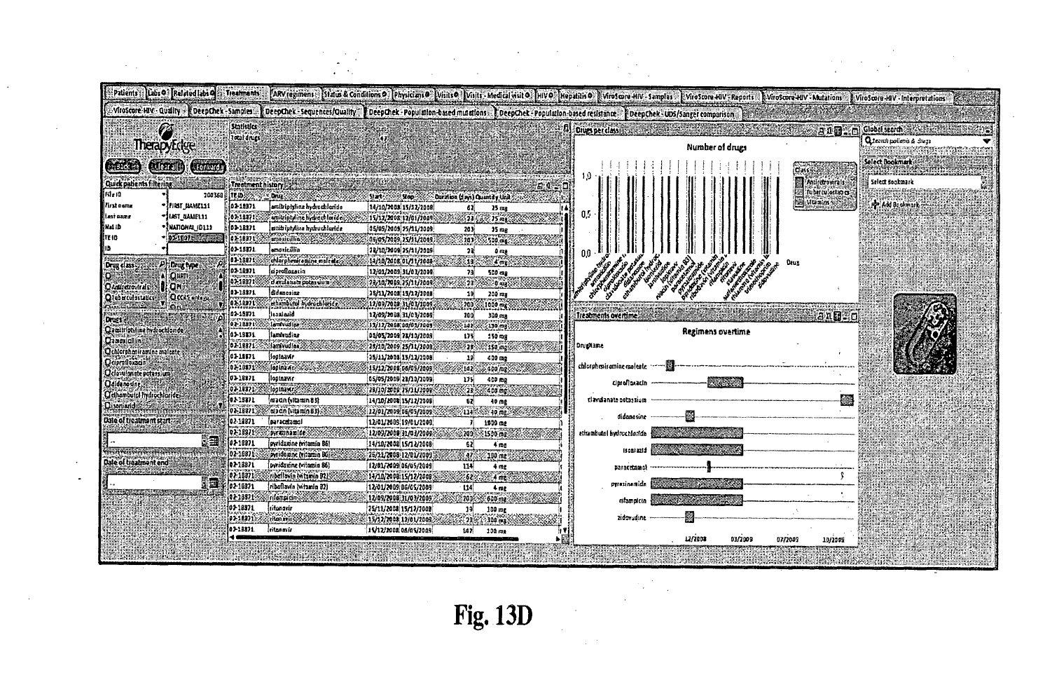

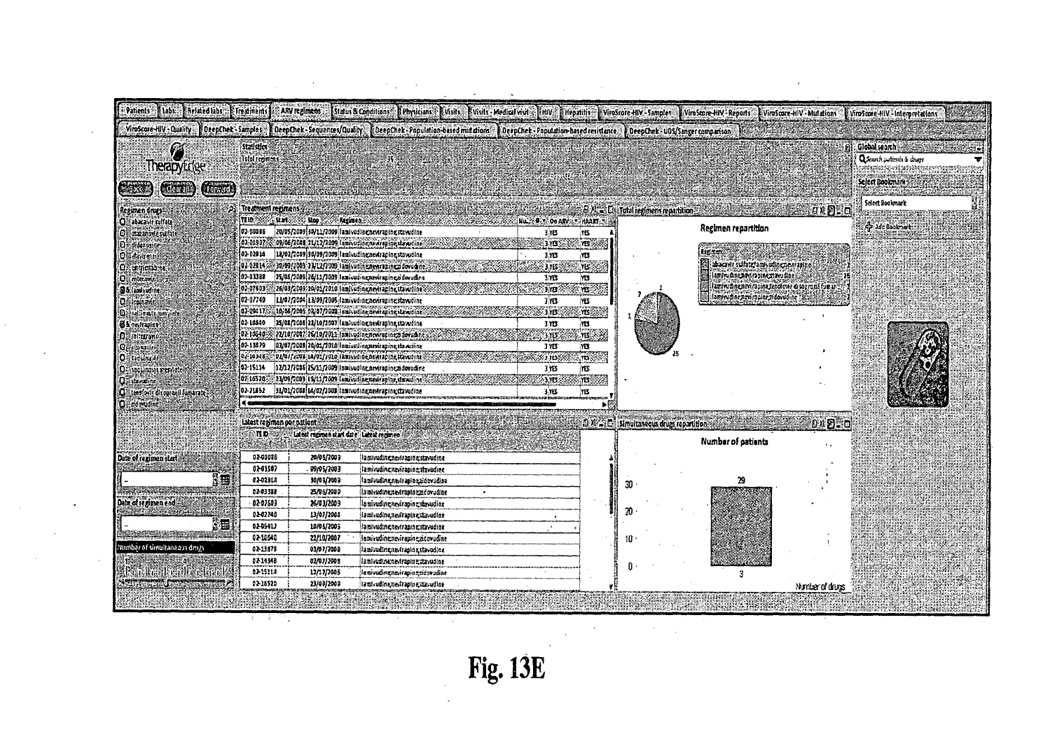

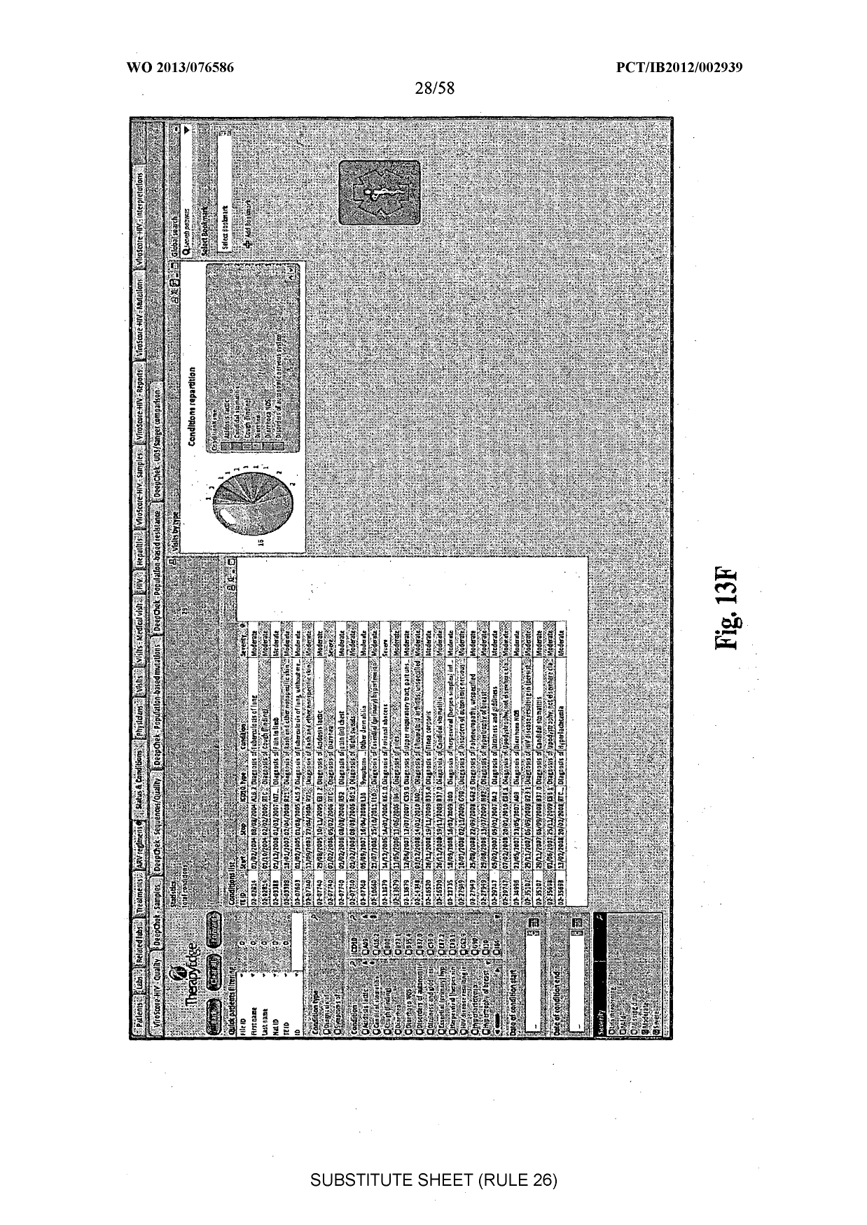

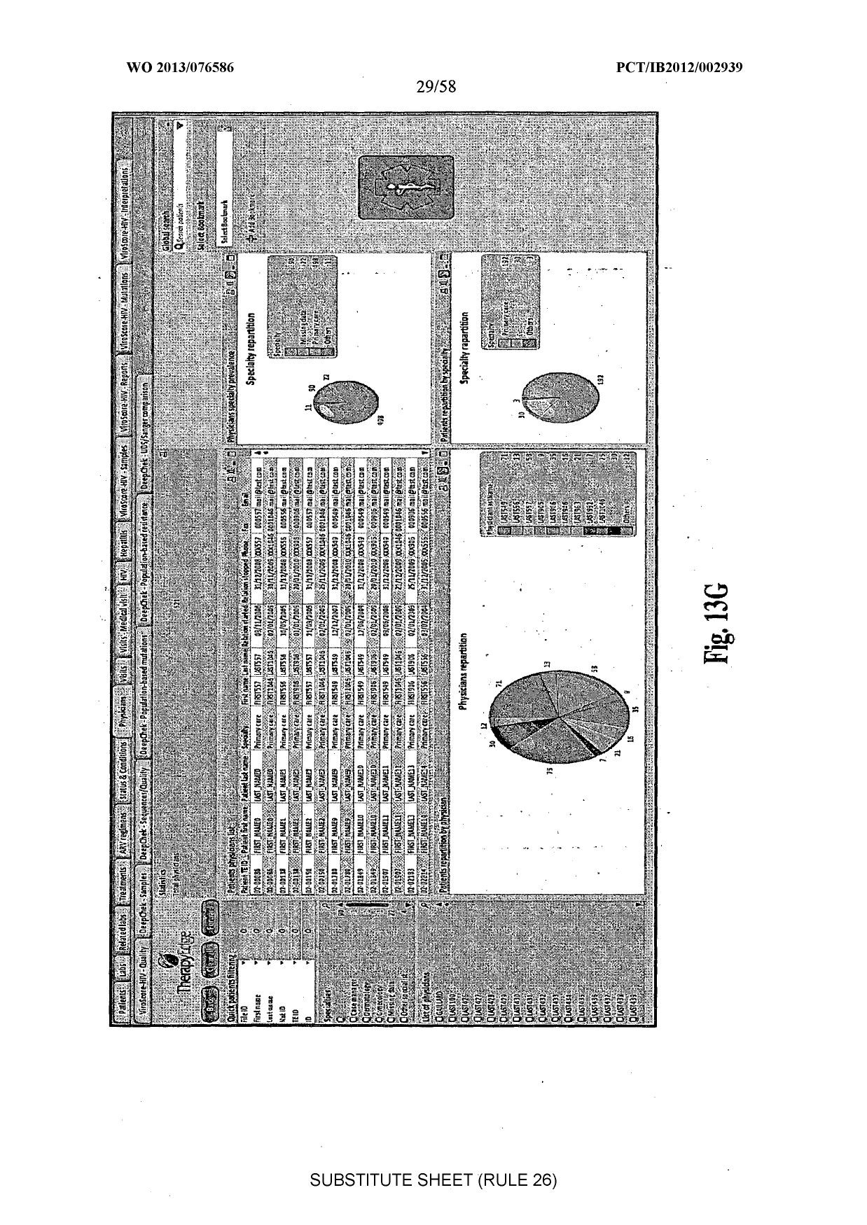

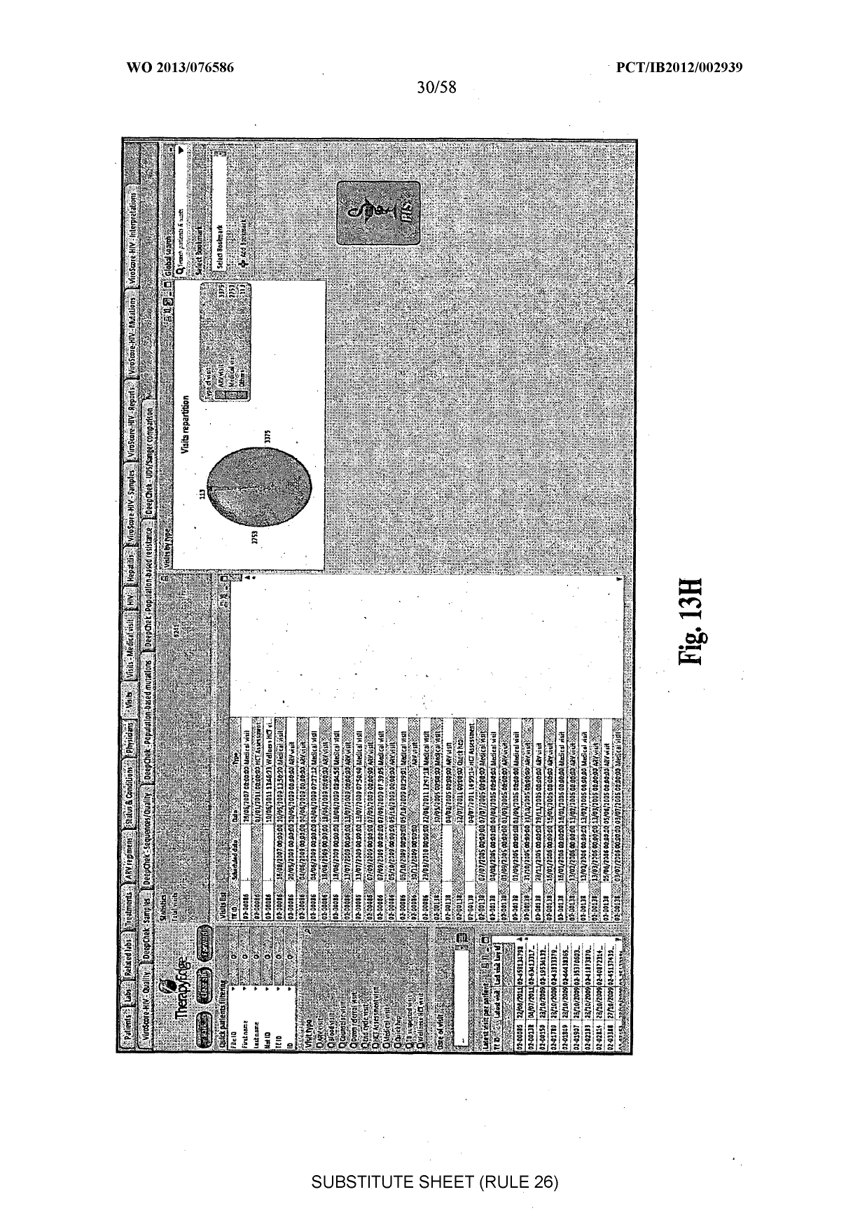

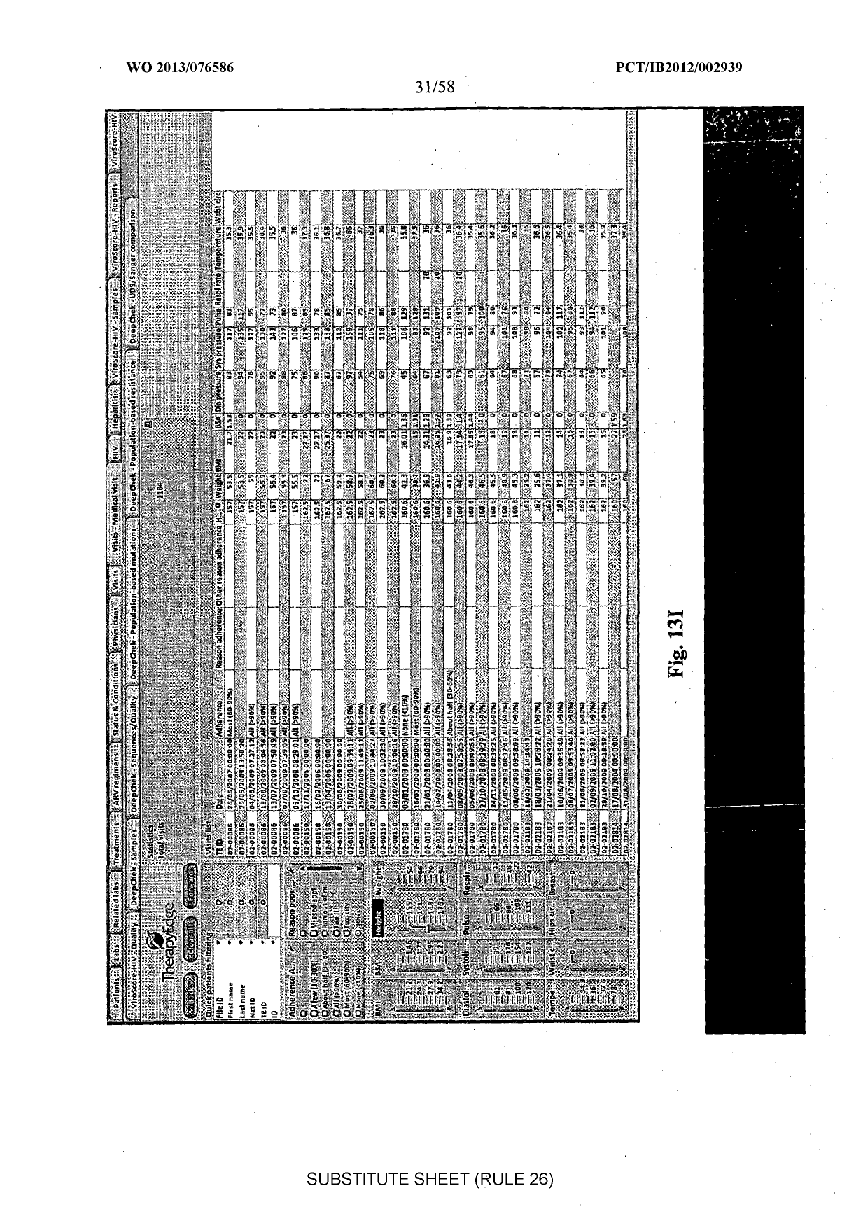

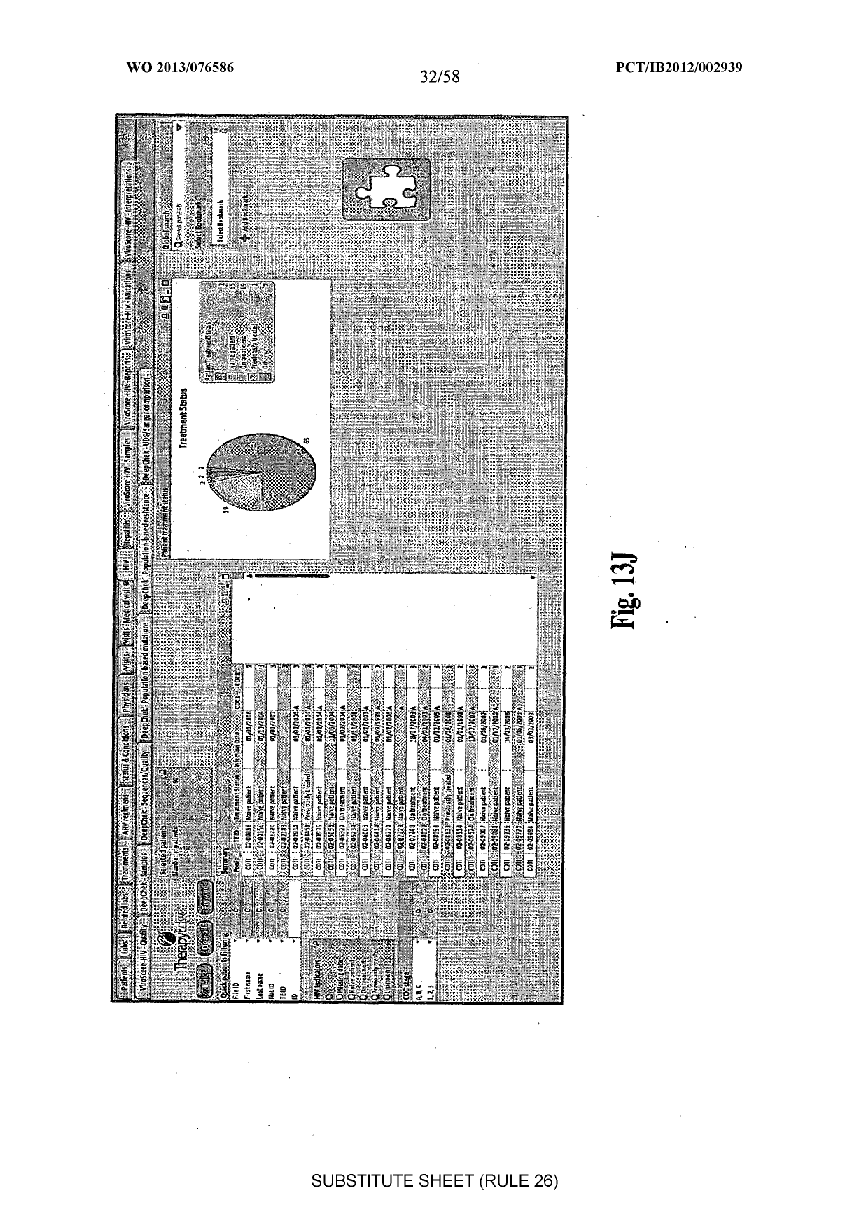

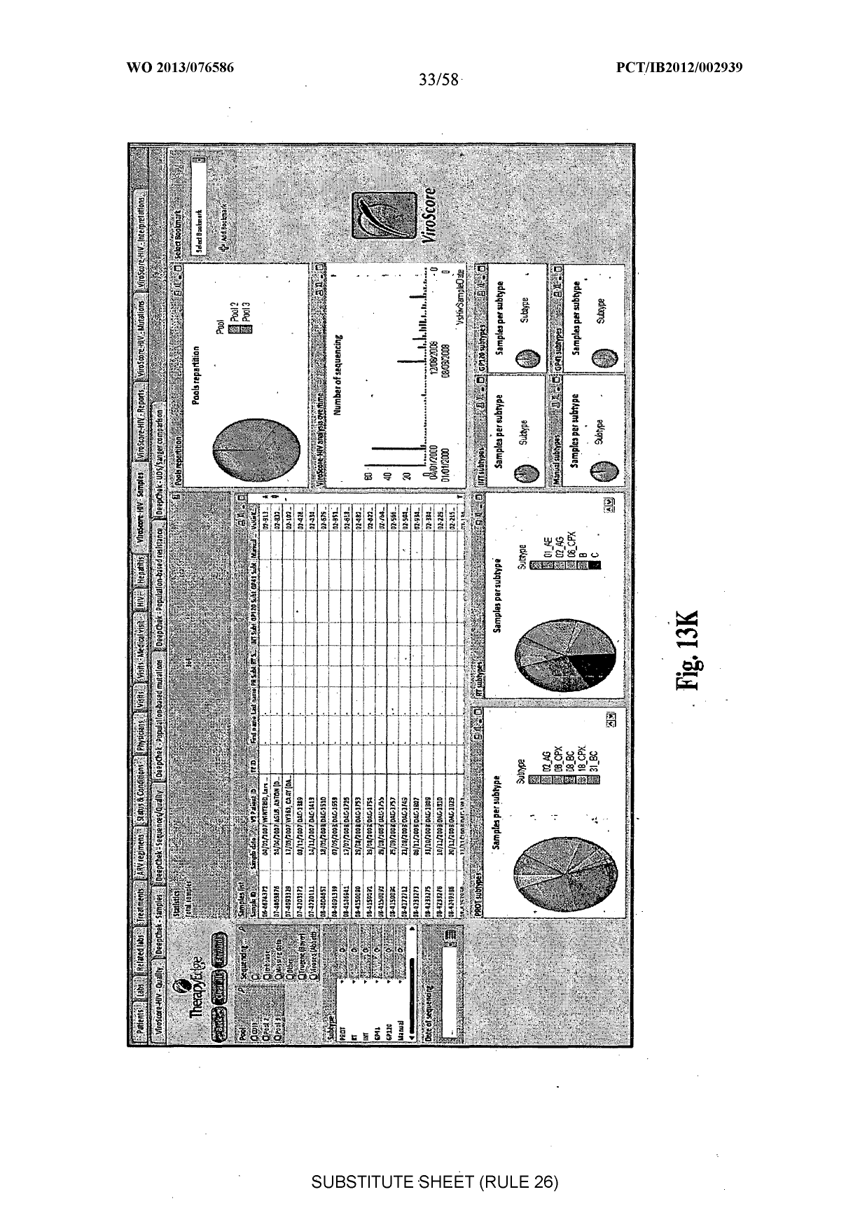

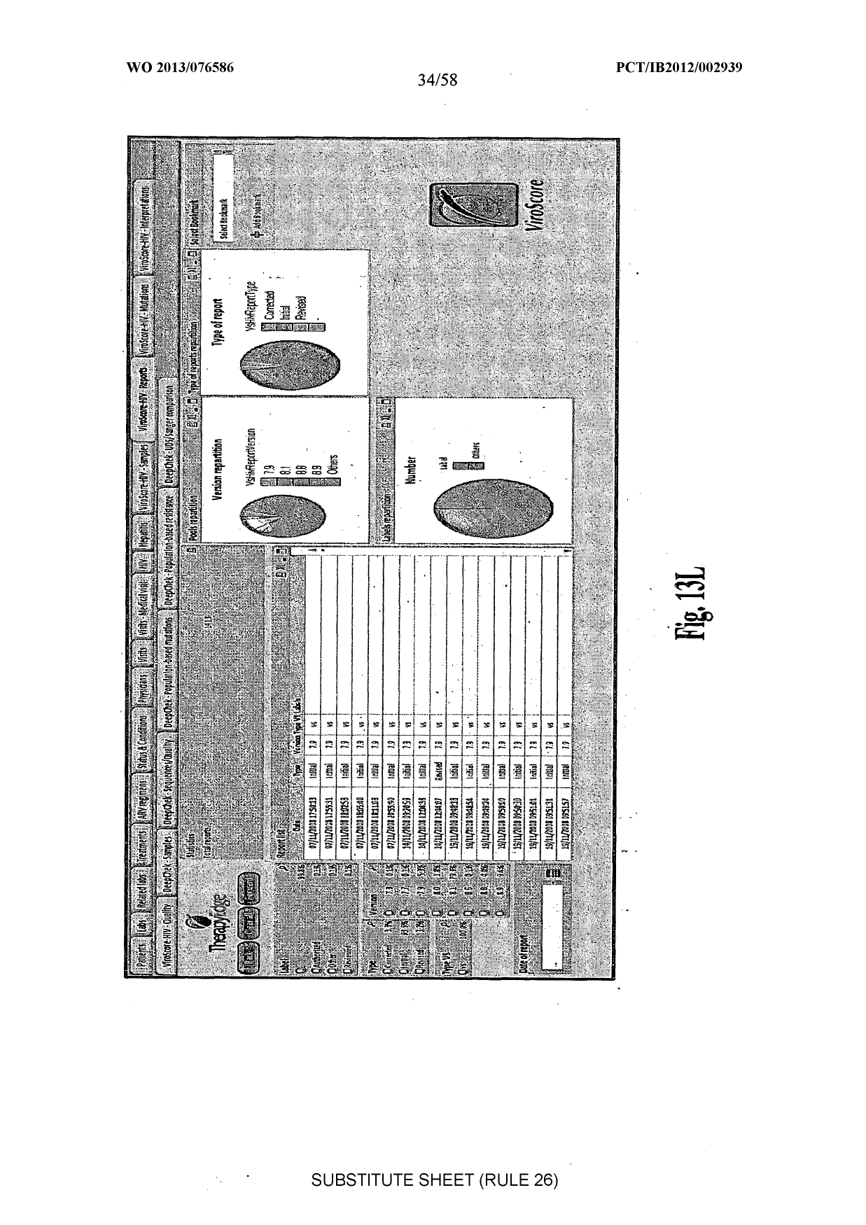

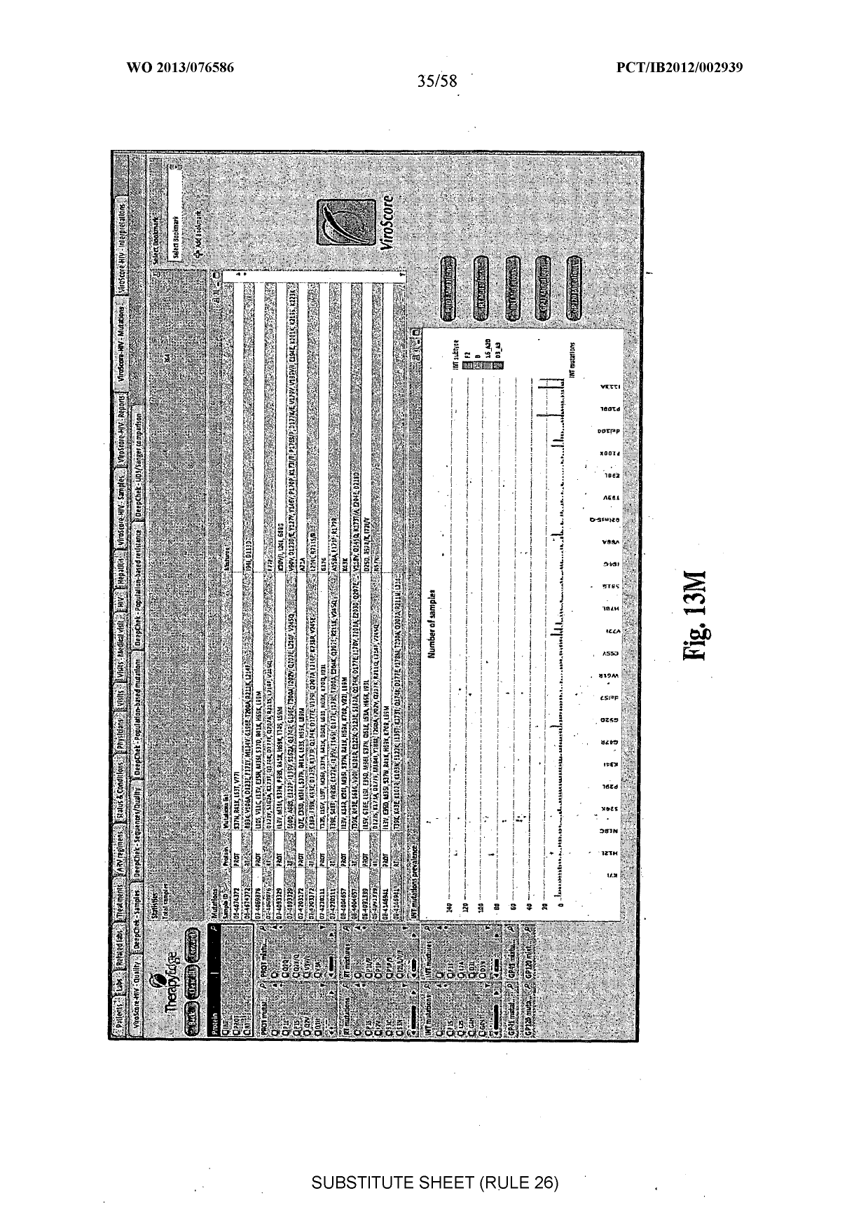

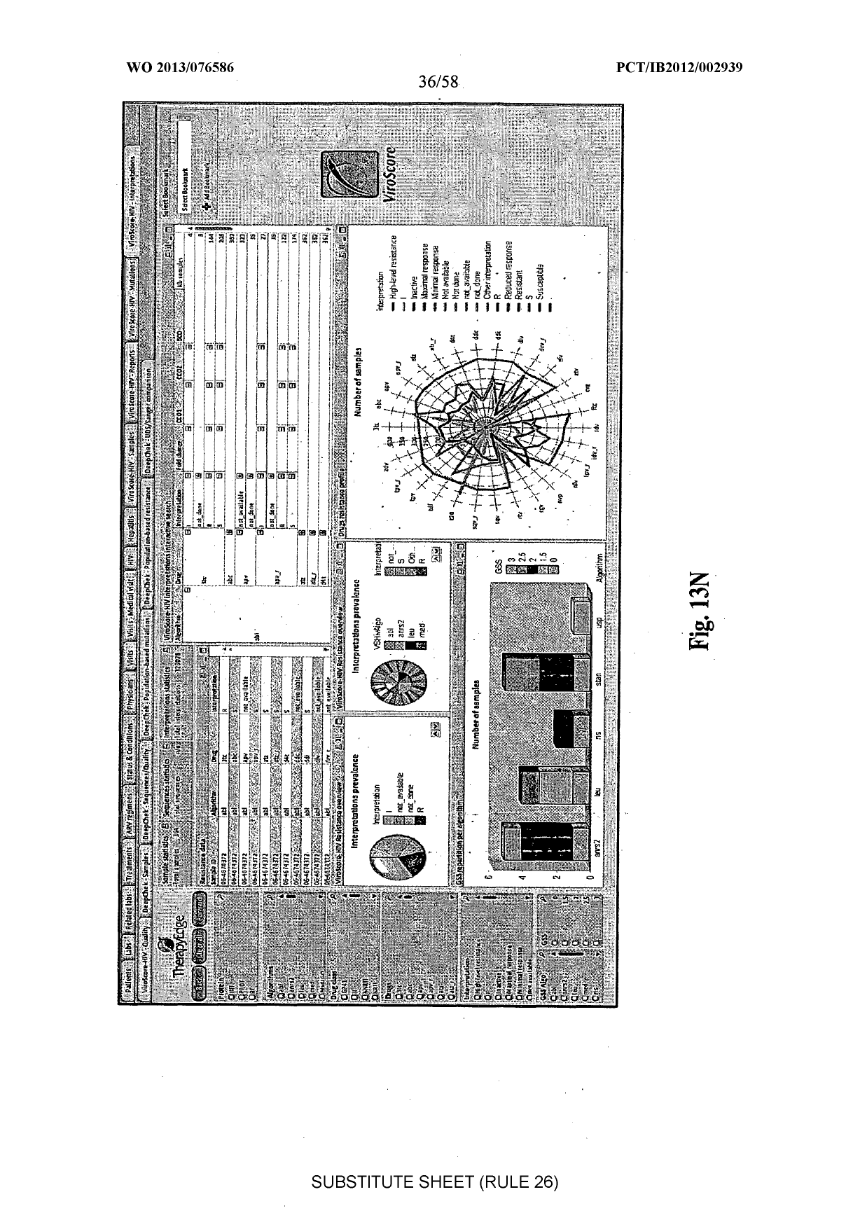

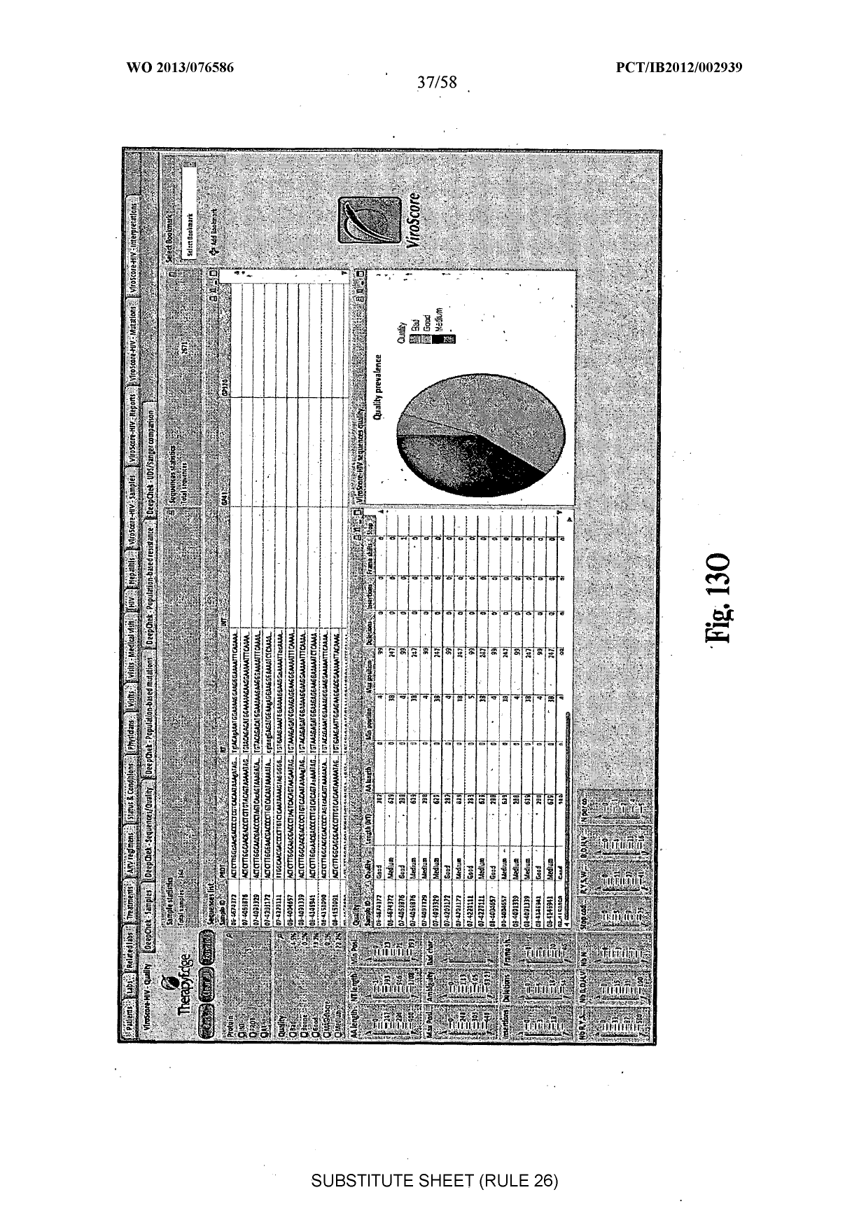

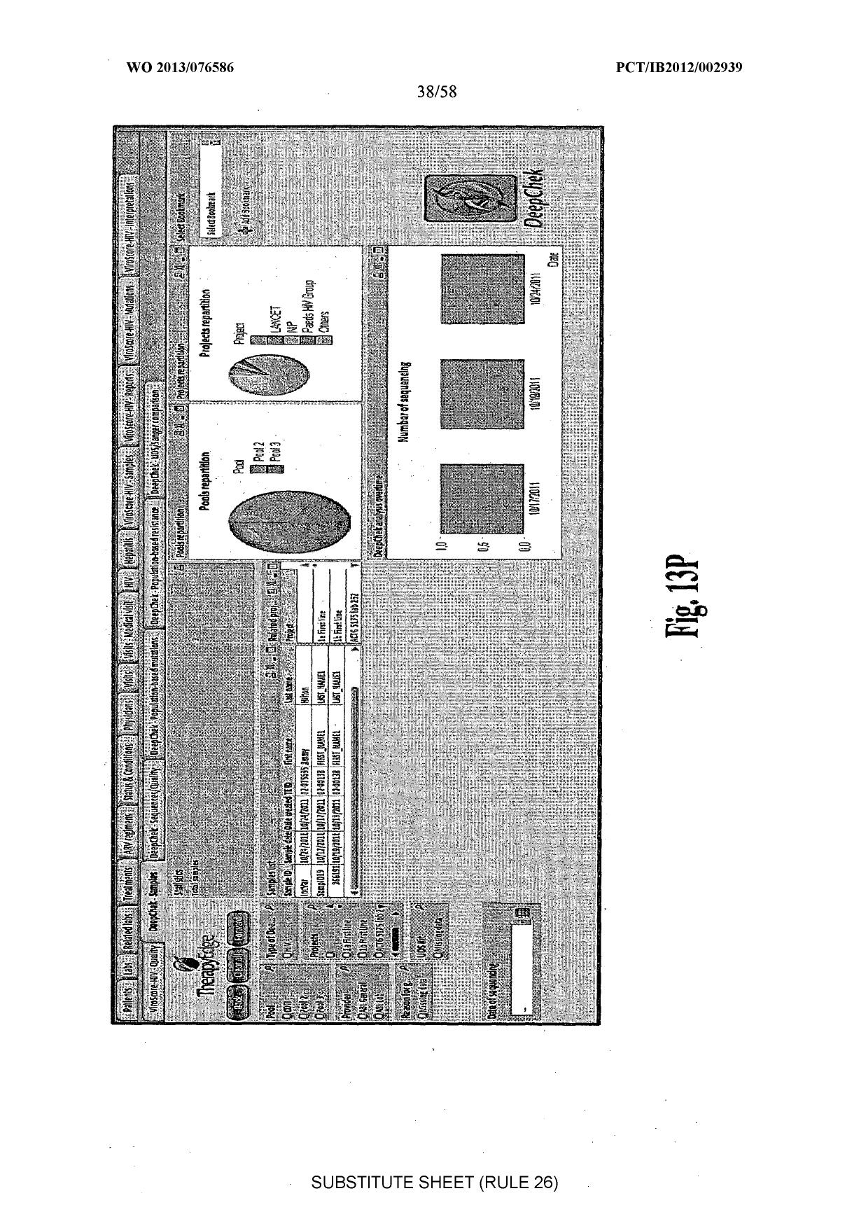

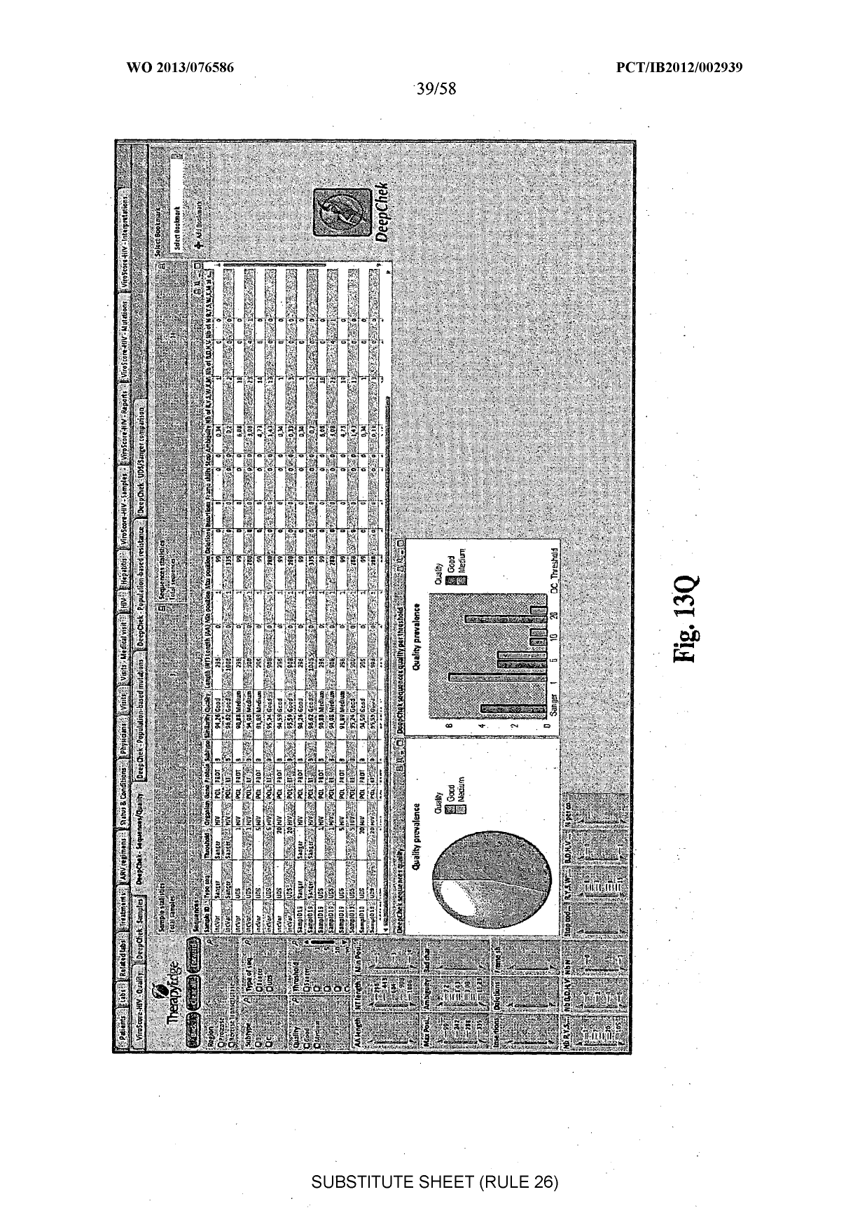

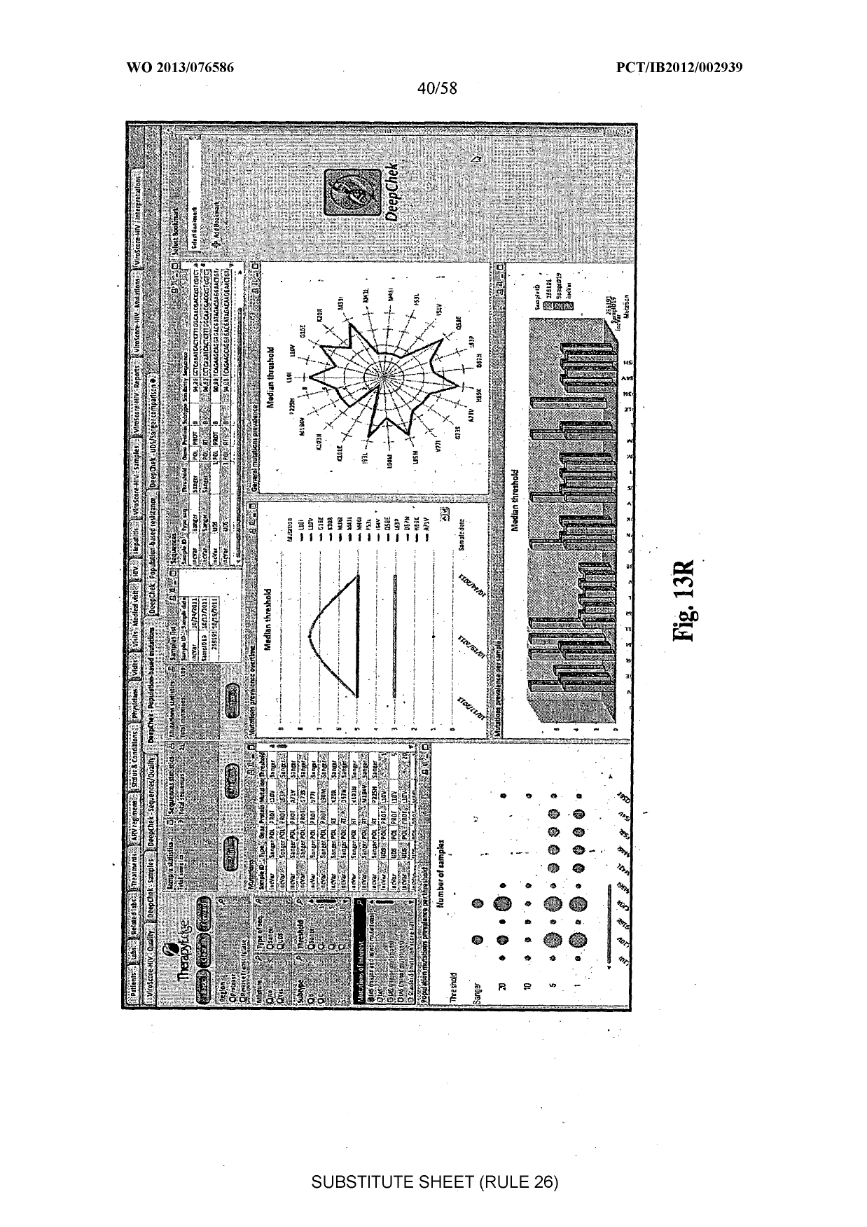

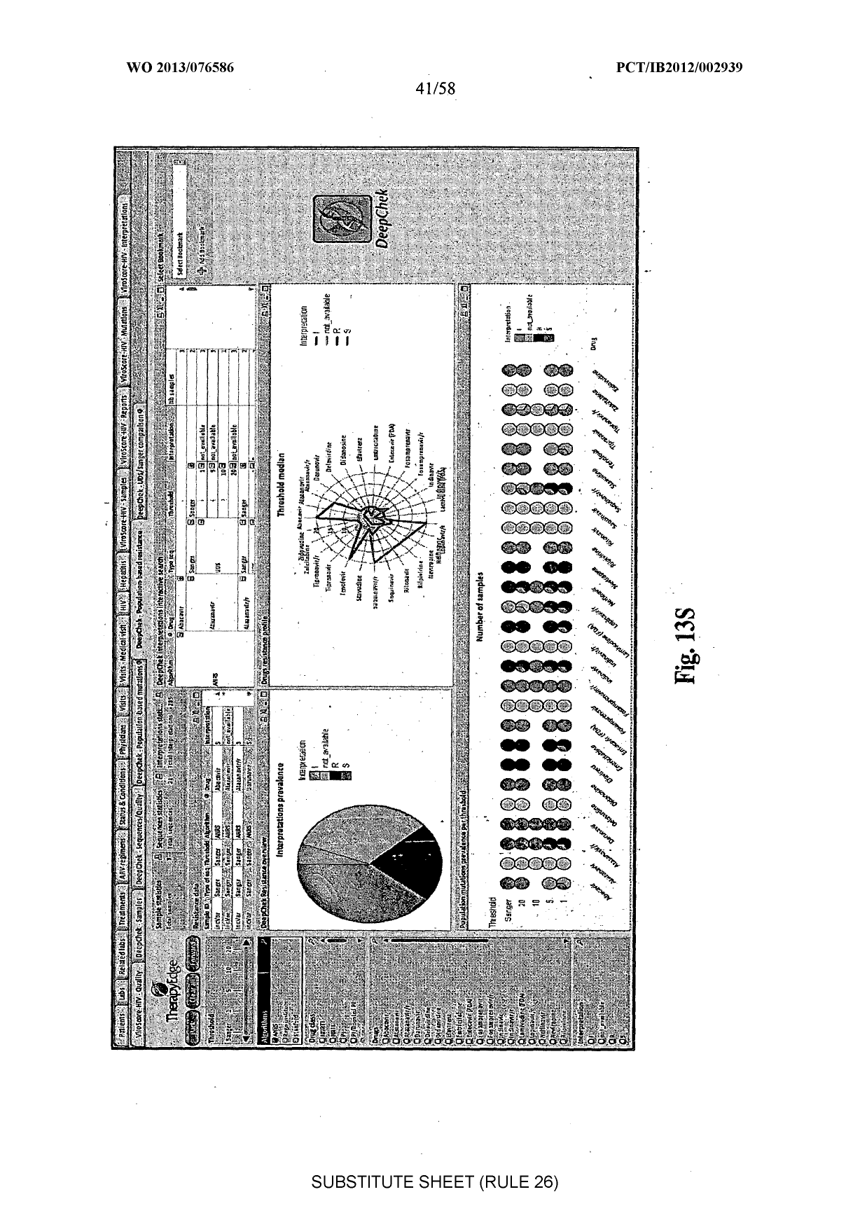

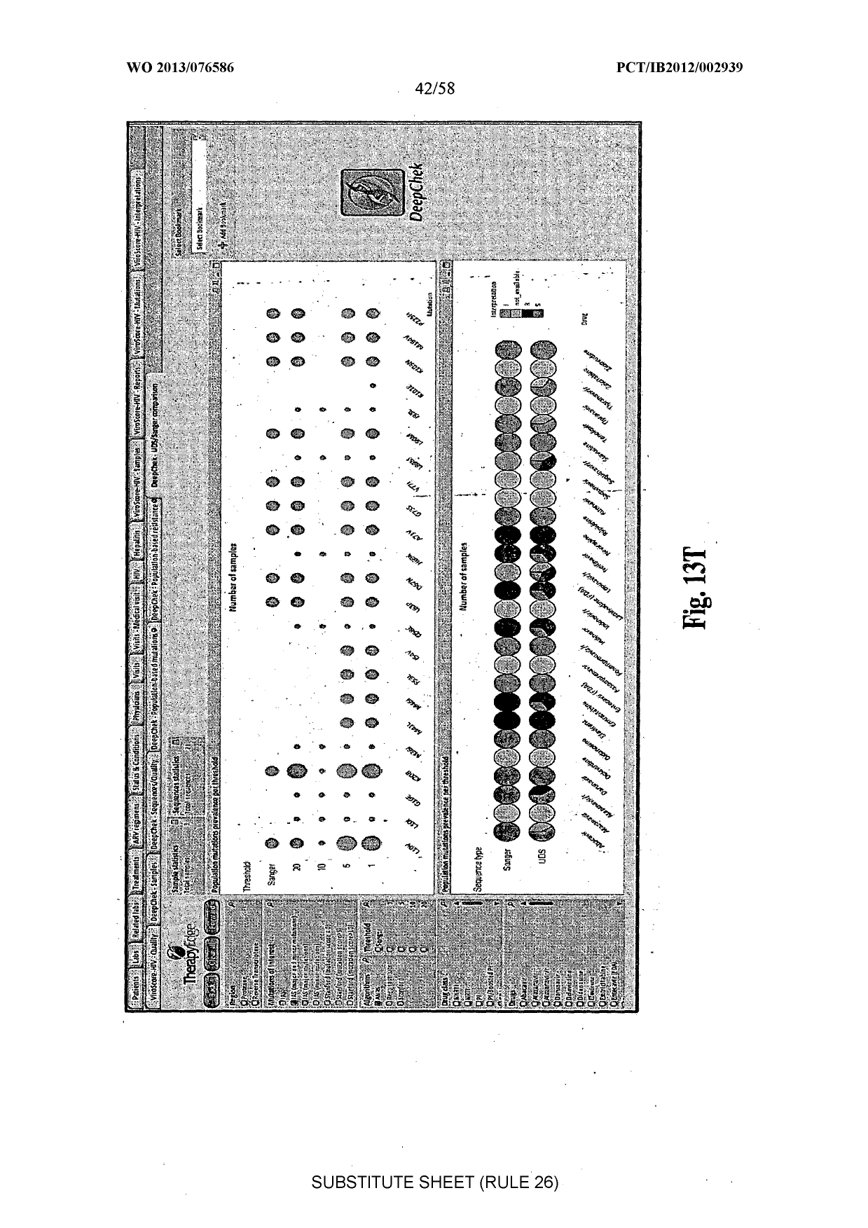

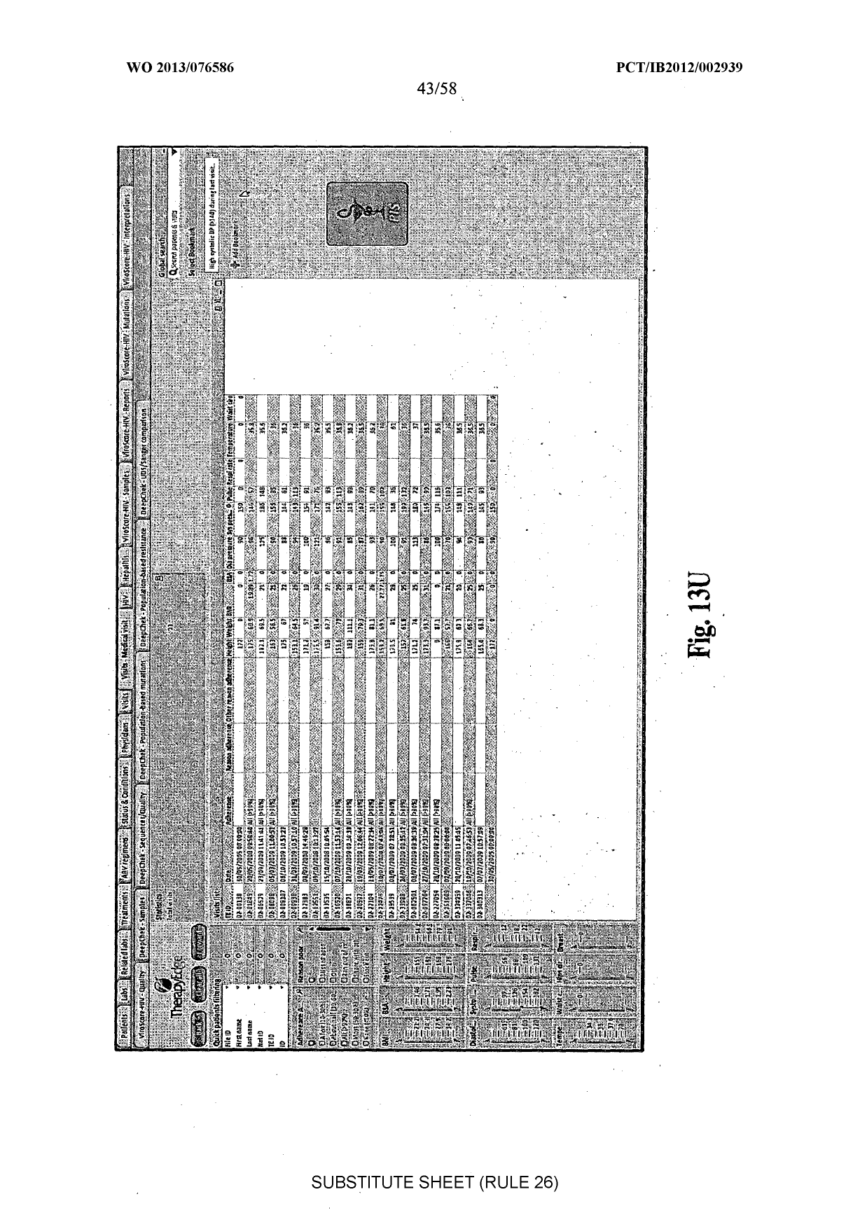

Example 4 will be explained with reference to FIGS. 13A-13U, and relates to a data exploratory framework in a patient file (termed a “QlikEdge Report). This illustrates that some important functions/features that a system according to the present invention can provide for highly drug experienced patients who may have developed resistance associated with the use of several antiviral drugs. Features, including functions attributed to the new resistance and historical therapy rules are illustrated and includes:

A “Patients” page, FIG. 13. A., which displays general information related to the selected patients: list of patients (demographics . . . ) as well as gender/sex/cities repartition in graphical representations.

A “Labs” page, FIG. 13 B, and Related Labs” page, FIG. 13. C, which display labs information related to the selected patients: list of laboratory results per patients (grid display), graphical display of biomarkers evolution overtime, number of tests per date . . . . Data can be filtered by patient, type of tests, value range, date of result, type of value, and the like.

A “Treatments” page, FIG. 13 D, which displays treatments information related to the selected patients: list of treatments per patients (drug, dosage, and the like), graphical display of treatments evolution over time, number of prescribed drugs, and the like. Data can be filtered by patient, drug class, drug, treatment start/stop dates, and the like.

An “ARV” page, FIG. 13 E, which displays antiretroviral regimens information related to the selected patients, graphical display of regimen repartition, latest regimen per patient, and the like. Data can be filtered by patient, drugs (combined or not), regimen start/stop dates, number of simultaneous ARVs, and the like.

A “Status and Conditions” page, FIG. 13 F, which displays clinical conditions information related to the selected patients, graphical display of conditions repartition . . . . Data can be filtered by patient, conditions (name or ICD10 code), condition start/stop dates, severity, and the like.

A “Physicians” page, FIG. 13G, which displays physicians information related to the selected patients, graphical display of physicians specialties repartition, specialty repartition, and the like. Data can be filtered by patient, physician, specialty, and the like.

A “Visits” page, FIG. 13 H and “Medical Visits” page, FIG. 131, which display visits information related to the selected patients, graphical display of types of visit, and the like. Data can be filtered by patient, visit type, and the like. Latest visits per patient can also be displayed.

An “HIV Indicators” page, FIG. 13 J, which displays, for example, an analysis of how many patients have received treatment, and which are treatment naive.

A “Viroscore Samples” page, FIG. 13 K and “Virocore Reports” page, which display Sanger-based genotyping (ViroScore) information for the selection: list of performed ViroScore analysis (submitted sequences, evolution overtime, subtypes, and the like) as well as graphical representations of subtypes repartition (per region).

A “Viroscore Mutations” page, FIG. 13 M, which displays Sanger-based genotyping (ViroScore) information for the selection:list/graphical display of mutations per sample (per protein), detail of encountered mixtures . . . . Data can be filtered by protein, mutation (for all the available proteins).

A “Viroscore Interpretations” page, FIG. 13 N, which displays Sanger-based genotyping (ViroScore) information for the selection, including one or more of: list of all the drug resistance interpretations (given per drug, per algorithm, per sample) as well as several graphical representations of interpretation repartition (global or per algorithm, per drug), GSS per algorithm. Data can be filtered by protein, algorithm, drug class, and drug, interpretation.

A “Viroscore Quality” page, FIG. 13 O, which displays Sanger-based genotyping (ViroScore) information for the selection: sequences, sequences quality, quality parameters (length, number of insertions/deletions, stop codon, and the like). The Figure is a graphical display of quality information. Data can be filtered by any quality parameter, including protein and type of quality.

A “DeepChek Samples” page, FIG. 13 P, which displays UDS-based genotyping (DeepChek) information for the selection: list of performed DeepChek analysis as well as graphical representations of samples repartition (per pool, per project, and the like). Data can be filtered by pool, project, date of sequencing, and the like.

A “DeepChek Quality” page, FIG. 13 Q, which displays UDS-based genotyping (DeepChek) information for the selection: sequences, sequences quality, quality parameters (length, number of insertions/deletions, stop codon, and the like). The Figure provides a graphical display of quality information. Data can be filtered by any quality parameter, including protein and type of quality.

A “DeepChek Mutations” page, FIG. 13 R, which displays UDS-based genotyping (DeepChek) information for the selection with a focus on mutations information. Min/Median/Max observed prevalence of the selection can also be displayed graphically for samples overtime, per mutation, per sample, and the like. Data can be filtered by protein, type of sequence (UDS/Sanger), threshold, mutations of interest, and other parameters.

A “DeepChek Interpretations” page, FIG. 13 S, which displays UDS-based genotyping (DeepChek) information for the selection with a focus on resistance interpretation information per sample/threshold/algorithm/drug, and the like. Data can be filtered by protein, algorithm, threshold, drug class/drug, type of interpretation, and the like. Several graphical representation of interpretations reparations (global, per drug, per drug/threshold, and the like) are available.

A “DeepChek Comparison Sanger-UDS” page, FIG. 13 T, which displays UDS-based genotyping (DeepChek) information for the selection with a focus on the comparison of mutations and resistance data between Sanger and Ultra Deep Sequencing data. Several filters are available, including one or more of: protein, mutations of interest, algorithm, thresholds, drug class/drug. The first graph shows the mutations comparison between Sanger/UDS. The second graph shows interpretations repartition from Sanger/UDS.

A “Bookmark Management” page, FIG. 13 U, which displays an embedded bookmark system can be used to store/retrieve specific filters performed on every sheet of the report. In this example, are displayed information (list of patients . . . ) with High systolic blood pressure (>140) during the last visit.

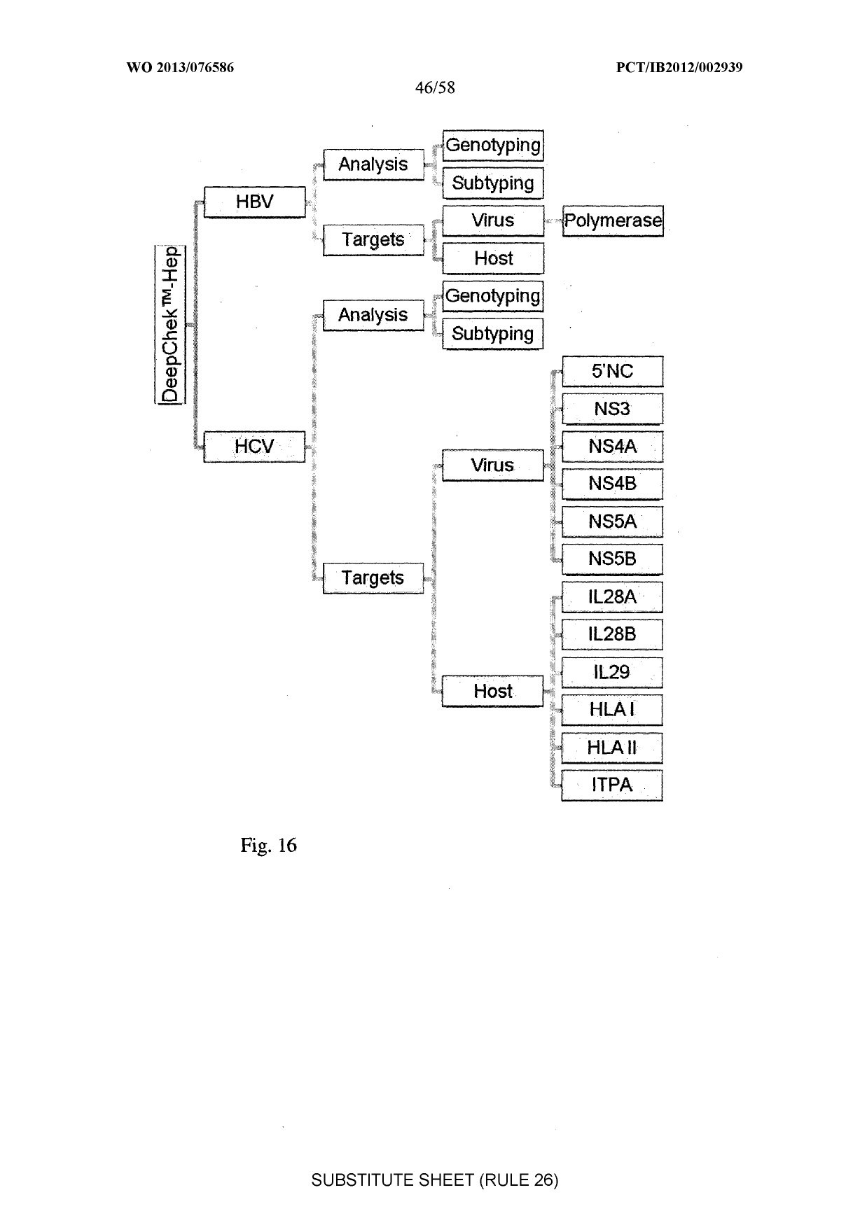

FIG. 16 is a chart showing types of analysis that can be included in a personal report, for HCV and HBV, including genotyping, subtyping, and the presence of mutations in both the virus (and in which enzyme or other target) and the host. Particularly with respect to HCV, the mutations in the host can determine the potential effectiveness of an anti-HCV treatment.

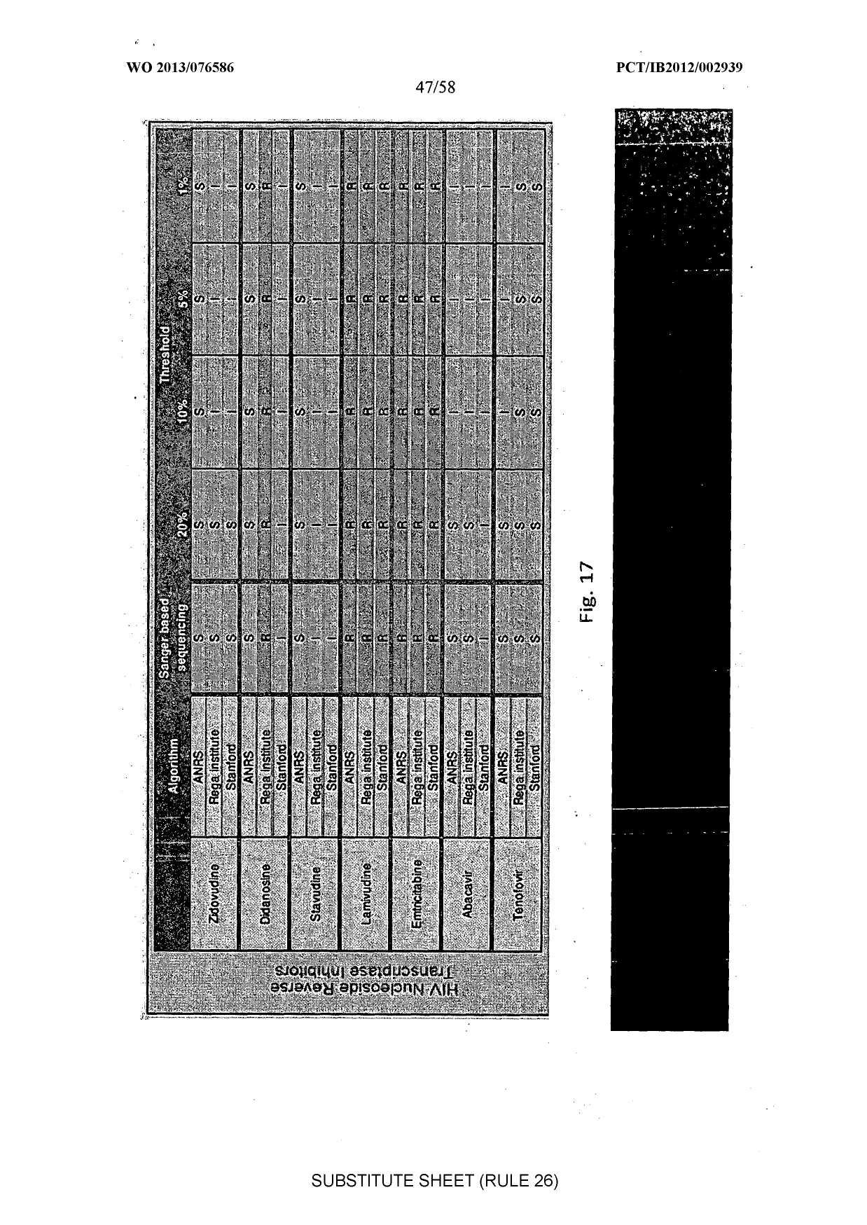

As shown in FIG. 17, the interpretations can be displayed for each selected threshold as well as for the Sanger sequences (if enabled). The interpretations can be given though the R/I/S nomenclature (R: Resistant; I: Intermediate; S: Sensible; N/A: Not Available), optionally together with a specific background color.

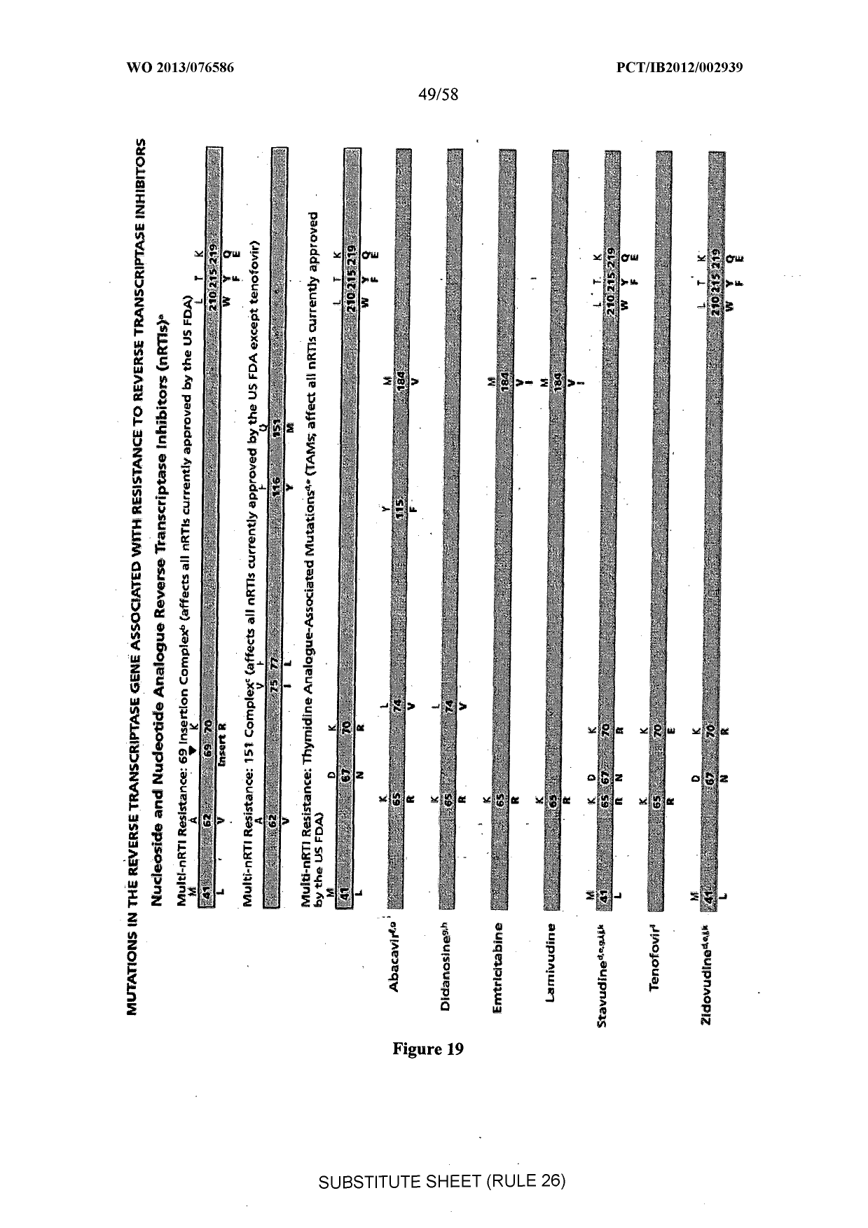

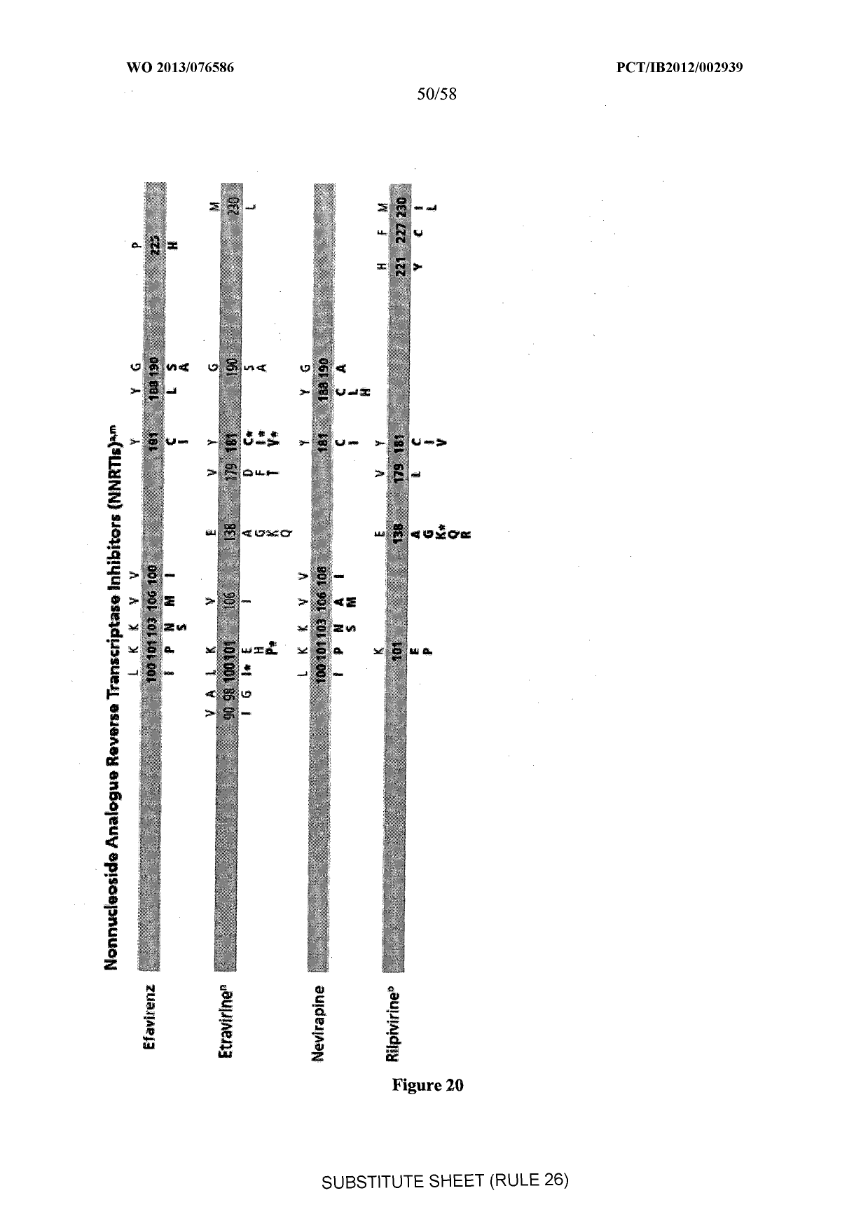

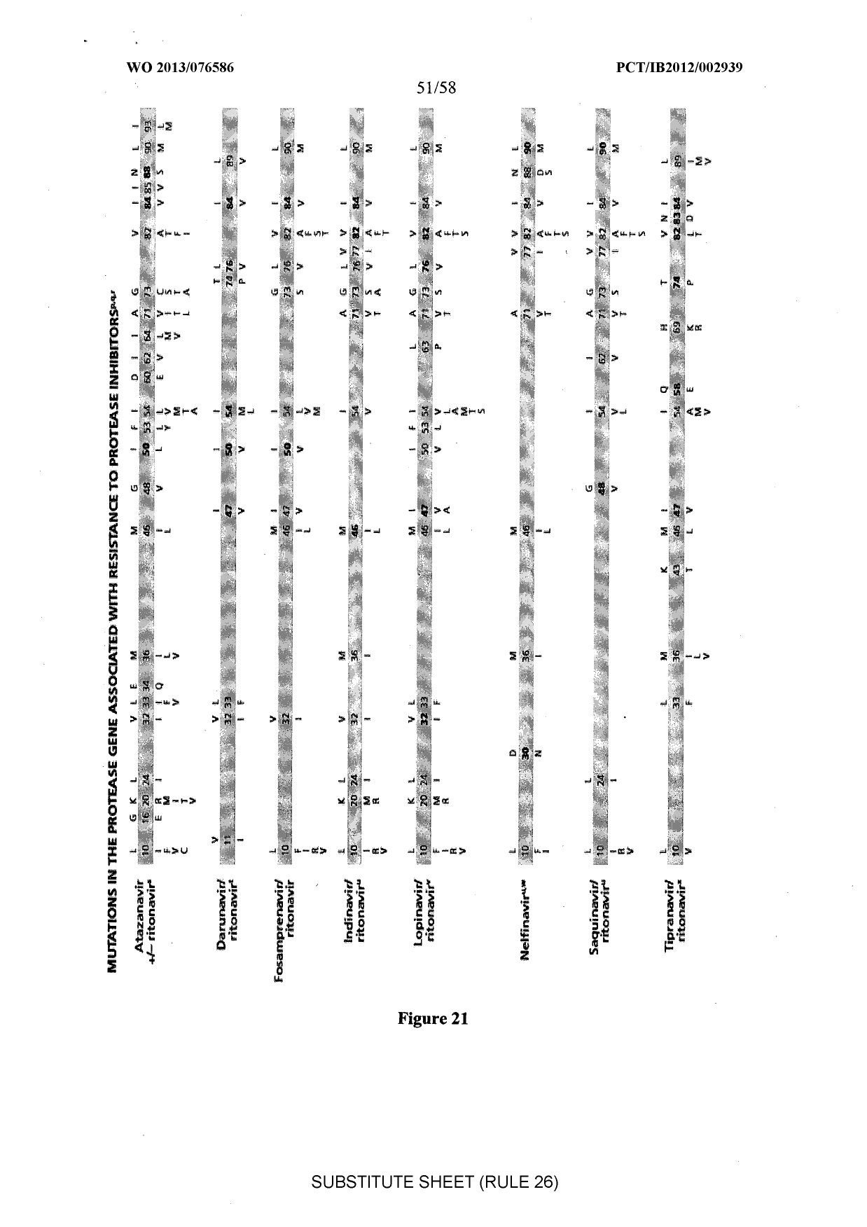

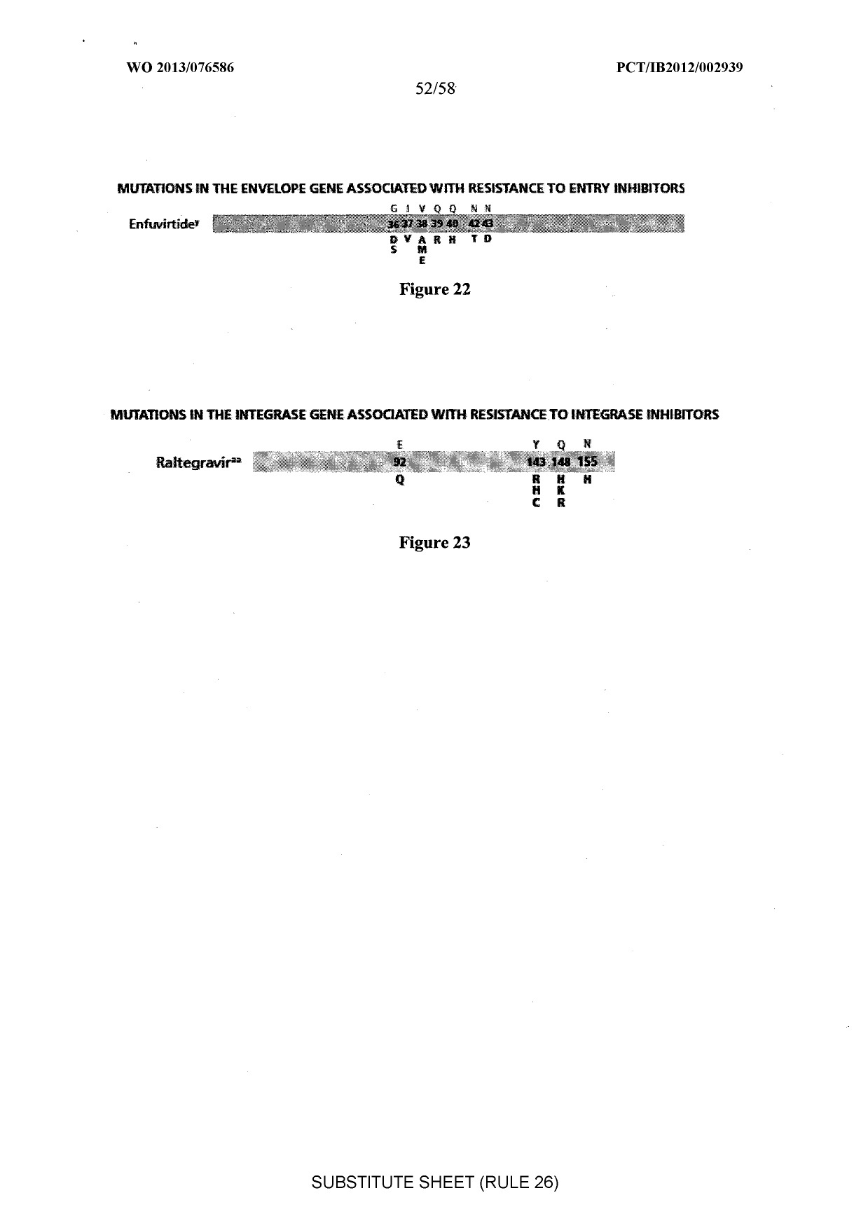

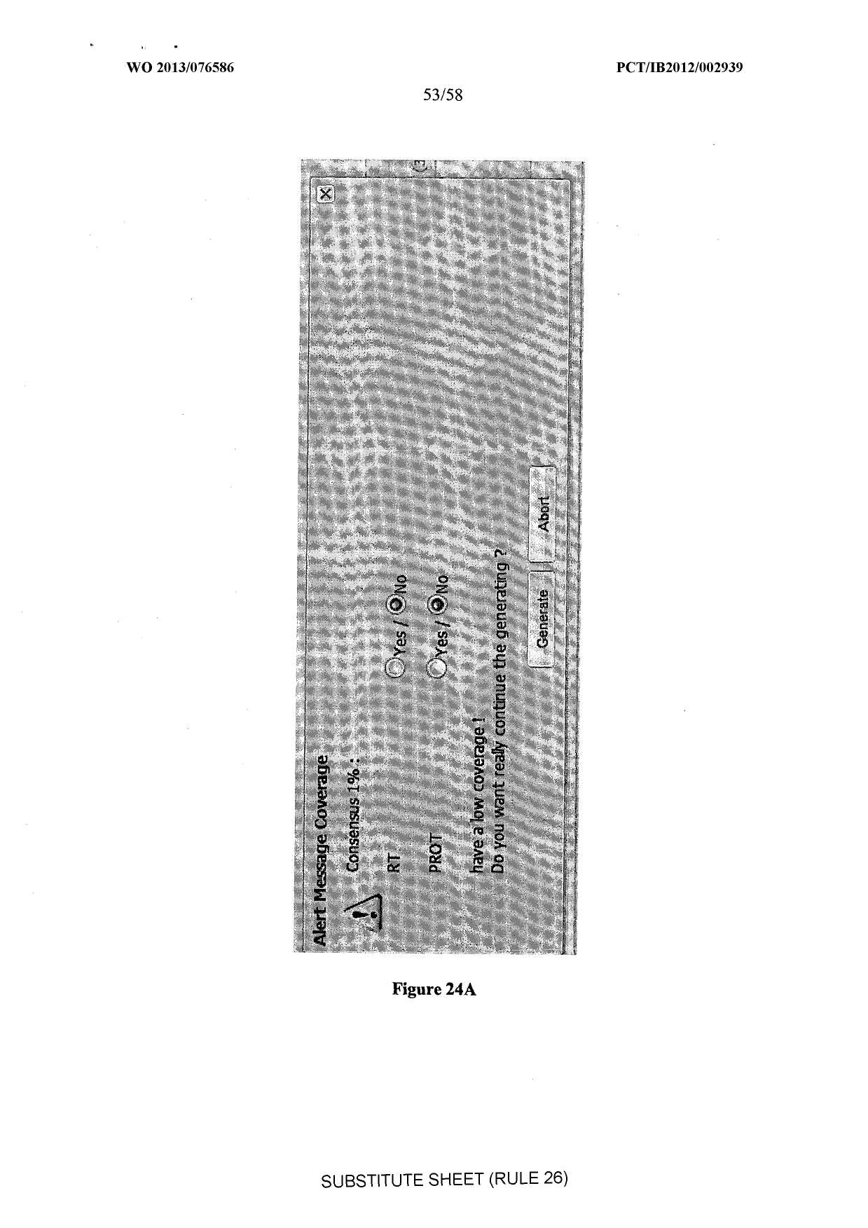

FIG. 18 is a chart showing the effect of the presence of minority variant copies, and adherence to antiviral therapy, on virologic failure. FIGS. 19-23 show various mutations associated with different classes of anti-HIV agents, which can be used to provide the Rules for prescribing a given therapy for a patient with a given set of HIV mutations.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1-151. (canceled)

152. A method for rapidly storing, analyzing, managing, and/or interpreting data generated from ultra-deep sequencing (UDS) systems, comprising:
(a) providing patient information, comprising UDS data related to a disorder or medical condition from which the patient is suffering, to a computing device comprising a software system capable of:
i) analyzing the UDS data and identifying observed mutation populations, and
ii) generating reports which comprise observed mutation populations; and
(b) generating in said computing device a report comprising observed mutation populations; wherein such mutation populations are observed either on a population-based observation and reporting, or clonal/haplotype-based analysis and reporting.

153. The method of claim 152, wherein said report includes information on low-level viremia of pathogens or provides a clinical relevant value to the amount of a given mutation present in a clinical sample,
wherein the pathogen is a virus selected from the group consisting of HIV, HCV, HBV, and influenza, or a bacteria selected from the group consisting of Staph spp and Tuberculosis.

154. The method of claim 153, wherein the report further comprises information regarding mRNA or low cell copy number present in the patient sample.

155. The method of claim 152, wherein the UDS sequence data is aligned before it is analyzed.

156. The method of claim 152, wherein the patient has an HIV-1, HBV or HCV infection, and wherein the patient information comprises UDS data obtained by:
(a) screening a patient infected with HIV-1, HBV, or HCV for i) the presence or absence of mutations, and the types of mutations, present in the primary HIV-1, HBV, or HCV associated with the infection, ii) the presence or absence of one or more minority variants of HIV-1, HBV, or HCV, and iii) the types of mutations in said one or more minority variants, using a genetic screening assay, and
(b) providing patient information comprising data regarding the types of mutations present in the primary HIV-1, HBV, or HCV, the presence or absence of one or more minority variants, and the types of mutations present in the one or more minority variants, to the computing device.

157. The method of claim 152, wherein the method further comprises the step of obtaining an alignment and interpretation of insertions/deletions and/or other DNA genetic rearrangements or obtaining an analysis of RNA expression.

158. The method of claim 157, wherein the analysis of RNA expression is performed in a microarray.

159. A method for guiding the selection of a therapeutic treatment regimen for a patient with a known disease or medical condition, said method comprising:
(a) providing patient information, comprising UDS data related to a disorder or medical condition from which the patient is suffering, to a computing device comprising:
a first knowledge base comprising a plurality of different therapeutic treatment regimens for said disease or medical condition;
a second knowledge base comprising a plurality of expert rules for evaluating and selecting a therapeutic treatment regimen for said disease or medical condition; and
a third knowledge base comprising advisory information useful for the treatment of a patient with different constituents of said different therapeutic treatment regimens;
a software system capable of analyzing the UDS data and identifying observed mutation populations, and generating reports which comprise observed mutation populations; and
a software system for identifying, in light of the observed mutation populations, different therapeutic treatment regimens, expert rules, and advisory information, one or more available therapeutic treatment regimens for the disorder from which the patient is suffering, and generating advisory information regarding the treatment regimen(s) and/or ways to monitor the patient undergoing the treatment regimen(s),
(b) generating in said computing device a report comprising a ranked listing of available therapeutic treatment regimens for said patient.

160. The method of claim 159, wherein the patient information further comprises a user-defined treatment regimen, and wherein instead of, or in addition to, generating a ranked listing of available treatment regimens, the user-defined treatment regimen is analyzed by the software system, in light of the observed mutation populations, expert rules, and advisory information, and
a report is generated providing advisory information regarding the user-defined treatment regimen, and optionally ranks the user-defined treatment regimen along with other treatment regimens in a ranked listing of available treatment regimens.

161. The method of claim 160, wherein the user-defined therapeutic treatment regimen is not included in said first knowledge base.

162. The method of claim 159, wherein the patient information comprises a history of therapeutic treatment regimens formerly used and currently used by the patient, which information is stored in a fourth knowledge base, and
wherein the software for evaluating, in light of the observed mutation populations, different therapeutic treatment regiments, expert rules, and advisory information, also evaluates the treatment regimens previously used by the patient,
wherein the report that is generated further comprises information regarding:
i) whether one or more constituents of the historical therapeutic treatment regimens is likely to have resulted in the development of one or more of the observed mutation populations,
ii) is likely to change the ranking of available treatment regimens, and/or
iii) whether certain therapeutic agents should not be administered to the patient, or which should not be administered to the patient without also monitoring the patient, based on known drug interactions with one or more drugs with which the patient is already being treated.

163. The method of claim 159, wherein the report further comprises advisory information for the therapeutic treatment regimens in said ranked listing.

164. The method of claim 163, wherein the advisory information comprises information regarding whether one or more constituents of the different therapeutic treatment regimens are incompatible with one or more of the observed mutation populations.

165. The method of claim 159, wherein the computing device further comprises a fifth knowledge base comprising information on known drug interactions,
wherein the software system is capable of relating information on observed mutation populations and known drug interactions with the advisory information for the treatment regimen, and
wherein the report that is generated provides advisory information for the treatment regimen(s) that takes into consideration the observed mutation populations, known drug interactions, patient information and expert rules.

166. The method of claim 159, wherein the report further comprises one or more of the following: drug susceptibility observations, ranked drug resistance levels, and guidance to treatment regimen.

167. The method of claim 160, wherein the user-defined therapeutic treatment regimen is a non-recommended therapeutic treatment regimen for said disease or medical condition that is included in said first knowledge base, but not recommended from said ranked listing; and
wherein advisory information for said non-recommended therapeutic treatment regimen is generated, said advisory information including at least one reason for not recommending the therapeutic treatment regimen, wherein said advisory information optionally includes warnings to take the patient off a contraindicated drug before initiating a corresponding therapeutic treatment regimen; and information clinically useful to implement a corresponding therapeutic treatment regimen.

168. The method of claim 159, wherein said patient information comprises one or more of gender, age, weight, CD4 information, viral load information, HIV genotype and phenotype information, hemoglobin information, neuropathy information, neutrophil information, pancreatitis, hepatic function, renal function, drug allergy and intolerance information, prior therapeutic treatment regimen information, and other prior patient information stored in the computing device.

169. The method of claim 162, wherein said report further comprises advisory information including previous therapeutic treatment regimen information extracted from said fourth knowledge base.

170. The method of claim 159, wherein said known disease or medical condition is an HIV-1, HBV or HCV infection, said therapeutic treatment regimen includes antiretroviral drugs, and said therapeutic treatment regimen includes contraindicated or potentially adversely interacting non-antiretroviral drugs.

171. The method of claim 170, wherein said therapeutic treatment regimen includes a protease inhibitor, and said contraindicated drug is terfenadine, or said therapeutic treatment regimen includes indinavir and said contraindicated drug is cisapride.

172. The method of claim 170, wherein the report comprises information regarding effective therapy for treating the primary HIV-1, HBV or HCV infection, as well as a listing of minority variants, if any, and if minority variants are present, effective therapy for treating the infection caused by the one or more minority variants, based on the patient information and the expert rules.

173. The method of claim 172, wherein the advisory information is in the form of a ranked listing.

174. A method according to claim 159, wherein said known disease or medical condition is one where multiple prophylactic or therapeutic treatment regimens are available to be used singly or in combination in the treatment of said disease, and wherein the known disease or medical condition is selected from the group consisting of a cardiovascular disease, a pulmonary disease, a neurologic disease, a cancer, a urinary tract infection, hepatitis, an HIV-1 infection, an HBV infection, or an HCV infection.

175. The method of claim 159, further comprising the step of:
(d) accessing, via said computing device, information for one or more therapeutic treatment regimens from a drug reference source.

176. A system for guiding the selection of a therapeutic treatment regimen for a patient with a known disease or medical condition, said system comprising:
(a) a computing device comprising:
a first knowledge base comprising a plurality of different therapeutic treatment regimens for said disease or medical condition,
a second knowledge base comprising a plurality of expert rules for evaluating and selecting a therapeutic treatment regimen for said disease or medical condition; and
a third knowledge base comprising advisory information useful for the treatment of a patient with different constituents of said different therapeutic treatment regimens;
(b) software for receiving patient information provided to said computing device;
(c) software for generating in said computing device a ranked listing of therapeutic treatment regimens for said patient; and
(d) software for generating in said computing device advisory information for one or more therapeutic treatment regimens in said ranked listing based on said patient information and said expert rules,
wherein said patient information comprises data generated from ultra-deep sequencing (UDS) systems, optionally further comprising:
(e) software for receiving a user-defined therapeutic treatment regimen for said disease or medical condition that is not generated or displayed via said first knowledge base; and
(f) software for generating in said computing device advisory information for said user-defined combination therapeutic treatment regimen, or
(f) software for receiving a non-recommended therapeutic treatment regimen for said disease or medical condition that is included in said first knowledge base but not recommended from said ranked listing; and
(g) software for generating in said computing device advisory information for said non-recommended therapeutic treatment regimen, said advisory information including at least one reason for non-recommendation of said therapeutic treatment regimen, optionally wherein said patient information comprises gender, age, weight, CD4 information, viral load information, HIV genotype and phenotype information, hemoglobin information, neuropathy information, neutrophil information, pancreatitis, hepatic function, renal function, drug allergy and intolerance information, prior therapeutic treatment regimen information, prior patient information stored in said computing device.

177. A computer program product for guiding the selection of a therapeutic treatment regimen for a patient with a known disease or medical condition, said computer program product comprising a computer usable storage medium having computer readable program code embodied in the medium, the computer readable program code comprising:
(a) computer readable program code for generating:
a first knowledge base comprising a plurality of different therapeutic treatment regimens for said disease or medical condition;
a second knowledge base comprising a plurality of expert rules for selecting a therapeutic treatment regimen for said disease or medical condition;
a third knowledge base comprising advisory information useful for the treatment of a patient with different constituents of said different therapeutic treatment regimens; and
(b) a computer readable program code for providing patient information;
(c) a computer readable program code for generating a ranked listing of available therapeutic treatment regimens for said patient based on said patient information and said expert rules; and
(d) a computer readable program code for generating advisory information for one or more therapeutic treatment regimens in said ranked listing based on said patient information and said expert rules.
